(19) United States
(12) Patent Application Publication
(10) Pub. No.: US 2011/0124588 A1
(43) Pub. Date: May 26, 2011

(54) SYNERGISTIC ACTIVE INGREDIENT COMBINATIONS

(75) Inventors: Peter Jeschke, Bergisch Gladbach (DE); Reiner Fischer, Monheim (DE); Wolfram Andersch, Bergisch Gladbach (DE); Heike Hungenberg, Langenfeld (DE)

(73) Assignee: Bayer Cropscience AG, Monheim (DE)

(21) Appl. No.: 12/989,698

(22) PCT Filed: Apr. 28, 2009
(86) PCT No.: PCT/EP09/03072

§ 371 Date: Nov. 19, 2010

(30) Foreign Application Priority Data
May 7, 2008 (EP) 08155752.2

(51) Int. Cl. A01N 43/24; A01N 43/56; A01N 35/10; A01N 53/06; A01N 43/02; A01N 43/16; A01N 43/36; A01N 43/78; A01N 37/44; A01N 43/40; A01N 47/34; A01N 43/64; A01N 43/58; A01N 57/00; A01N 43/88; A01N 43/66; A01N 55/00; A01P 15/00

(52) U.S. Cl. 514/28; 514/406; 514/636; 514/531; 514/450; 514/53; 514/427; 514/365; 514/534; 514/357; 514/590; 514/383; 514/336; 514/345; 514/248; 514/89; 514/250; 514/242; 514/223.8; 514/245; 514/229.2; 514/63

(57) ABSTRACT

The novel active compound combinations comprising compounds of the formulae (I) and (II) have very good insecticidal and acaricidal properties.

The present invention relates to novel active compound combinations which comprise, firstly, at least a known compound of the general formula (I) and, secondly, at least one further known active compound from the class of the macrolides, the carboxylates, the neonicotinoids, the chitin synthesis inhibitors, the moulting hormone agonists, the organophosphates or the carbamates, the phthalic acid diamides, the tetronic or tetramic acid, the pyrethroids or other classes and which are highly suitable for controlling animal pests such as insects and unwanted acarids. The invention also relates to methods for controlling animal pests on plants and seed, to a method for protecting seed and not least to the seed treated with the active compound combinations according to the invention.

It is already known that compounds of the formula (I)

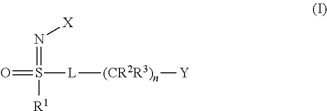

in which
X represents NO₂, CN or COOR⁴,
L represents a single bond,
R¹ represents C₁-C₄-alkyl, or
R¹, sulphur and L together represent a 4-, 5- or 6-membered ring,
R² and R³ independently of one another represent hydrogen, methyl, ethyl, fluorine, chlorine or bromine,
or
R² and R³ together represent —(CH₂)₂—, —(CH₂)₃—, —(CH₂)₄— or —(CH₂)₅— and together with the carbon atom to which they are attached form a 3-, 4-, 5- or 6-membered ring,
n represents 0, 1, 2 or 3,
Y represents one of the radicals

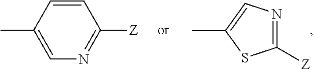

in which
Z represents halogen, C₁-C₄-alkyl, C₁-C₄-haloalkyl, C₁-C₄-alkoxy or C₁-C₄-haloalkoxy,
R⁴ represents C₁-C₃-alkyl, have insecticidal activity (cf. the US patent application 2005/228027 A1, WO 2006/060029 A2, WO 2007/095229 A2, WO 2007/149134 A1, WO 2008/027539 A1, WO 2008/027073 A1, WO 2008/097235 A1 and WO 2008/057129 A1).

However, the acaricidal and/or insecticidal activity and/or activity spectrum and/or the plant compatibility of these known compounds, in particular with respect to crop plants, is/are not always satisfactory.

It has now been found that active compound combinations comprising at least one and preferably exactly one compound of the formula (I)

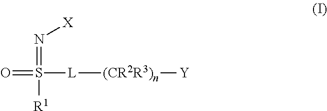

in which
X represents NO₂, CN or COOR⁴,
L represents a single bond,
R¹ represents C₁-C₄-alkyl, or
R¹, sulphur and L together represent a 4-, 5- or 6-membered ring,
R² and R³ independently of one another represent hydrogen, methyl, ethyl, fluorine, chlorine or bromine,
or
R² and R³ together represent —(CH₂)₂—, —(CH₂)₃—, —(CH₂)₄— or —(CH₂)₅— and together with the carbon atom to which they are attached form a 3-, 4-, 5- or 6-membered ring,
n represents 0, 1, 2 or 3,
Y represents one of the radicals

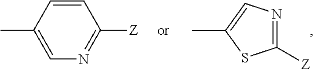

in which
Z represents halogen, C₁-C₄-alkyl, C₁-C₄-haloalkyl, C₁-C₄-alkoxy or C₁-C₄-haloalkoxy,
R⁴ represents C₁-C₃-alkyl,

and one or more further active compounds of the formula (II) are highly suitable for controlling animal pests such as, for example, insects and/or acarids.

The active compounds of the formula (II) have been classified according to the IRAC Classification (Version 6.1 Aug. 2008) in various classes (I-29) and groups according to their mechanism of action:

Acetylcholinesterase (AChE) inhibitors II-1

II-1.A carbamates,

for example alanycarb (II-1.A-1), aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35)

II-1.B organophosphates,

for example acephate (II-1.B-1), azamethiphos (II-1.B-2), azinphos (-methyl, -ethyl) (II-1.B-3), bromophos-ethyl (II-1.B-4), bromfenvinfos (-methyl) (II-1.B-5), butathiofos (II-1.B-6), cadusafos (II-1.B-7), carbophenothion (II-1.B-8), chlorethoxyfos (II-1.B-9), chlorfenvinphos (II-1.B-10), chlormephos (II-1.B-11), chlorpyrifos (-methyl/-ethyl) (II-1.B-12), coumaphos (II-1.B-13), cyanofenphos (II-1.B-14), cyanophos (II-1.B-15), chlorfenvinphos (II-1.B-16), demeton-S-methyl (II-1.B-17), demeton-S-methylsulphone (II-1.B-18), dialifos (II-1.B-19), diazinon (II-1.B-20), dichlofenthion (II-1.B-21), dichlorvos/DDVP (II-1.B-22), dicrotophos (II-1.B-23), dimethoate (II-1.B-24), dimethylvinphos (II-1.B-25), dioxabenzofos (II-1.B-26), disulfoton (II-1.B-27), EPN (II-1.B-28), ethion (II-1.B-29), ethoprophos (II-1.B-30), etrimfos (II-1.B-31), famphur (II-1.B-32), fenamiphos (II-1.B-33), fenitrothion (II-1.B-34), fensulfothion (II-1.B-35), fenthion (II-1.B-36), flupyrazofos (II-1.B-37), fonofos (II-1.B-38), formothion (II-1.B-39), fosmethilan (II-1.B-40), fosthiazate (II-1.B-41), heptenophos (II-1.B-42), iodofenphos (II-1.B-43), iprobenfos (II-1.B-44), isazofos (II-1.B-45), isofenphos (II-1.B-46), isopropyl (II-1.B-47), O-salicylate (II-1.B-48), isoxathion (II-1.B-49), malathion (II-1.B-50), mecarbam (II-1.B-51), methacrifos (II-1.B-52), methamidophos (II-1.B-53), methidathion (II-1.B-54), mevinphos (II-1.B-55), monocrotophos (II-1.B-56), naled (II-1.B-57), omethoate (II-1.B-58), oxydemeton-methyl (II-1.B-59), parathion (-methyl/-ethyl) (II-1.B-60), phenthoate (II-1.B-61), phorate (II-1.B-62), phosalone (II-1.B-63), phosmet (II-1.B-64), phosphamidon (II-1.B-65), phosphocarb (II-1.B-66), phoxim (II-1.B-67), pirimiphos (-methyl/-ethyl) (II-1.B-68), profenofos (II-1.B-69), propaphos (II-1.B-70), propetamphos (II-1.B-71), prothiofos (II-1.B-72), prothoate (II-1.B-73), pyraclofos (II-1.B-74), pyridaphenthion (II-1.B-75), pyridathion (II-1.B-76), quinalphos (II-1.B-77), sebufos (II-1.B-78), sulfotep (II-1.B-79), sulprofos (II-1.B-80), tebupirimfos (II-1.B-81), temephos (II-1.B-82), terbufos (II-1.B-83), tetrachlorvinphos (II-1.B-84), thiometon (II-1.B-85), triazophos (II-1.B-86), triclorfon (II-1.B-87), vamidothion (II-1.B-88) antagonists of GABA-gated chloride channels II-2

II-2A organochlorines,

for example camphechlor (II-2A-1), chlordane (II-2A-2), endosulfan (II-2A-3), gamma-HCH (II-2A-4), HCH (II-2A-5), heptachlor (II-2A-6), lindane (II-2A-7), methoxychlor (II-2A-8)

II-2B fiproles (phenylpyrazoles),

for example acetoprole (II-2B-1), ethiprole (II-2B-2), fipronil (II-2B-3), pyrafluprole (II-2B-4), pyriprole (II-2B-5), vaniliprole (II-2B-6)
sodium channel modulators/blockers of voltage-gated sodium channels II-3

II-3 pyrethroids,

for example acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-)(II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (-1R isomer) (II-3-51), tralomethrin (II-3-52), transfluthrin (II-3-53), ZXI 8901 (II-3-54), pyrethrin (pyrethrum) (II-3-55), eflusilanate (II-3-56), DDT (II-3-57), methoxychlor (II-3-58),
agonists/antagonists of the nicotinergic acetylcholine receptor II-4

II-4A chloronicotinyls,

for example acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9),

II-4B nicotine (II-4B-1), bensultap (II-4B-2), cartap (II-4B-3), thiosulfap-sodium (II-4B-4), thiocylam (II-4C-4)

allosteric modulators of the acetylcholine receptor (agonists)

II-5 spinosyns,

for example spinosad (II-5-1), spinetoram (II-5-2) chloride channel activators

II-6 mectins/macrolides,

for example abamectin (II-6-1), emamectin (II-6-2), emamectin-benzoate (II-6-3), ivermectin (II-6-4), lepimectin (II-6-5), milbemectin (II-6-6)

II-7A juvenile hormone analogues,

for example hydroprene (II-7A-1), kinoprene (II-7A-2), methoprene (II-7A-3), epofenonane (II-7A-4), triprene (II-7A-5), fenoxycarb (II-7B-1),
pyriproxifen (II-7C-1), diofenolan (II-7C-2)
   active compounds having unknown or non-specific mechanisms of action

II-8 fumigants,

for example methylbromide (II-8A-1), chloropicrin (II-8B-1), sulphuryl fluoride (II-8C-1)

II-9 selective antifeedants,

for example cryolite (II-9A-1), pymetrozine (II-9B-1), pyrifluquinazone NNI0101 (II-9B-2), flonicamid (II-9C-1)

II-10 mite growth inhibitors

for example clofentezine (II-10A-1), hexythiazox (II-10A-2), etoxazole (II-10B-1)
inhibitors of oxidative phosphorylation, ATP disruptors II-12

II-12A diafenthiuron (II-12A-1)

II-12B organotin compounds,

for example azocyclotin (II-12B-1), cyhexatin (II-12B-2), fenbutatin oxide (II-12B-3)

II-12C propargite (II-12C-1), tetradifon (II-12C-2)

decouplers of oxidative phosphorylation by interruption of the H-proton gradient II-13
chlorfenapyr (II-13-1)
binapacyrl (II-13-2), dinobuton (II-13-3), dinocap (II-13-4), DNOC (II-13-5)
microbial disruptors of the insect gut membrane

Bacillus thuringiensis strains (II-13-6)

inhibitors of chitin biosynthesis

II-15 benzoylureas,

for example bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)

II-16 buprofezin (II-16-1)

moulting disruptors cyromazine (II-17-1)
ecdysone agonists/disruptors (II-18)

II-18A diacylhydrazines,

for example chromafenozide (II-18A-1), halofenozide (II-18A-2), methoxyfenozide (II-18A-3), tebufenozide (II-18A-4), fufenozide (JS-118) (II-18A-5)
azadirachtin (II-18B-1)
   octopaminergic agonists
   for example amitraz (II-19-1)

II-20 site III electron transport inhibitors/site II electron transport inhibitors
hydramethylnon (II-20A-1)
acequinocyl (II-20B-1)
   fluacrypyrim (II-20C-1)
cyflumetofen (II-20D-1), cyenopyrafen (II-20D-2)
   electron transport inhibitors

II-21 site I electron transport inhibitors

from the group of the METI acaricides,
for example fenazaquin (II-21-1), fenpyroximate (II-21-2), pyrimidifen (II-21-3), pyridaben (II-21-4), tebufenpyrad (II-21-5), tolfenpyrad (II-21-6), rotenone (II-21-7)

II-22 blockers of voltage-gated sodium channels

for example indoxacarb (II-22A-1)
for example metaflumizone (BAS 3201) (II-22B-1)

II-23 inhibitors of fatty acid biosynthesis

II-23A tetronic acid derivatives

for example spirodiclofen (II-23A-1), spiromesifen (II-23A-2)

II-23B tetramic acid derivatives,

for example spirotetramat (II-23B-1)

II-25 neuronal inhibitors having an unknown mechanism of action

bifenazate (II-25-1)
ryanodine receptor effectors

II-28 diamides,

for example flubendiamides (II-28-1),

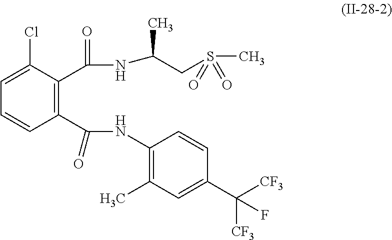

### Chlorantraniliprole (Rynaxypyr (II-28-3),

### Cyantraniliprole (Cyazypyr (II-28-4)

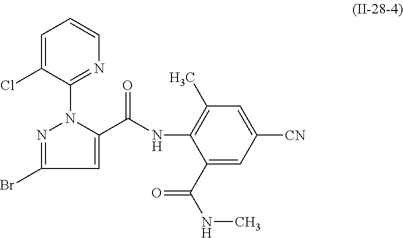

II-29 active compounds having an unknown mechanism of action

amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27), 4-{[(6-chloropyrid-3-yl)methyl](methyl)amino}furan-2(5H)-one (known from EP-A-0 539 588) (II-29-28), 4-{[(6-chloropyrid-3-yl)methyl](2,2-difluoroethyl)amino}furan-2(5H)-one (known from WO 2007/115644) (II-29-29), 4-{[(6-chloropyrid-3-yl)methyl](cyclopropyl)amino}furan-2(5H)-one (known from EP-A-0 539 588) (II-29-30) and 1-{2,4-dimethyl-5-[(2,2,2-trifluoroethyl)sulphinyl]phenyl}-3-(trifluoromethyl)-1H-1,2,4-triazole (known from WO 1999/55668) (II-29-31).

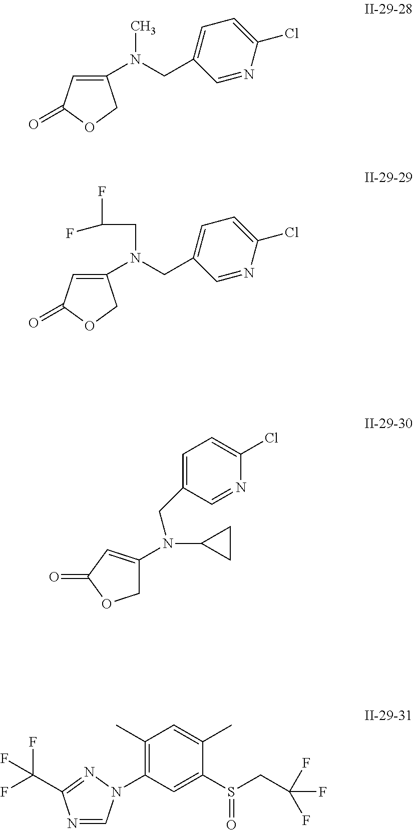

II-30 microbial disruptors of the insect gut membrane

II-30-1 Bacillus thuringiensis strains

The active compounds referred to in this description by their common name are known, for example, from “The Pesticide Manual” 13th Ed., British Crop Protection Council 2003, and the website http://www.alanwood.net/pesticides/.

If, in the context of this description, the short form of the common name of an active compound is used, this comprises in each case all customary derivatives, such as the esters and salts, and isomers, in particular optical isomers, especially the commercially available form or forms. If the common name refers to an ester or a salt, this in each case also comprises all other customary derivatives, such as other esters and salts, the free acids and neutral compounds, and isomers, in particular optical isomers, especially the commercially available form or forms. The given chemical compound names refer to at least one of the compounds embraced by the common name, frequently to a preferred compound.

Depending inter alia on the nature of the substituents, the compounds of the formula (I) may be present as optical isomers or isomer mixtures of varying composition which, if required, can be separated in a customary manner. The present invention provides both the pure isomers and the isomer mixtures, their preparation and use and compositions comprising them. However, for the sake of simplicity, hereinbelow only compounds of the formula (I) are referred to, although what is meant are both the pure compounds and, if appropriate, mixtures having varying proportions of isomeric compounds.

Preferred subgroups of the compounds of the formula (I) in the active compound combinations according to the invention are listed below:

In a special group (Ia) of compounds of the formula (I), X is a nitro group:

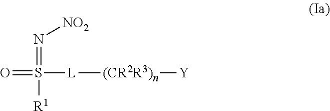

In a further special group (Ib) of compounds of the formula (I), X is a cyano group:

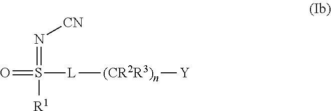

In a further special group (Ic) of compounds of the formula (I), X is NO₂ or CN and Y is a 6-chloropyrid-3-yl radical:

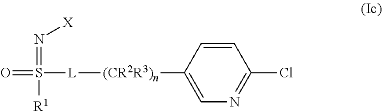

In a further special group (Id) of compounds of the formula (I), X is NO₂ or CN and Y is a 6-trifluoromethylpyrid-3-yl radical:

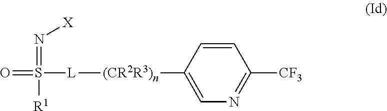

In a further special group (Ie) of compounds of the formula (I), X is NO₂ or CN and Y is a 2-chloro-1,3-thiazol-5-yl radical:

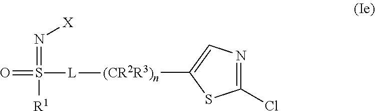

In a further special group (If) of compounds of the formula (I), X is NO₂ or CN and Y is a 2-trifluoromethyl-1,3-thiazol-5-yl radical:

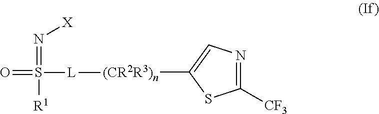

In a further special group (Ig) of compounds of the formula (I), R¹, sulphur and L together form a 5-membered ring, X is NO₂ or CN, Y is 6-halopyrid-3-yl or 6-(C₁-C₄-haloalkyl)pyrid-3-yl, particularly preferably 6-chloropyrid-3-yl or 6-trifluoromethylpyrid-3-yl, and n is preferably 0:

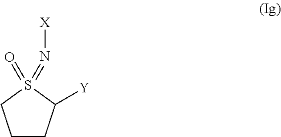

In a further special group (Ih) of compounds of the formula (I), R¹, sulphur and L together form a 5-membered ring, X is NO₂ or CN, Y is 6-halopyrid-3-yl or 6-(C₁-C₄-haloalkyl)pyrid-3-yl, particularly preferably 6-chloropyrid-3-yl or 6-trifluoromethylpyrid-3-yl, and n is preferably 0:

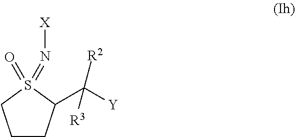

In a further special group (Ii) of compounds of the formula (I), R¹ is methyl, X is NO₂ or CN, L is a single bond and n is preferably 1:

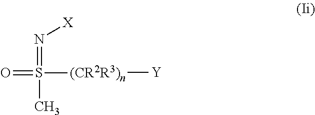

In a further special group (Ij) of compounds of the formula (I), n is 1, R¹ is methyl, R² and R³ independently of one another are hydrogen or methyl, X is NO₂ or CN 1:

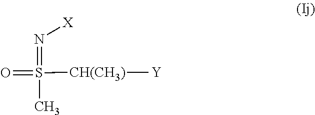

In a further special group (Ik) of compounds of the formula (I), n is 1, R¹ is methyl, R² and R³ together represent —(CH₂)₂— and together with the carbon atom to which they are attached form a 3-membered ring, X represents NO₂ or CN 1:

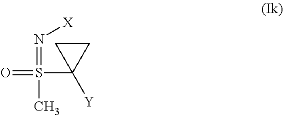

Depending, if appropriate, on the nature of the substituents, the compounds of the formula (I) may be present as geometric and/or optically active isomers or corresponding isomer mixtures of varying composition. The invention relates both to the pure isomers and to the isomer mixtures.

Specific mention may be made of the following compounds of the formula (I):
Compound (I-1), [6-chloropyridin-3-yl]methyl](methyl)oxido-λ⁴-sulphanylidene-cyanamide:

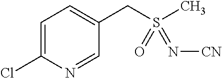

known from the US patent application 2005/228027 A1 and WO 2007/149134 A1.
Compound (I-2), [6-trifluoromethylpyridin-3-yl]methyl](methyl)oxido-λ⁴-sulphanylidene-cyanamide:

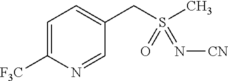

known from WO 2007/095229 A2, WO 2007/149134 A1 and WO 2008/027073 A1.
Compound (I-3), methyl(oxido){[2-chloro-1,3-thiazol-5-yl]methyl}λ⁴-sulphanylidene-cyanamide:

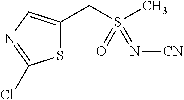

known from the US patent application 2005/228027 A1.
Compound (I-4), methyl(oxido){[2-(trifluoromethyl)-1,3-thiazol-5-yl]methyl}λ⁴-sulphanylidenecyanamide:

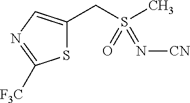

known from WO 2008/027539 A1.
Compound (I-5), [6-chloropyridin-3-yl]ethyl](methyl)oxido-λ⁴-sulphanylidenecyanamide:

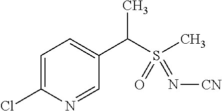

known from the US patent application 2005/228027 A1 and WO 2007/149134 A1.
Compound (I-6), [6-chloropyridin-3-yl]ethyl](methyl)oxido-λ⁴-sulphanylidenecyanamide diastereomer:

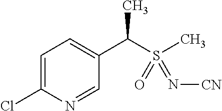

known from the US patent application 2005/228027 A1 and WO 2007/149134 A1.
Compound (I-7), [6-chloropyridin-3-yl]ethyl](methyl)oxido-λ⁴-sulphanylidenecyanamide diastereomer:

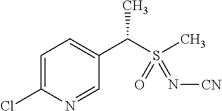

known from the US patent application 2005/228027 A1 and WO 2007/149134 A1.
Compound (I-8), [6-trifluoromethylpyridin-3-yl]ethyl](methyl)oxido-λ⁴-sulphanylidene-cyanamide:

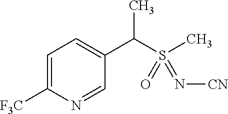

known from WO 2007/095229 A2 and WO 2007/149134 A1.
Compound (I-9), [6-(1,1-difluoroethyl)pyrid-3-yl]ethyl](methyl)oxido-λ⁴-sulphanylidene-cyanamide:

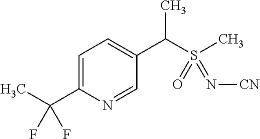

known from WO 2007/095229 A2.
Compound (I-10), [6-difluoromethylpyrid-3-yl]ethyl](methyl)oxido-λ⁴-sulphanylidene-cyanamide:

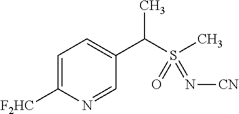

known from WO 2007/095229 A2.
Compound (I-11), methyl(oxido){1-[2-(trichloromethyl)pyrid-3-yl]ethyl}-λ⁴-sulphanylidenecyanamide

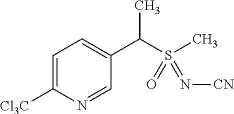

known from WO 2007/095229 A2.
Compound (I-12), methyl(oxido){1-[2-(pentafluoroethyl)pyrid-3-yl]ethyl}-λ⁴-sulphanylidenecyanamide

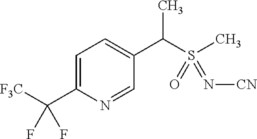

known from WO 2007/095229 A2.
Compound (I-13), [6-chlorodifluoromethylpyrid-3-yl]ethyl](methyl)oxido-λ⁴-sulphanylidenecyanamide:

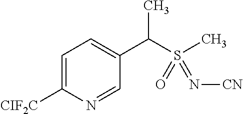

known from WO 2007/095229 A2.
Compound (I-14), methyl(oxido){1-[2-(trifluoromethyl)-1,3-thiazol-5-yl]ethyl}-λ⁴-sulphanylidenecyanamide:

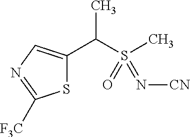

known from WO 2008/027539 A1.
Compound (I-15), methyl(oxido){1-[6-(trifluoromethyl)pyridin-3-yl]cyclopropyl-λ⁴-sulphanylidenecyanamide:

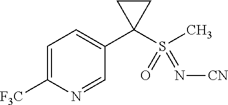

known from WO 2008/027073 A1.
Compound (I-16), methyl(oxido){1-(6-chloropyridin-3-yl)cyclopropyl-λ⁴-sulphanylidenecyanamide:

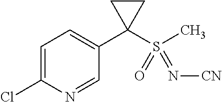

known from WO 2008/027073 A1.
Compound (I-17), 2-(6-chloropyridin-3-yl)-1-oxidotetrahydro-1H-1λ⁴-thienylidene-cyanamide:

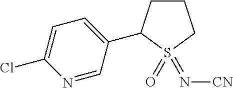

known from WO 2004/149134 A1.
Compound (I-18), 2-(6-trifluoromethylpyridin-3-yl)-1-oxidotetrahydro-1H-1λ⁴-thien-ylidenecyanamide:

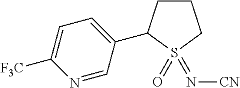

known from WO 2004/149134 A1.
Compound (I-19), 1-oxo-2-(2-trifluoromethyl-1,3-thiazol-5-ylmethyl)tetrahydro-1-λ⁶-thiophen-1-ylidenecyanamide:

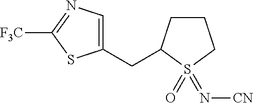

known from WO 2008/027539 A1.
Compound (I-20), 1-oxo-2-(6-trifluoromethylpyrid-3-ylmethyl)tetrahydro-1-λ⁶-thiophen-1-ylidenecyanamide:

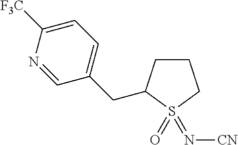

known from WO 2007/095229 A2.
Compound (I-21), 1-oxo-2-(6-chloropyrid-3-ylmethyl)tetrahydro-1-λ⁶-thiophen-1-ylidenecyanamide:

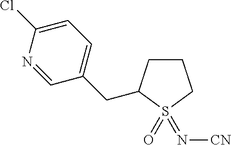

known from the US patent application 2005/228027 A1.
Compound (I-22), 1-oxo-2-(6-chloropyrid-3-ylmethyl)tetrahydro-1-λ⁶-thiophen-1-ylidenecyanamide diastereomer:

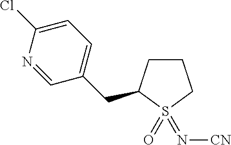

known from the US patent application 2005/228027 A1.
Compound (I-23), 1-oxo-2-(6-chloropyrid-3-ylmethyl)tetrahydro-1-λ⁶-thiophen-1-ylidenecyanamide diastereomer:

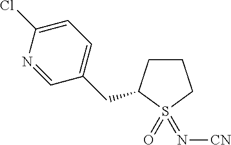

known from the US patent application 2005/228027 A1.

The active compound combinations according to the invention preferably comprise the following sulphoximines of the formula (I):
(I-1), [6-chloropyridin-3-yl]methyl](methyl)oxido-λ⁴-sulphanylidenecyanamide,
(I-2), [6-trifluoromethylpyridin-3-yl]methyl](methyl)oxido-λ⁴-sulphanylidenecyanamide,
(I-3), methyl(oxido){[2-chloro-1,3-thiazol-5-yl]methyl}λ⁴-sulphanylidenecyanamide,
(I-4), methyl(oxido){[2-(trifluoromethyl)-1,3-thiazol-5-yl]methyl}λ⁴-sulphanylidenecyanamide,
(I-5), [6-chloropyridin-3-yl]ethyl](methyl)oxido-λ⁴-sulphanylidenecyanamide,
(I-6), [6-chloropyridin-3-yl]ethyl](methyl)oxido-λ⁴-sulphanylidenecyanamide diastereomer,
(I-7), [6-chloropyridin-3-yl]ethyl](methyl)oxido-λ⁴-sulphanylidenecyanamide diastereomer,
(I-8), [6-trifluoromethylpyridin-3-yl]ethyl](methyl)oxido-λ⁴-sulphanylidenecyanamide,
(I-14), methyl(oxido){1-[2-(trifluoromethyl)-1,3-thiazol-5-yl]ethyl}-λ⁴-sulphanylidenecyanamide,
(I-15), methyl(oxido){1-[6-(trifluoromethyl)pyridin-3-yl]cyclopropyl-λ⁴-sulphanylidenecyanamide,
(I-16), methyl(oxido){1-(6-chloropyridin-3-yl)cyclopropyl-λ⁴-sulphanylidenecyanamide.

Particularly preferably, the active compound combinations according to the invention comprise the following sulphoximines of the formula (I):
(I-5), [6-chloropyridin-3-yl]ethyl](methyl)oxido-λ⁴-sulphanylidenecyanamide,
(I-6), [6-chloropyridin-3-yl]ethyl](methyl)oxido-λ⁴-sulphanylidenecyanamide diastereomer,
(I-7), [6-chloropyridin-3-yl]ethyl](methyl)oxido-λ⁴-sulphanylidenecyanamide diastereomer,
(I-8), [6-trifluoromethylpyridin-3-yl]ethyl](methyl)oxido-λ⁴-sulphanylidenecyanamide,
(I-15), methyl(oxido){1-[6-(trifluoromethyl)pyridin-3-yl]cyclopropyl-λ⁴-sulphanylidenecyanamide,
(I-16), methyl(oxido){1-(6-chloropyridin-3-yl)cyclopropyl-λ⁴-sulphanylidenecyanamide.

Surprisingly, the insecticidal and/or acaricidal activity of the active compound combinations according to the invention is substantially higher than the sum of the activities of the individual active compounds. An unforeseeable true synergistic effect is present, and not just an addition of activities.

Preference is given to active compound combinations comprising at least one, in particular exactly one, compound of the formulae (I-1) to (I-8), (I-14), (I-15) and (I-16) and at least one, in particular exactly one, active compound of the formula (II).

The following combinations are of particular interest:

| | | |
|---|---|---|
| I-1 | + | II-1A-1 |
| I-1 | + | II-1A-2 |
| I-1 | + | II-1A-3 |
| I-1 | + | II-1A-4 |
| I-1 | + | II-1A-5 |
| I-1 | + | II-1A-6 |
| I-1 | + | II-1A-7 |
| I-1 | + | II-1A-8 |
| I-1 | + | II-1A-9 |
| I-1 | + | II-1A-10 |
| I-1 | + | II-1A-11 |
| I-1 | + | II-1A-12 |
| I-1 | + | II-1A-13 |
| I-1 | + | II-1A-14 |
| I-1 | + | II-1A-15 |
| I-1 | + | II-1A-16 |
| I-1 | + | II-1A-17 |
| I-1 | + | II-1A-18 |
| I-1 | + | II-1A-19 |
| I-1 | + | II-1A-20 |
| I-1 | + | II-1A-21 |
| I-1 | + | II-1A-22 |
| I-1 | + | II-1A-23 |
| I-1 | + | II-1A-24 |
| I-1 | + | II-1A-25 |
| I-1 | + | II-1A-26 |
| I-1 | + | II-1A-27 |
| I-1 | + | II-1A-28 |
| I-1 | + | II-1A-29 |
| I-1 | + | II-1A-30 |
| I-1 | + | II-1A-31 |
| I-1 | + | II-1A-32 |
| I-1 | + | II-1A-33 |
| I-1 | + | II-1A-34 |
| I-1 | + | II-1A-35 |
| I-1 | + | II-1B-1 |
| I-1 | + | II-1B-2 |
| I-1 | + | II-1B-3 |
| I-1 | + | II-1B-4 |
| I-1 | + | II-1B-5 |
| I-1 | + | II-1B-6 |
| I-1 | + | II-1B-7 |
| I-1 | + | II-1B-8 |
| I-1 | + | II-1B-9 |
| I-1 | + | II-1B-10 |
| I-1 | + | II-1B-11 |
| I-1 | + | II-1B-12 |
| I-1 | + | II-1B-13 |
| I-1 | + | II-1B-14 |
| I-1 | + | II-1B-15 |
| I-1 | + | II-1B-16 |
| I-1 | + | II-1B-17 |
| I-1 | + | II-1B-18 |
| I-1 | + | II-1B-19 |
| I-1 | + | II-1B-20 |
| I-1 | + | II-1B-21 |
| I-1 | + | II-1B-22 |
| I-1 | + | II-1B-23 |
| I-1 | + | II-1B-24 |
| I-1 | + | II-1B-25 |
| I-1 | + | II-1B-26 |
| I-1 | + | II-1B-27 |
| I-1 | + | II-1B-28 |
| I-1 | + | II-1B-29 |
| I-1 | + | II-1B-30 |
| I-1 | + | II-1B-31 |
| I-1 | + | II-1B-32 |
| I-1 | + | II-1B-33 |
| I-1 | + | II-1B-34 |
| I-1 | + | II-1B-35 |
| I-1 | + | II-1B-36 |
| I-1 | + | II-1B-37 |
| I-1 | + | II-1B-38 |
| I-1 | + | II-1B-39 |
| I-1 | + | II-1B-40 |
| I-1 | + | II-1B-41 |
| I-1 | + | II-1B-42 |
| I-1 | + | II-1B-43 |
| I-1 | + | II-1B-44 |
| I-1 | + | II-1B-45 |
| I-1 | + | II-1B-46 |
| I-1 | + | II-1B-47 |
| I-1 | + | II-1B-48 |
| I-1 | + | II-1B-49 |
| I-1 | + | II-1B-50 |
| I-1 | + | II-1B-51 |
| I-1 | + | II-1B-52 |
| I-1 | + | II-1B-53 |
| I-1 | + | II-1B-54 |
| I-1 | + | II-1B-55 |
| I-1 | + | II-1B-56 |
| I-1 | + | II-1B-57 |
| I-1 | + | II-1B-58 |
| I-1 | + | II-1B-59 |
| I-1 | + | II-1B-60 |
| I-1 | + | II-1B-61 |
| I-1 | + | II-1B-62 |
| I-1 | + | II-1B-63 |
| I-1 | + | II-1B-64 |
| I-1 | + | II-1B-65 |
| I-1 | + | II-1B-66 |
| I-1 | + | II-1B-67 |
| I-1 | + | II-1B-68 |
| I-1 | + | II-1B-69 |
| I-1 | + | II-1B-70 |
| I-1 | + | II-1B-71 |
| I-1 | + | II-1B-72 |
| I-1 | + | II-1B-73 |
| I-1 | + | II-1B-74 |
| I-1 | + | II-1B-75 |
| I-1 | + | II-1B-76 |
| I-1 | + | II-1B-77 |
| I-1 | + | II-1B-78 |
| I-1 | + | II-1B-79 |
| I-1 | + | II-1B-80 |
| I-1 | + | II-1B-81 |
| I-1 | + | II-1B-82 |
| I-1 | + | II-1B-83 |
| I-1 | + | II-1B-84 |
| I-1 | + | II-1B-85 |
| I-1 | + | II-1B-86 |
| I-1 | + | II-1B-87 |
| I-1 | + | II-1B-88 |
| I-1 | + | II-2A-1 |
| I-1 | + | II-2A-2 |
| I-1 | + | II-2A-3 |
| I-1 | + | II-2A-4 |
| I-1 | + | II-2A-5 |
| I-1 | + | II-2A-6 |
| I-1 | + | II-2A-7 |
| I-1 | + | II-2A-8 |
| I-1 | + | II-2B-1 |
| I-1 | + | II-2B-2 |
| I-1 | + | II-2B-3 |
| I-1 | + | II-2B-4 |
| I-1 | + | II-2B-5 |
| I-1 | + | II-2B-6 |
| I-1 | + | II-3-1 |
| I-1 | + | II-3-2 |
| I-1 | + | II-3-3 |
| I-1 | + | II-3-4 |
| I-1 | + | II-3-5 |
| I-1 | + | II-3-6 |
| I-1 | + | II-3-7 |
| I-1 | + | II-3-8 |
| I-1 | + | II-3-9 |
| I-1 | + | II-3-10 |
| I-1 | + | II-3-11 |
| I-1 | + | II-3-12 |
| I-1 | + | II-3-13 |
| I-1 | + | II-3-14 |
| I-1 | + | II-3-15 |
| I-1 | + | II-3-16 |
| I-1 | + | II-3-17 |
| I-1 | + | II-3-18 |
| I-1 | + | II-3-19 |
| I-1 | + | II-3-20 |
| I-1 | + | II-3-21 |
| I-1 | + | II-3-22 |
| I-1 | + | II-3-23 |
| I-1 | + | II-3-24 |
| I-1 | + | II-3-25 |
| I-1 | + | II-3-26 |
| I-1 | + | II-3-27 |
| I-1 | + | II-3-28 |
| I-1 | + | II-3-29 |
| I-1 | + | II-3-30 |
| I-1 | + | II-3-31 |
| I-1 | + | II-3-32 |
| I-1 | + | II-3-33 |
| I-1 | + | II-3-34 |
| I-1 | + | II-3-35 |
| I-1 | + | II-3-36 |
| I-1 | + | II-3-37 |
| I-1 | + | II-3-38 |
| I-1 | + | II-3-39 |
| I-1 | + | II-3-40 |
| I-1 | + | II-3-41 |
| I-1 | + | II-3-42 |
| I-1 | + | II-3-43 |
| I-1 | + | II-3-44 |
| I-1 | + | II-3-45 |
| I-1 | + | II-3-46 |
| I-1 | + | II-3-47 |
| I-1 | + | II-3-48 |
| I-1 | + | II-3-49 |
| I-1 | + | II-3-50 |
| I-1 | + | II-3-51 |
| I-1 | + | II-3-52 |
| I-1 | + | II-3-53 |
| I-1 | + | II-3-54 |
| I-1 | + | II-3-55 |
| I-1 | + | II-3-56 |
| I-1 | + | II-3-57 |
| I-1 | + | II-3-58 |
| I-1 | + | II-4A-1 |
| I-1 | + | II-4A-2 |
| I-1 | + | II-4A-3 |
| I-1 | + | II-4A-4 |
| I-1 | + | II-4A-5 |
| I-1 | + | II-4A-6 |
| I-1 | + | II-4A-7 |
| I-1 | + | II-4A-8 |
| I-1 | + | II-4A-9 |
| I-1 | + | II-4B-1 |
| I-1 | + | II-4B-2 |
| I-1 | + | II-4B-3 |
| I-1 | + | II-4B-4 |
| I-1 | + | II-4C-4 |
| I-1 | + | II-5-1 |
| I-1 | + | II-5-2 |
| I-1 | + | II-6-1 |
| I-1 | + | II-6-2 |
| I-1 | + | II-6-3 |
| I-1 | + | II-6-4 |
| I-1 | + | II-6-5 |
| I-1 | + | II-6-6 |
| I-1 | + | II-7A-1 |
| I-1 | + | II-7A-2 |
| I-1 | + | II-7A-3 |
| I-1 | + | II-7A-4 |
| I-1 | + | II-7A-5 |
| I-1 | + | II-7B-1 |
| I-1 | + | II-7C-1 |
| I-1 | + | II-7C-2 |
| I-1 | + | II-8A-1 |
| I-1 | + | II-8B-1 |
| I-1 | + | II-8C-1 |
| I-1 | + | II-9A-1 |
| I-1 | + | II-9B-1 |
| I-1 | + | II-9B-2 |
| I-1 | + | II-9C-1 |
| I-1 | + | II-10A-1 |
| I-1 | + | II-10A-2 |
| I-1 | + | II-10B-1 |
| I-1 | + | II-12A-1 |
| I-1 | + | II-12B-1 |
| I-1 | + | II-12B-2 |
| I-1 | + | II-12B-3 |
| I-1 | + | II-12C-1 |
| I-1 | + | II-12C-2 |
| I-1 | + | II-13-1 |
| I-1 | + | II-13-2 |
| I-1 | + | II-13-3 |
| I-1 | + | II-13-4 |
| I-1 | + | II-13-5 |
| I-1 | + | II-13-6 |
| I-1 | + | II-15-1 |
| I-1 | + | II-15-2 |
| I-1 | + | II-15-3 |
| I-1 | + | II-15-4 |
| I-1 | + | II-15-5 |
| I-1 | + | II-15-6 |
| I-1 | + | II-15-7 |
| I-1 | + | II-15-8 |
| I-1 | + | II-15-9 |
| I-1 | + | II-15-10 |
| I-1 | + | II-15-11 |
| I-1 | + | II-15-12 |
| I-1 | + | II-15-13 |
| I-1 | + | II-16-1 |
| I-1 | + | II-17-1 |
| I-1 | + | II-18A-1 |
| I-1 | + | II-18A-2 |
| I-1 | + | II-18A-3 |
| I-1 | + | II-18A-4 |
| I-1 | + | II-18A-5 |
| I-1 | + | II-18B-1 |
| I-1 | + | II-19-1 |
| I-1 | + | II-20A-1 |
| I-1 | + | II-20B-1 |
| I-1 | + | II-20C-1 |
| I-1 | + | II-20D-1 |
| I-1 | + | II-20D-2 |
| I-1 | + | II-21-1 |
| I-1 | + | II-21-2 |
| I-1 | + | II-21-3 |
| I-1 | + | II-21-4 |
| I-1 | + | II-21-5 |
| I-1 | + | II-21-6 |
| I-1 | + | II-21-7 |
| I-1 | + | II-22A-1 |
| I-1 | + | II-22B-1 |
| I-1 | + | II-23A-1 |
| I-1 | + | II-23A-2 |
| I-1 | + | II-23B-1 |
| I-1 | + | II-25-1 |
| I-1 | + | II-28-1 |
| I-1 | + | II-28-2 |
| I-1 | + | II-28-3 |
| I-1 | + | II-28-4 |
| I-1 | + | II-29-1 |
| I-1 | + | II-29-2 |
| I-1 | + | II-29-3 |
| I-1 | + | II-29-4 |
| I-1 | + | II-29-5 |
| I-1 | + | II-29-6 |
| I-1 | + | II-29-7 |
| I-1 | + | II-29-8 |
| I-1 | + | II-29-9 |
| I-1 | + | II-29-10 |
| I-1 | + | II-29-11 |
| I-1 | + | II-29-12 |
| I-1 | + | II-29-13 |
| I-1 | + | II-29-14 |
| I-1 | + | II-29-15 |
| I-1 | + | II-29-16 |
| I-1 | + | II-29-17 |
| I-1 | + | II-29-18 |
| I-1 | + | II-29-19 |
| I-1 | + | II-29-20 |
| I-1 | + | II-29-21 |
| I-1 | + | II-29-22 |
| I-1 | + | II-29-23 |
| I-1 | + | II-29-24 |
| I-1 | + | II-29-25 |
| I-1 | + | II-29-26 |
| I-1 | + | II-29-27 |
| I-1 | + | II-29-28 |
| I-1 | + | II-29-29 |
| I-1 | + | II-29-30 |
| I-1 | + | II-29-31 |
| I-2 | + | II-1A-1 |
| I-2 | + | II-1A-2 |
| I-2 | + | II-1A-3 |
| I-2 | + | II-1A-4 |
| I-2 | + | II-1A-5 |
| I-2 | + | II-1A-6 |
| I-2 | + | II-1A-7 |
| I-2 | + | II-1A-8 |
| I-2 | + | II-1A-9 |
| I-2 | + | II-1A-10 |
| I-2 | + | II-1A-11 |
| I-2 | + | II-1A-12 |
| I-2 | + | II-1A-13 |
| I-2 | + | II-1A-14 |
| I-2 | + | II-1A-15 |
| I-2 | + | II-1A-16 |
| I-2 | + | II-1A-17 |
| I-2 | + | II-1A-18 |
| I-2 | + | II-1A-19 |
| I-2 | + | II-1A-20 |
| I-2 | + | II-1A-21 |
| I-2 | + | II-1A-22 |
| I-2 | + | II-1A-23 |
| I-2 | + | II-1A-24 |
| I-2 | + | II-1A-25 |
| I-2 | + | II-1A-26 |
| I-2 | + | II-1A-27 |
| I-2 | + | II-1A-28 |
| I-2 | + | II-1A-29 |
| I-2 | + | II-1A-30 |
| I-2 | + | II-1A-31 |
| I-2 | + | II-1A-32 |
| I-2 | + | II-1A-33 |
| I-2 | + | II-1A-34 |
| I-2 | + | II-1A-35 |
| I-2 | + | II-1B-1 |
| I-2 | + | II-1B-2 |
| I-2 | + | II-1B-3 |
| I-2 | + | II-1B-4 |
| I-2 | + | II-1B-5 |
| I-2 | + | II-1B-6 |
| I-2 | + | II-1B-7 |
| I-2 | + | II-1B-8 |
| I-2 | + | II-1B-9 |
| I-2 | + | II-1B-10 |
| I-2 | + | II-1B-11 |
| I-2 | + | II-1B-12 |
| I-2 | + | II-1B-13 |
| I-2 | + | II-1B-14 |
| I-2 | + | II-1B-15 |
| I-2 | + | II-1B-16 |
| I-2 | + | II-1B-17 |
| I-2 | + | II-1B-18 |
| I-2 | + | II-1B-19 |
| I-2 | + | II-1B-20 |
| I-2 | + | II-1B-21 |
| I-2 | + | II-1B-22 |
| I-2 | + | II-1B-23 |
| I-2 | + | II-1B-24 |
| I-2 | + | II-1B-25 |
| I-2 | + | II-1B-26 |
| I-2 | + | II-1B-27 |
| I-2 | + | II-1B-28 |
| I-2 | + | II-1B-29 |
| I-2 | + | II-1B-30 |
| I-2 | + | II-1B-31 |
| I-2 | + | II-1B-32 |
| I-2 | + | II-1B-33 |
| I-2 | + | II-1B-34 |
| I-2 | + | II-1B-35 |
| I-2 | + | II-1B-36 |
| I-2 | + | II-1B-37 |
| I-2 | + | II-1B-38 |
| I-2 | + | II-1B-39 |
| I-2 | + | II-1B-40 |
| I-2 | + | II-1B-41 |
| I-2 | + | II-1B-42 |
| I-2 | + | II-1B-43 |
| I-2 | + | II-1B-44 |
| I-2 | + | II-1B-45 |
| I-2 | + | II-1B-46 |
| I-2 | + | II-1B-47 |
| I-2 | + | II-1B-48 |
| I-2 | + | II-1B-49 |
| I-2 | + | II-1B-50 |
| I-2 | + | II-1B-51 |
| I-2 | + | II-1B-52 |
| I-2 | + | II-1B-53 |
| I-2 | + | II-1B-54 |
| I-2 | + | II-1B-55 |
| I-2 | + | II-1B-56 |
| I-2 | + | II-1B-57 |
| I-2 | + | II-1B-58 |
| I-2 | + | II-1B-59 |
| I-2 | + | II-1B-60 |
| I-2 | + | II-1B-61 |
| I-2 | + | II-1B-62 |
| I-2 | + | II-1B-63 |
| I-2 | + | II-1B-64 |
| I-2 | + | II-1B-65 |
| I-2 | + | II-1B-66 |
| I-2 | + | II-1B-67 |
| I-2 | + | II-1B-68 |
| I-2 | + | II-1B-69 |
| I-2 | + | II-1B-70 |
| I-2 | + | II-1B-71 |
| I-2 | + | II-1B-72 |
| I-2 | + | II-1B-73 |
| I-2 | + | II-1B-74 |
| I-2 | + | II-1B-75 |
| I-2 | + | II-1B-76 |
| I-2 | + | II-1B-77 |
| I-2 | + | II-1B-78 |
| I-2 | + | II-1B-79 |
| I-2 | + | II-1B-80 |
| I-2 | + | II-1B-81 |
| I-2 | + | II-1B-82 |
| I-2 | + | II-1B-83 |
| I-2 | + | II-1B-84 |
| I-2 | + | II-1B-85 |
| I-2 | + | II-1B-86 |
| I-2 | + | II-1B-87 |
| I-2 | + | II-1B-88 |
| I-2 | + | II-2A-1 |
| I-2 | + | II-2A-2 |
| I-2 | + | II-2A-3 |
| I-2 | + | II-2A-4 |
| I-2 | + | II-2A-5 |
| I-2 | + | II-2A-6 |
| I-2 | + | II-2A-7 |
| I-2 | + | II-2A-8 |
| I-2 | + | II-2B-1 |
| I-2 | + | II-2B-2 |
| I-2 | + | II-2B-3 |
| I-2 | + | II-2B-4 |
| I-2 | + | II-2B-5 |
| I-2 | + | II-2B-6 |
| I-2 | + | II-3-1 |
| I-2 | + | II-3-2 |
| I-2 | + | II-3-3 |
| I-2 | + | II-3-4 |
| I-2 | + | II-3-5 |
| I-2 | + | II-3-6 |
| I-2 | + | II-3-7 |
| I-2 | + | II-3-8 |
| I-2 | + | II-3-9 |
| I-2 | + | II-3-10 |
| I-2 | + | II-3-11 |
| I-2 | + | II-3-12 |
| I-2 | + | II-3-13 |
| I-2 | + | II-3-14 |
| I-2 | + | II-3-15 |
| I-2 | + | II-3-16 |
| I-2 | + | II-3-17 |
| I-2 | + | II-3-18 |
| I-2 | + | II-3-19 |
| I-2 | + | II-3-20 |
| I-2 | + | II-3-21 |
| I-2 | + | II-3-22 |
| I-2 | + | II-3-23 |
| I-2 | + | II-3-24 |
| I-2 | + | II-3-25 |
| I-2 | + | II-3-26 |
| I-2 | + | II-3-27 |
| I-2 | + | II-3-28 |
| I-2 | + | II-3-29 |
| I-2 | + | II-3-30 |
| I-2 | + | II-3-31 |
| I-2 | + | II-3-32 |
| I-2 | + | II-3-33 |
| I-2 | + | II-3-34 |
| I-2 | + | II-3-35 |
| I-2 | + | II-3-36 |
| I-2 | + | II-3-37 |
| I-2 | + | II-3-38 |
| I-2 | + | II-3-39 |
| I-2 | + | II-3-40 |
| I-2 | + | II-3-41 |
| I-2 | + | II-3-42 |
| I-2 | + | II-3-43 |
| I-2 | + | II-3-44 |
| I-2 | + | II-3-45 |
| I-2 | + | II-3-46 |
| I-2 | + | II-3-47 |
| I-2 | + | II-3-48 |
| I-2 | + | II-3-49 |
| I-2 | + | II-3-50 |
| I-2 | + | II-3-51 |
| I-2 | + | II-3-52 |
| I-2 | + | II-3-53 |
| I-2 | + | II-3-54 |
| I-2 | + | II-3-55 |
| I-2 | + | II-3-56 |
| I-2 | + | II-3-57 |
| I-2 | + | II-3-58 |
| I-2 | + | II-4A-1 |
| I-2 | + | II-4A-2 |
| I-2 | + | II-4A-3 |
| I-2 | + | II-4A-4 |
| I-2 | + | II-4A-5 |
| I-2 | + | II-4A-6 |
| I-2 | + | II-4A-7 |
| I-2 | + | II-4A-8 |
| I-2 | + | II-4A-9 |
| I-2 | + | II-4B-1 |
| I-2 | + | II-4B-2 |
| I-2 | + | II-4B-3 |
| I-2 | + | II-4B-4 |
| I-2 | + | II-4C-4 |
| I-2 | + | II-5-1 |
| I-2 | + | II-5-2 |
| I-2 | + | II-6-1 |
| I-2 | + | II-6-2 |
| I-2 | + | II-6-3 |
| I-2 | + | II-6-4 |
| I-2 | + | II-6-5 |
| I-2 | + | II-6-6 |
| I-2 | + | II-7A-1 |
| I-2 | + | II-7A-2 |
| I-2 | + | II-7A-3 |
| I-2 | + | II-7A-4 |
| I-2 | + | II-7A-5 |
| I-2 | + | II-7B-1 |
| I-2 | + | II-7C-1 |
| I-2 | + | II-7C-2 |
| I-2 | + | II-8A-1 |
| I-2 | + | II-8B-1 |
| I-2 | + | II-8C-1 |
| I-2 | + | II-9A-1 |
| I-2 | + | II-9B-1 |
| I-2 | + | II-9B-2 |
| I-2 | + | II-9C-1 |
| I-2 | + | II-10A-1 |
| I-2 | + | II-10A-2 |
| I-2 | + | II-10B-1 |
| I-2 | + | II-12A-1 |
| I-2 | + | II-12B-1 |
| I-2 | + | II-12B-2 |
| I-2 | + | II-12B-3 |
| I-2 | + | II-12C-1 |
| I-2 | + | II-12C-2 |
| I-2 | + | II-13-1 |
| I-2 | + | II-13-2 |
| I-2 | + | II-13-3 |
| I-2 | + | II-13-4 |
| I-2 | + | II-13-5 |
| I-2 | + | II-13-6 |
| I-2 | + | II-15-1 |
| I-2 | + | II-15-2 |
| I-2 | + | II-15-3 |
| I-2 | + | II-15-4 |
| I-2 | + | II-15-5 |
| I-2 | + | II-15-6 |
| I-2 | + | II-15-7 |
| I-2 | + | II-15-8 |
| I-2 | + | II-15-9 |
| I-2 | + | II-15-10 |
| I-2 | + | II-15-11 |
| I-2 | + | II-15-12 |
| I-2 | + | II-15-13 |
| I-2 | + | II-16-1 |
| I-2 | + | II-17-1 |
| I-2 | + | II-18A-1 |
| I-2 | + | II-18A-2 |
| I-2 | + | II-18A-3 |
| I-2 | + | II-18A-4 |
| I-2 | + | II-18A-5 |
| I-2 | + | II-18B-1 |
| I-2 | + | II-19-1 |
| I-2 | + | II-20A-1 |
| I-2 | + | II-20B-1 |
| I-2 | + | II-20C-1 |
| I-2 | + | II-20D-1 |
| I-2 | + | II-20D-2 |
| I-2 | + | II-21-1 |
| I-2 | + | II-21-2 |
| I-2 | + | II-21-3 |
| I-2 | + | II-21-4 |
| I-2 | + | II-21-5 |
| I-2 | + | II-21-6 |
| I-2 | + | II-21-7 |
| I-2 | + | II-22A-1 |
| I-2 | + | II-22B-1 |
| I-2 | + | II-23A-1 |
| I-2 | + | II-23A-2 |
| I-2 | + | II-23B-1 |
| I-2 | + | II-25-1 |
| I-2 | + | II-28-1 |
| I-2 | + | II-28-2 |
| I-2 | + | II-28-3 |
| I-2 | + | II-28-4 |
| I-2 | + | II-29-1 |
| I-2 | + | II-29-2 |
| I-2 | + | II-29-3 |
| I-2 | + | II-29-4 |
| I-2 | + | II-29-5 |
| I-2 | + | II-29-6 |
| I-2 | + | II-29-7 |
| I-2 | + | II-29-8 |
| I-2 | + | II-29-9 |
| I-2 | + | II-29-10 |
| I-2 | + | II-29-11 |
| I-2 | + | II-29-12 |
| I-2 | + | II-29-13 |
| I-2 | + | II-29-14 |
| I-2 | + | II-29-15 |
| I-2 | + | II-29-16 |
| I-2 | + | II-29-17 |
| I-2 | + | II-29-18 |
| I-2 | + | II-29-19 |
| I-2 | + | II-29-20 |
| I-2 | + | II-29-21 |
| I-2 | + | II-29-22 |
| I-2 | + | II-29-23 |
| I-2 | + | II-29-24 |
| I-2 | + | II-29-25 |
| I-2 | + | II-29-26 |
| I-2 | + | II-29-27 |
| I-2 | + | II-29-28 |
| I-2 | + | II-29-29 |
| I-2 | + | II-29-30 |
| I-2 | + | II-29-31 |
| I-3 | + | II-1A-1 |
| I-3 | + | II-1A-2 |
| I-3 | + | II-1A-3 |
| I-3 | + | II-1A-4 |
| I-3 | + | II-1A-5 |
| I-3 | + | II-1A-6 |
| I-3 | + | II-1A-7 |
| I-3 | + | II-1A-8 |
| I-3 | + | II-1A-9 |
| I-3 | + | II-1A-10 |
| I-3 | + | II-1A-11 |
| I-3 | + | II-1A-12 |
| I-3 | + | II-1A-13 |
| I-3 | + | II-1A-14 |
| I-3 | + | II-1A-15 |
| I-3 | + | II-1A-16 |
| I-3 | + | II-1A-17 |
| I-3 | + | II-1A-18 |
| I-3 | + | II-1A-19 |
| I-3 | + | II-1A-20 |
| I-3 | + | II-1A-21 |
| I-3 | + | II-1A-22 |
| I-3 | + | II-1A-23 |
| I-3 | + | II-1A-24 |
| I-3 | + | II-1A-25 |
| I-3 | + | II-1A-26 |
| I-3 | + | II-1A-27 |
| I-3 | + | II-1A-28 |
| I-3 | + | II-1A-29 |
| I-3 | + | II-1A-30 |
| I-3 | + | II-1A-31 |
| I-3 | + | II-1A-32 |
| I-3 | + | II-1A-33 |
| I-3 | + | II-1A-34 |
| I-3 | + | II-1A-35 |
| I-3 | + | II-1B-1 |
| I-3 | + | II-1B-2 |
| I-3 | + | II-1B-3 |
| I-3 | + | II-1B-4 |
| I-3 | + | II-1B-5 |
| I-3 | + | II-1B-6 |
| I-3 | + | II-1B-7 |
| I-3 | + | II-1B-8 |
| I-3 | + | II-1B-9 |
| I-3 | + | II-1B-10 |
| I-3 | + | II-1B-11 |
| I-3 | + | II-1B-12 |
| I-3 | + | II-1B-13 |
| I-3 | + | II-1B-14 |
| I-3 | + | II-1B-15 |
| I-3 | + | II-1B-16 |
| I-3 | + | II-1B-17 |
| I-3 | + | II-1B-18 |
| I-3 | + | II-1B-19 |
| I-3 | + | II-1B-20 |
| I-3 | + | II-1B-21 |
| I-3 | + | II-1B-22 |
| I-3 | + | II-1B-23 |
| I-3 | + | II-1B-24 |
| I-3 | + | II-1B-25 |
| I-3 | + | II-1B-26 |
| I-3 | + | II-1B-27 |
| I-3 | + | II-1B-28 |
| I-3 | + | II-1B-29 |
| I-3 | + | II-1B-30 |
| I-3 | + | II-1B-31 |
| I-3 | + | II-1B-32 |
| I-3 | + | II-1B-33 |
| I-3 | + | II-1B-34 |
| I-3 | + | II-1B-35 |
| I-3 | + | II-1B-36 |
| I-3 | + | II-1B-37 |
| I-3 | + | II-1B-38 |
| I-3 | + | II-1B-39 |
| I-3 | + | II-1B-40 |
| I-3 | + | II-1B-41 |
| I-3 | + | II-1B-42 |
| I-3 | + | II-1B-43 |
| I-3 | + | II-1B-44 |
| I-3 | + | II-1B-45 |
| I-3 | + | II-1B-46 |
| I-3 | + | II-1B-47 |
| I-3 | + | II-1B-48 |
| I-3 | + | II-1B-49 |
| I-3 | + | II-1B-50 |
| I-3 | + | II-1B-51 |
| I-3 | + | II-1B-52 |
| I-3 | + | II-1B-53 |
| I-3 | + | II-1B-54 |
| I-3 | + | II-1B-55 |
| I-3 | + | II-1B-56 |
| I-3 | + | II-1B-57 |
| I-3 | + | II-1B-58 |
| I-3 | + | II-1B-59 |
| I-3 | + | II-1B-60 |
| I-3 | + | II-1B-61 |
| I-3 | + | II-1B-62 |
| I-3 | + | II-1B-63 |
| I-3 | + | II-1B-64 |
| I-3 | + | II-1B-65 |
| I-3 | + | II-1B-66 |
| I-3 | + | II-1B-67 |
| I-3 | + | II-1B-68 |
| I-3 | + | II-1B-69 |
| I-3 | + | II-1B-70 |
| I-3 | + | II-1B-71 |
| I-3 | + | II-1B-72 |
| I-3 | + | II-1B-73 |
| I-3 | + | II-1B-74 |
| I-3 | + | II-1B-75 |
| I-3 | + | II-1B-76 |
| I-3 | + | II-1B-77 |
| I-3 | + | II-1B-78 |
| I-3 | + | II-1B-79 |
| I-3 | + | II-1B-80 |
| I-3 | + | II-1B-81 |
| I-3 | + | II-1B-82 |
| I-3 | + | II-1B-83 |
| I-3 | + | II-1B-84 |
| I-3 | + | II-1B-85 |
| I-3 | + | II-1B-86 |
| I-3 | + | II-1B-87 |
| I-3 | + | II-1B-88 |
| I-3 | + | II-2A-1 |
| I-3 | + | II-2A-2 |
| I-3 | + | II-2A-3 |
| I-3 | + | II-2A-4 |
| I-3 | + | II-2A-5 |
| I-3 | + | II-2A-6 |
| I-3 | + | II-2A-7 |
| I-3 | + | II-2A-8 |
| I-3 | + | II-2B-1 |
| I-3 | + | II-2B-2 |
| I-3 | + | II-2B-3 |
| I-3 | + | II-2B-4 |
| I-3 | + | II-2B-5 |
| I-3 | + | II-2B-6 |
| I-3 | + | II-3-1 |
| I-3 | + | II-3-2 |
| I-3 | + | II-3-3 |
| I-3 | + | II-3-4 |
| I-3 | + | II-3-5 |
| I-3 | + | II-3-6 |
| I-3 | + | II-3-7 |
| I-3 | + | II-3-8 |
| I-3 | + | II-3-9 |
| I-3 | + | II-3-10 |
| I-3 | + | II-3-11 |
| I-3 | + | II-3-12 |
| I-3 | + | II-3-13 |
| I-3 | + | II-3-14 |
| I-3 | + | II-3-15 |
| I-3 | + | II-3-16 |
| I-3 | + | II-3-17 |
| I-3 | + | II-3-18 |
| I-3 | + | II-3-19 |
| I-3 | + | II-3-20 |
| I-3 | + | II-3-21 |
| I-3 | + | II-3-22 |
| I-3 | + | II-3-23 |
| I-3 | + | II-3-24 |
| I-3 | + | II-3-25 |
| I-3 | + | II-3-26 |
| I-3 | + | II-3-27 |
| I-3 | + | II-3-28 |
| I-3 | + | II-3-29 |
| I-3 | + | II-3-30 |
| I-3 | + | II-3-31 |
| I-3 | + | II-3-32 |
| I-3 | + | II-3-33 |
| I-3 | + | II-3-34 |
| I-3 | + | II-3-35 |
| I-3 | + | II-3-36 |
| I-3 | + | II-3-37 |
| I-3 | + | II-3-38 |
| I-3 | + | II-3-39 |
| I-3 | + | II-3-40 |
| I-3 | + | II-3-41 |
| I-3 | + | II-3-42 |
| I-3 | + | II-3-43 |
| I-3 | + | II-3-44 |
| I-3 | + | II-3-45 |
| I-3 | + | II-3-46 |
| I-3 | + | II-3-47 |
| I-3 | + | II-3-48 |
| I-3 | + | II-3-49 |
| I-3 | + | II-3-50 |
| I-3 | + | II-3-51 |
| I-3 | + | II-3-52 |
| I-3 | + | II-3-53 |
| I-3 | + | II-3-54 |
| I-3 | + | II-3-55 |
| I-3 | + | II-3-56 |
| I-3 | + | II-3-57 |
| I-3 | + | II-3-58 |
| I-3 | + | II-4A-1 |
| I-3 | + | II-4A-2 |
| I-3 | + | II-4A-3 |
| I-3 | + | II-4A-4 |
| I-3 | + | II-4A-5 |
| I-3 | + | II-4A-6 |
| I-3 | + | II-4A-7 |
| I-3 | + | II-4A-8 |
| I-3 | + | II-4A-9 |
| I-3 | + | II-4B-1 |
| I-3 | + | II-4B-2 |
| I-3 | + | II-4B-3 |
| I-3 | + | II-4B-4 |
| I-3 | + | II-4C-4 |
| I-3 | + | II-5-1 |
| I-3 | + | II-5-2 |
| I-3 | + | II-6-1 |
| I-3 | + | II-6-2 |
| I-3 | + | II-6-3 |
| I-3 | + | II-6-4 |
| I-3 | + | II-6-5 |
| I-3 | + | II-6-6 |
| I-3 | + | II-7A-1 |
| I-3 | + | II-7A-2 |
| I-3 | + | II-7A-3 |
| I-3 | + | II-7A-4 |
| I-3 | + | II-7A-5 |
| I-3 | + | II-7B-1 |
| I-3 | + | II-7C-1 |
| I-3 | + | II-7C-2 |
| I-3 | + | II-8A-1 |
| I-3 | + | II-8B-1 |
| I-3 | + | II-8C-1 |
| I-3 | + | II-9A-1 |
| I-3 | + | II-9B-1 |
| I-3 | + | II-9B-2 |
| I-3 | + | II-9C-1 |
| I-3 | + | II-10A-1 |
| I-3 | + | II-10A-2 |
| I-3 | + | II-10B-1 |
| I-3 | + | II-12A-1 |
| I-3 | + | II-12B-1 |
| I-3 | + | II-12B-2 |
| I-3 | + | II-12B-3 |
| I-3 | + | II-12C-1 |
| I-3 | + | II-12C-2 |
| I-3 | + | II-13-1 |
| I-3 | + | II-13-2 |
| I-3 | + | II-13-3 |
| I-3 | + | II-13-4 |
| I-3 | + | II-13-5 |
| I-3 | + | II-13-6 |
| I-3 | + | II-15-1 |
| I-3 | + | II-15-2 |
| I-3 | + | II-15-3 |
| I-3 | + | II-15-4 |
| I-3 | + | II-15-5 |
| I-3 | + | II-15-6 |
| I-3 | + | II-15-7 |
| I-3 | + | II-15-8 |
| I-3 | + | II-15-9 |
| I-3 | + | II-15-10 |
| I-3 | + | II-15-11 |
| I-3 | + | II-15-12 |
| I-3 | + | II-15-13 |
| I-3 | + | II-16-1 |
| I-3 | + | II-17-1 |
| I-3 | + | II-18A-1 |
| I-3 | + | II-18A-2 |
| I-3 | + | II-18A-3 |
| I-3 | + | II-18A-4 |
| I-3 | + | II-18A-5 |
| I-3 | + | II-18B-1 |
| I-3 | + | II-19-1 |
| I-3 | + | II-20A-1 |
| I-3 | + | II-20B-1 |
| I-3 | + | II-20C-1 |
| I-3 | + | II-20D-1 |
| I-3 | + | II-20D-2 |
| I-3 | + | II-21-1 |
| I-3 | + | II-21-2 |
| I-3 | + | II-21-3 |
| I-3 | + | II-21-4 |
| I-3 | + | II-21-5 |
| I-3 | + | II-21-6 |
| I-3 | + | II-21-7 |
| I-3 | + | II-22A-1 |
| I-3 | + | II-22B-1 |
| I-3 | + | II-23A-1 |
| I-3 | + | II-23A-2 |
| I-3 | + | II-23B-1 |
| I-3 | + | II-25-1 |
| I-3 | + | II-28-1 |
| I-3 | + | II-28-2 |
| I-3 | + | II-28-3 |
| I-3 | + | II-28-4 |
| I-3 | + | II-29-1 |
| I-3 | + | II-29-2 |
| I-3 | + | II-29-3 |
| I-3 | + | II-29-4 |
| I-3 | + | II-29-5 |
| I-3 | + | II-29-6 |
| I-3 | + | II-29-7 |
| I-3 | + | II-29-8 |
| I-3 | + | II-29-9 |
| I-3 | + | II-29-10 |
| I-3 | + | II-29-11 |
| I-3 | + | II-29-12 |
| I-3 | + | II-29-13 |
| I-3 | + | II-29-14 |
| I-3 | + | II-29-15 |
| I-3 | + | II-29-16 |
| I-3 | + | II-29-17 |
| I-3 | + | II-29-18 |
| I-3 | + | II-29-19 |
| I-3 | + | II-29-20 |
| I-3 | + | II-29-21 |
| I-3 | + | II-29-22 |
| I-3 | + | II-29-23 |
| I-3 | + | II-29-24 |
| I-3 | + | II-29-25 |
| I-3 | + | II-29-26 |
| I-3 | + | II-29-27 |
| I-3 | + | II-29-28 |
| I-3 | + | II-29-29 |
| I-3 | + | II-29-30 |
| I-3 | + | II-29-31 |
| I-4 | + | II-1A-1 |
| I-4 | + | II-1A-2 |
| I-4 | + | II-1A-3 |
| I-4 | + | II-1A-4 |
| I-4 | + | II-1A-5 |
| I-4 | + | II-1A-6 |
| I-4 | + | II-1A-7 |
| I-4 | + | II-1A-8 |
| I-4 | + | II-1A-9 |
| I-4 | + | II-1A-10 |
| I-4 | + | II-1A-11 |
| I-4 | + | II-1A-12 |
| I-4 | + | II-1A-13 |
| I-4 | + | II-1A-14 |
| I-4 | + | II-1A-15 |
| I-4 | + | II-1A-16 |
| I-4 | + | II-1A-17 |
| I-4 | + | II-1A-18 |
| I-4 | + | II-1A-19 |
| I-4 | + | II-1A-20 |
| I-4 | + | II-1A-21 |
| I-4 | + | II-1A-22 |
| I-4 | + | II-1A-23 |
| I-4 | + | II-1A-24 |
| I-4 | + | II-1A-25 |
| I-4 | + | II-1A-26 |
| I-4 | + | II-1A-27 |
| I-4 | + | II-1A-28 |
| I-4 | + | II-1A-29 |
| I-4 | + | II-1A-30 |
| I-4 | + | II-1A-31 |
| I-4 | + | II-1A-32 |
| I-4 | + | II-1A-33 |
| I-4 | + | II-1A-34 |
| I-4 | + | II-1A-35 |
| I-4 | + | II-1B-1 |
| I-4 | + | II-1B-2 |
| I-4 | + | II-1B-3 |
| I-4 | + | II-1B-4 |
| I-4 | + | II-1B-5 |
| I-4 | + | II-1B-6 |
| I-4 | + | II-1B-7 |
| I-4 | + | II-1B-8 |
| I-4 | + | II-1B-9 |
| I-4 | + | II-1B-10 |
| I-4 | + | II-1B-11 |
| I-4 | + | II-1B-12 |
| I-4 | + | II-1B-13 |
| I-4 | + | II-1B-14 |
| I-4 | + | II-1B-15 |
| I-4 | + | II-1B-16 |
| I-4 | + | II-1B-17 |
| I-4 | + | II-1B-18 |
| I-4 | + | II-1B-19 |
| I-4 | + | II-1B-20 |
| I-4 | + | II-1B-21 |
| I-4 | + | II-1B-22 |
| I-4 | + | II-1B-23 |
| I-4 | + | II-1B-24 |
| I-4 | + | II-1B-25 |
| I-4 | + | II-1B-26 |
| I-4 | + | II-1B-27 |
| I-4 | + | II-1B-28 |
| I-4 | + | II-1B-29 |
| I-4 | + | II-1B-30 |
| I-4 | + | II-1B-31 |
| I-4 | + | II-1B-32 |
| I-4 | + | II-1B-33 |
| I-4 | + | II-1B-34 |
| I-4 | + | II-1B-35 |
| I-4 | + | II-1B-36 |
| I-4 | + | II-1B-37 |
| I-4 | + | II-1B-38 |
| I-4 | + | II-1B-39 |
| I-4 | + | II-1B-40 |
| I-4 | + | II-1B-41 |
| I-4 | + | II-1B-42 |
| I-4 | + | II-1B-43 |
| I-4 | + | II-1B-44 |
| I-4 | + | II-1B-45 |
| I-4 | + | II-1B-46 |
| I-4 | + | II-1B-47 |
| I-4 | + | II-1B-48 |
| I-4 | + | II-1B-49 |
| I-4 | + | II-1B-50 |
| I-4 | + | II-1B-51 |
| I-4 | + | II-1B-52 |
| I-4 | + | II-1B-53 |
| I-4 | + | II-1B-54 |
| I-4 | + | II-1B-55 |
| I-4 | + | II-1B-56 |
| I-4 | + | II-1B-57 |
| I-4 | + | II-1B-58 |
| I-4 | + | II-1B-59 |
| I-4 | + | II-1B-60 |
| I-4 | + | II-1B-61 |
| I-4 | + | II-1B-62 |
| I-4 | + | II-1B-63 |
| I-4 | + | II-1B-64 |
| I-4 | + | II-1B-65 |
| I-4 | + | II-1B-66 |
| I-4 | + | II-1B-67 |
| I-4 | + | II-1B-68 |
| I-4 | + | II-1B-69 |
| I-4 | + | II-1B-70 |
| I-4 | + | II-1B-71 |
| I-4 | + | II-1B-72 |
| I-4 | + | II-1B-73 |
| I-4 | + | II-1B-74 |
| I-4 | + | II-1B-75 |
| I-4 | + | II-1B-76 |
| I-4 | + | II-1B-77 |
| I-4 | + | II-1B-78 |
| I-4 | + | II-1B-79 |
| I-4 | + | II-1B-80 |
| I-4 | + | II-1B-81 |
| I-4 | + | II-1B-82 |
| I-4 | + | II-1B-83 |
| I-4 | + | II-1B-84 |
| I-4 | + | II-1B-85 |
| I-4 | + | II-1B-86 |
| I-4 | + | II-1B-87 |
| I-4 | + | II-1B-88 |
| I-4 | + | II-2A-1 |
| I-4 | + | II-2A-2 |
| I-4 | + | II-2A-3 |
| I-4 | + | II-2A-4 |
| I-4 | + | II-2A-5 |
| I-4 | + | II-2A-6 |
| I-4 | + | II-2A-7 |
| I-4 | + | II-2A-8 |
| I-4 | + | II-2B-1 |
| I-4 | + | II-2B-2 |
| I-4 | + | II-2B-3 |
| I-4 | + | II-2B-4 |
| I-4 | + | II-2B-5 |
| I-4 | + | II-2B-6 |
| I-4 | + | II-3-1 |
| I-4 | + | II-3-2 |
| I-4 | + | II-3-3 |
| I-4 | + | II-3-4 |
| I-4 | + | II-3-5 |
| I-4 | + | II-3-6 |
| I-4 | + | II-3-7 |
| I-4 | + | II-3-8 |
| I-4 | + | II-3-9 |
| I-4 | + | II-3-10 |
| I-4 | + | II-3-11 |
| I-4 | + | II-3-12 |
| I-4 | + | II-3-13 |
| I-4 | + | II-3-14 |
| I-4 | + | II-3-15 |
| I-4 | + | II-3-16 |
| I-4 | + | II-3-17 |
| I-4 | + | II-3-18 |
| I-4 | + | II-3-19 |
| I-4 | + | II-3-20 |
| I-4 | + | II-3-21 |
| I-4 | + | II-3-22 |
| I-4 | + | II-3-23 |
| I-4 | + | II-3-24 |
| I-4 | + | II-3-25 |
| I-4 | + | II-3-26 |
| I-4 | + | II-3-27 |
| I-4 | + | II-3-28 |
| I-4 | + | II-3-29 |
| I-4 | + | II-3-30 |
| I-4 | + | II-3-31 |
| I-4 | + | II-3-32 |
| I-4 | + | II-3-33 |
| I-4 | + | II-3-34 |
| I-4 | + | II-3-35 |
| I-4 | + | II-3-36 |
| I-4 | + | II-3-37 |
| I-4 | + | II-3-38 |
| I-4 | + | II-3-39 |
| I-4 | + | II-3-40 |
| I-4 | + | II-3-41 |
| I-4 | + | II-3-42 |
| I-4 | + | II-3-43 |
| I-4 | + | II-3-44 |
| I-4 | + | II-3-45 |
| I-4 | + | II-3-46 |
| I-4 | + | II-3-47 |
| I-4 | + | II-3-48 |
| I-4 | + | II-3-49 |
| I-4 | + | II-3-50 |
| I-4 | + | II-3-51 |
| I-4 | + | II-3-52 |
| I-4 | + | II-3-53 |
| I-4 | + | II-3-54 |
| I-4 | + | II-3-55 |
| I-4 | + | II-3-56 |
| I-4 | + | II-3-57 |
| I-4 | + | II-3-58 |
| I-4 | + | II-4A-1 |
| I-4 | + | II-4A-2 |
| I-4 | + | II-4A-3 |
| I-4 | + | II-4A-4 |
| I-4 | + | II-4A-5 |
| I-4 | + | II-4A-6 |
| I-4 | + | II-4A-7 |
| I-4 | + | II-4A-8 |
| I-4 | + | II-4A-9 |
| I-4 | + | II-4B-1 |
| I-4 | + | II-4B-2 |
| I-4 | + | II-4B-3 |
| I-4 | + | II-4B-4 |
| I-4 | + | II-4C-4 |
| I-4 | + | II-5-1 |
| I-4 | + | II-5-2 |
| I-4 | + | II-6-1 |
| I-4 | + | II-6-2 |
| I-4 | + | II-6-3 |
| I-4 | + | II-6-4 |
| I-4 | + | II-6-5 |
| I-4 | + | II-6-6 |
| I-4 | + | II-7A-1 |
| I-4 | + | II-7A-2 |
| I-4 | + | II-7A-3 |
| I-4 | + | II-7A-4 |
| I-4 | + | II-7A-5 |
| I-4 | + | II-7B-1 |
| I-4 | + | II-7C-1 |
| I-4 | + | II-7C-2 |
| I-4 | + | II-8A-1 |
| I-4 | + | II-8B-1 |
| I-4 | + | II-8C-1 |
| I-4 | + | II-9A-1 |
| I-4 | + | II-9B-1 |
| I-4 | + | II-9B-2 |
| I-4 | + | II-9C-1 |
| I-4 | + | II-10A-1 |
| I-4 | + | II-10A-2 |
| I-4 | + | II-10B-1 |
| I-4 | + | II-12A-1 |
| I-4 | + | II-12B-1 |
| I-4 | + | II-12B-2 |
| I-4 | + | II-12B-3 |
| I-4 | + | II-12C-1 |
| I-4 | + | II-12C-2 |
| I-4 | + | II-13-1 |
| I-4 | + | II-13-2 |
| I-4 | + | II-13-3 |
| I-4 | + | II-13-4 |
| I-4 | + | II-13-5 |
| I-4 | + | II-13-6 |
| I-4 | + | II-15-1 |
| I-4 | + | II-15-2 |
| I-4 | + | II-15-3 |
| I-4 | + | II-15-4 |
| I-4 | + | II-15-5 |
| I-4 | + | II-15-6 |
| I-4 | + | II-15-7 |
| I-4 | + | II-15-8 |
| I-4 | + | II-15-9 |
| I-4 | + | II-15-10 |
| I-4 | + | II-15-11 |
| I-4 | + | II-15-12 |
| I-4 | + | II-15-13 |
| I-4 | + | II-16-1 |
| I-4 | + | II-17-1 |
| I-4 | + | II-18A-1 |
| I-4 | + | II-18A-2 |
| I-4 | + | II-18A-3 |
| I-4 | + | II-18A-4 |
| I-4 | + | II-18A-5 |
| I-4 | + | II-18B-1 |
| I-4 | + | II-19-1 |
| I-4 | + | II-20A-1 |
| I-4 | + | II-20B-1 |
| I-4 | + | II-20C-1 |
| I-4 | + | II-20D-1 |
| I-4 | + | II-20D-2 |
| I-4 | + | II-21-1 |
| I-4 | + | II-21-2 |
| I-4 | + | II-21-3 |
| I-4 | + | II-21-4 |
| I-4 | + | II-21-5 |
| I-4 | + | II-21-6 |
| I-4 | + | II-21-7 |
| I-4 | + | II-22A-1 |
| I-4 | + | II-22B-1 |
| I-4 | + | II-23A-1 |
| I-4 | + | II-23A-2 |
| I-4 | + | II-23B-1 |
| I-4 | + | II-25-1 |
| I-4 | + | II-28-1 |
| I-4 | + | II-28-2 |
| I-4 | + | II-28-3 |
| I-4 | + | II-28-4 |
| I-4 | + | II-29-1 |
| I-4 | + | II-29-2 |
| I-4 | + | II-29-3 |
| I-4 | + | II-29-4 |
| I-4 | + | II-29-5 |
| I-4 | + | II-29-6 |
| I-4 | + | II-29-7 |
| I-4 | + | II-29-8 |
| I-4 | + | II-29-9 |
| I-4 | + | II-29-10 |
| I-4 | + | II-29-11 |
| I-4 | + | II-29-12 |
| I-4 | + | II-29-13 |
| I-4 | + | II-29-14 |
| I-4 | + | II-29-15 |
| I-4 | + | II-29-16 |
| I-4 | + | II-29-17 |
| I-4 | + | II-29-18 |
| I-4 | + | II-29-19 |
| I-4 | + | II-29-20 |
| I-4 | + | II-29-21 |
| I-4 | + | II-29-22 |
| I-4 | + | II-29-23 |
| I-4 | + | II-29-24 |
| I-4 | + | II-29-25 |
| I-4 | + | II-29-26 |
| I-4 | + | II-29-27 |
| I-4 | + | II-29-28 |
| I-4 | + | II-29-29 |
| I-4 | + | II-29-30 |
| I-4 | + | II-29-31 |
| I-5 | + | II-1A-1 |
| I-5 | + | II-1A-2 |
| I-5 | + | II-1A-3 |
| I-5 | + | II-1A-4 |
| I-5 | + | II-1A-5 |
| I-5 | + | II-1A-6 |
| I-5 | + | II-1A-7 |
| I-5 | + | II-1A-8 |
| I-5 | + | II-1A-9 |
| I-5 | + | II-1A-10 |
| I-5 | + | II-1A-11 |
| I-5 | + | II-1A-12 |
| I-5 | + | II-1A-13 |
| I-5 | + | II-1A-14 |
| I-5 | + | II-1A-15 |
| I-5 | + | II-1A-16 |
| I-5 | + | II-1A-17 |
| I-5 | + | II-1A-18 |
| I-5 | + | II-1A-19 |
| I-5 | + | II-1A-20 |
| I-5 | + | II-1A-21 |
| I-5 | + | II-1A-22 |
| I-5 | + | II-1A-23 |
| I-5 | + | II-1A-24 |
| I-5 | + | II-1A-25 |
| I-5 | + | II-1A-26 |
| I-5 | + | II-1A-27 |
| I-5 | + | II-1A-28 |
| I-5 | + | II-1A-29 |
| I-5 | + | II-1A-30 |
| I-5 | + | II-1A-31 |
| I-5 | + | II-1A-32 |
| I-5 | + | II-1A-33 |
| I-5 | + | II-1A-34 |
| I-5 | + | II-1A-35 |
| I-5 | + | II-1B-1 |
| I-5 | + | II-1B-2 |
| I-5 | + | II-1B-3 |
| I-5 | + | II-1B-4 |
| I-5 | + | II-1B-5 |
| I-5 | + | II-1B-6 |
| I-5 | + | II-1B-7 |
| I-5 | + | II-1B-8 |
| I-5 | + | II-1B-9 |
| I-5 | + | II-1B-10 |
| I-5 | + | II-1B-11 |
| I-5 | + | II-1B-12 |
| I-5 | + | II-1B-13 |
| I-5 | + | II-1B-14 |
| I-5 | + | II-1B-15 |
| I-5 | + | II-1B-16 |
| I-5 | + | II-1B-17 |
| I-5 | + | II-1B-18 |
| I-5 | + | II-1B-19 |
| I-5 | + | II-1B-20 |
| I-5 | + | II-1B-21 |
| I-5 | + | II-1B-22 |
| I-5 | + | II-1B-23 |
| I-5 | + | II-1B-24 |
| I-5 | + | II-1B-25 |
| I-5 | + | II-1B-26 |
| I-5 | + | II-1B-27 |
| I-5 | + | II-1B-28 |
| I-5 | + | II-1B-29 |
| I-5 | + | II-1B-30 |
| I-5 | + | II-1B-31 |
| I-5 | + | II-1B-32 |
| I-5 | + | II-1B-33 |
| I-5 | + | II-1B-34 |
| I-5 | + | II-1B-35 |
| I-5 | + | II-1B-36 |
| I-5 | + | II-1B-37 |
| I-5 | + | II-1B-38 |
| I-5 | + | II-1B-39 |
| I-5 | + | II-1B-40 |
| I-5 | + | II-1B-41 |
| I-5 | + | II-1B-42 |
| I-5 | + | II-1B-43 |
| I-5 | + | II-1B-44 |
| I-5 | + | II-1B-45 |
| I-5 | + | II-1B-46 |
| I-5 | + | II-1B-47 |
| I-5 | + | II-1B-48 |
| I-5 | + | II-1B-49 |
| I-5 | + | II-1B-50 |
| I-5 | + | II-1B-51 |
| I-5 | + | II-1B-52 |
| I-5 | + | II-1B-53 |
| I-5 | + | II-1B-54 |
| I-5 | + | II-1B-55 |
| I-5 | + | II-1B-56 |
| I-5 | + | II-1B-57 |
| I-5 | + | II-1B-58 |
| I-5 | + | II-1B-59 |
| I-5 | + | II-1B-60 |
| I-5 | + | II-1B-61 |
| I-5 | + | II-1B-62 |
| I-5 | + | II-1B-63 |
| I-5 | + | II-1B-64 |
| I-5 | + | II-1B-65 |
| I-5 | + | II-1B-66 |
| I-5 | + | II-1B-67 |
| I-5 | + | II-1B-68 |
| I-5 | + | II-1B-69 |
| I-5 | + | II-1B-70 |
| I-5 | + | II-1B-71 |
| I-5 | + | II-1B-72 |
| I-5 | + | II-1B-73 |
| I-5 | + | II-1B-74 |
| I-5 | + | II-1B-75 |
| I-5 | + | II-1B-76 |
| I-5 | + | II-1B-77 |
| I-5 | + | II-1B-78 |
| I-5 | + | II-1B-79 |
| I-5 | + | II-1B-80 |
| I-5 | + | II-1B-81 |
| I-5 | + | II-1B-82 |
| I-5 | + | II-1B-83 |
| I-5 | + | II-1B-84 |
| I-5 | + | II-1B-85 |
| I-5 | + | II-1B-86 |
| I-5 | + | II-1B-87 |
| I-5 | + | II-1B-88 |
| I-5 | + | II-2A-1 |
| I-5 | + | II-2A-2 |
| I-5 | + | II-2A-3 |
| I-5 | + | II-2A-4 |
| I-5 | + | II-2A-5 |
| I-5 | + | II-2A-6 |
| I-5 | + | II-2A-7 |
| I-5 | + | II-2A-8 |
| I-5 | + | II-2B-1 |
| I-5 | + | II-2B-2 |
| I-5 | + | II-2B-3 |
| I-5 | + | II-2B-4 |
| I-5 | + | II-2B-5 |
| I-5 | + | II-2B-6 |
| I-5 | + | II-3-1 |
| I-5 | + | II-3-2 |
| I-5 | + | II-3-3 |
| I-5 | + | II-3-4 |
| I-5 | + | II-3-5 |
| I-5 | + | II-3-6 |
| I-5 | + | II-3-7 |
| I-5 | + | II-3-8 |
| I-5 | + | II-3-9 |
| I-5 | + | II-3-10 |
| I-5 | + | II-3-11 |
| I-5 | + | II-3-12 |
| I-5 | + | II-3-13 |
| I-5 | + | II-3-14 |
| I-5 | + | II-3-15 |
| I-5 | + | II-3-16 |
| I-5 | + | II-3-17 |
| I-5 | + | II-3-18 |
| I-5 | + | II-3-19 |
| I-5 | + | II-3-20 |
| I-5 | + | II-3-21 |
| I-5 | + | II-3-22 |
| I-5 | + | II-3-23 |
| I-5 | + | II-3-24 |
| I-5 | + | II-3-25 |
| I-5 | + | II-3-26 |
| I-5 | + | II-3-27 |
| I-5 | + | II-3-28 |
| I-5 | + | II-3-29 |
| I-5 | + | II-3-30 |
| I-5 | + | II-3-31 |
| I-5 | + | II-3-32 |
| I-5 | + | II-3-33 |
| I-5 | + | II-3-34 |
| I-5 | + | II-3-35 |
| I-5 | + | II-3-36 |
| I-5 | + | II-3-37 |
| I-5 | + | II-3-38 |
| I-5 | + | II-3-39 |
| I-5 | + | II-3-40 |
| I-5 | + | II-3-41 |
| I-5 | + | II-3-42 |
| I-5 | + | II-3-43 |
| I-5 | + | II-3-44 |
| I-5 | + | II-3-45 |
| I-5 | + | II-3-46 |
| I-5 | + | II-3-47 |
| I-5 | + | II-3-48 |
| I-5 | + | II-3-49 |
| I-5 | + | II-3-50 |
| I-5 | + | II-3-51 |
| I-5 | + | II-3-52 |
| I-5 | + | II-3-53 |
| I-5 | + | II-3-54 |
| I-5 | + | II-3-55 |
| I-5 | + | II-3-56 |
| I-5 | + | II-3-57 |
| I-5 | + | II-3-58 |
| I-5 | + | II-4A-1 |
| I-5 | + | II-4A-2 |
| I-5 | + | II-4A-3 |
| I-5 | + | II-4A-4 |
| I-5 | + | II-4A-5 |
| I-5 | + | II-4A-6 |
| I-5 | + | II-4A-7 |
| I-5 | + | II-4A-8 |
| I-5 | + | II-4A-9 |
| I-5 | + | II-4B-1 |
| I-5 | + | II-4B-2 |
| I-5 | + | II-4B-3 |
| I-5 | + | II-4B-4 |
| I-5 | + | II-4C-4 |
| I-5 | + | II-5-1 |
| I-5 | + | II-5-2 |
| I-5 | + | II-6-1 |
| I-5 | + | II-6-2 |
| I-5 | + | II-6-3 |
| I-5 | + | II-6-4 |
| I-5 | + | II-6-5 |
| I-5 | + | II-6-6 |
| I-5 | + | II-7A-1 |
| I-5 | + | II-7A-2 |
| I-5 | + | II-7A-3 |
| I-5 | + | II-7A-4 |
| I-5 | + | II-7A-5 |
| I-5 | + | II-7B-1 |
| I-5 | + | II-7C-1 |
| I-5 | + | II-7C-2 |
| I-5 | + | II-8A-1 |
| I-5 | + | II-8B-1 |
| I-5 | + | II-8C-1 |
| I-5 | + | II-9A-1 |
| I-5 | + | II-9B-1 |
| I-5 | + | II-9B-2 |
| I-5 | + | II-9C-1 |
| I-5 | + | II-10A-1 |
| I-5 | + | II-10A-2 |
| I-5 | + | II-10B-1 |
| I-5 | + | II-12A-1 |
| I-5 | + | II-12B-1 |
| I-5 | + | II-12B-2 |
| I-5 | + | II-12B-3 |
| I-5 | + | II-12C-1 |
| I-5 | + | II-12C-2 |
| I-5 | + | II-13-1 |
| I-5 | + | II-13-2 |
| I-5 | + | II-13-3 |
| I-5 | + | II-13-4 |
| I-5 | + | II-13-5 |
| I-5 | + | II-13-6 |
| I-5 | + | II-15-1 |
| I-5 | + | II-15-2 |
| I-5 | + | II-15-3 |
| I-5 | + | II-15-4 |
| I-5 | + | II-15-5 |
| I-5 | + | II-15-6 |
| I-5 | + | II-15-7 |
| I-5 | + | II-15-8 |
| I-5 | + | II-15-9 |
| I-5 | + | II-15-10 |
| I-5 | + | II-15-11 |
| I-5 | + | II-15-12 |
| I-5 | + | II-15-13 |
| I-5 | + | II-16-1 |
| I-5 | + | II-17-1 |
| I-5 | + | II-18A-1 |
| I-5 | + | II-18A-2 |
| I-5 | + | II-18A-3 |
| I-5 | + | II-18A-4 |
| I-5 | + | II-18A-5 |
| I-5 | + | II-18B-1 |
| I-5 | + | II-19-1 |
| I-5 | + | II-20A-1 |
| I-5 | + | II-20B-1 |
| I-5 | + | II-20C-1 |
| I-5 | + | II-20D-1 |
| I-5 | + | II-20D-2 |
| I-5 | + | II-21-1 |
| I-5 | + | II-21-2 |
| I-5 | + | II-21-3 |
| I-5 | + | II-21-4 |
| I-5 | + | II-21-5 |
| I-5 | + | II-21-6 |
| I-5 | + | II-21-7 |
| I-5 | + | II-22A-1 |
| I-5 | + | II-22B-1 |
| I-5 | + | II-23A-1 |
| I-5 | + | II-23A-2 |
| I-5 | + | II-23B-1 |
| I-5 | + | II-25-1 |
| I-5 | + | II-28-1 |
| I-5 | + | II-28-2 |
| I-5 | + | II-28-3 |
| I-5 | + | II-28-4 |
| I-5 | + | II-29-1 |
| I-5 | + | II-29-2 |
| I-5 | + | II-29-3 |
| I-5 | + | II-29-4 |
| I-5 | + | II-29-5 |
| I-5 | + | II-29-6 |
| I-5 | + | II-29-7 |
| I-5 | + | II-29-8 |
| I-5 | + | II-29-9 |
| I-5 | + | II-29-10 |
| I-5 | + | II-29-11 |
| I-5 | + | II-29-12 |
| I-5 | + | II-29-13 |
| I-5 | + | II-29-14 |
| I-5 | + | II-29-15 |
| I-5 | + | II-29-16 |
| I-5 | + | II-29-17 |
| I-5 | + | II-29-18 |
| I-5 | + | II-29-19 |
| I-5 | + | II-29-20 |
| I-5 | + | II-29-21 |
| I-5 | + | II-29-22 |
| I-5 | + | II-29-23 |
| I-5 | + | II-29-24 |
| I-5 | + | II-29-25 |
| I-5 | + | II-29-26 |
| I-5 | + | II-29-27 |
| I-5 | + | II-29-28 |
| I-5 | + | II-29-29 |
| I-5 | + | II-29-30 |
| I-5 | + | II-29-31 |
| I-6 | + | II-1A-1 |
| I-6 | + | II-1A-2 |
| I-6 | + | II-1A-3 |
| I-6 | + | II-1A-4 |
| I-6 | + | II-1A-5 |
| I-6 | + | II-1A-6 |
| I-6 | + | II-1A-7 |
| I-6 | + | II-1A-8 |
| I-6 | + | II-1A-9 |
| I-6 | + | II-1A-10 |
| I-6 | + | II-1A-11 |
| I-6 | + | II-1A-12 |
| I-6 | + | II-1A-13 |
| I-6 | + | II-1A-14 |
| I-6 | + | II-1A-15 |
| I-6 | + | II-1A-16 |
| I-6 | + | II-1A-17 |
| I-6 | + | II-1A-18 |
| I-6 | + | II-1A-19 |
| I-6 | + | II-1A-20 |
| I-6 | + | II-1A-21 |
| I-6 | + | II-1A-22 |
| I-6 | + | II-1A-23 |
| I-6 | + | II-1A-24 |
| I-6 | + | II-1A-25 |
| I-6 | + | II-1A-26 |
| I-6 | + | II-1A-27 |
| I-6 | + | II-1A-28 |
| I-6 | + | II-1A-29 |
| I-6 | + | II-1A-30 |
| I-6 | + | II-1A-31 |
| I-6 | + | II-1A-32 |
| I-6 | + | II-1A-33 |
| I-6 | + | II-1A-34 |
| I-6 | + | II-1A-35 |
| I-6 | + | II-1B-1 |
| I-6 | + | II-1B-2 |
| I-6 | + | II-1B-3 |
| I-6 | + | II-1B-4 |
| I-6 | + | II-1B-5 |
| I-6 | + | II-1B-6 |
| I-6 | + | II-1B-7 |
| I-6 | + | II-1B-8 |
| I-6 | + | II-1B-9 |
| I-6 | + | II-1B-10 |
| I-6 | + | II-1B-11 |
| I-6 | + | II-1B-12 |
| I-6 | + | II-1B-13 |
| I-6 | + | II-1B-14 |
| I-6 | + | II-1B-15 |
| I-6 | + | II-1B-16 |
| I-6 | + | II-1B-17 |
| I-6 | + | II-1B-18 |
| I-6 | + | II-1B-19 |
| I-6 | + | II-1B-20 |
| I-6 | + | II-1B-21 |
| I-6 | + | II-1B-22 |
| I-6 | + | II-1B-23 |
| I-6 | + | II-1B-24 |
| I-6 | + | II-1B-25 |
| I-6 | + | II-1B-26 |
| I-6 | + | II-1B-27 |
| I-6 | + | II-1B-28 |
| I-6 | + | II-1B-29 |
| I-6 | + | II-1B-30 |
| I-6 | + | II-1B-31 |
| I-6 | + | II-1B-32 |
| I-6 | + | II-1B-33 |
| I-6 | + | II-1B-34 |
| I-6 | + | II-1B-35 |
| I-6 | + | II-1B-36 |
| I-6 | + | II-1B-37 |
| I-6 | + | II-1B-38 |
| I-6 | + | II-1B-39 |
| I-6 | + | II-1B-40 |
| I-6 | + | II-1B-41 |
| I-6 | + | II-1B-42 |
| I-6 | + | II-1B-43 |
| I-6 | + | II-1B-44 |
| I-6 | + | II-1B-45 |
| I-6 | + | II-1B-46 |
| I-6 | + | II-1B-47 |
| I-6 | + | II-1B-48 |
| I-6 | + | II-1B-49 |
| I-6 | + | II-1B-50 |
| I-6 | + | II-1B-51 |
| I-6 | + | II-1B-52 |
| I-6 | + | II-1B-53 |
| I-6 | + | II-1B-54 |
| I-6 | + | II-1B-55 |
| I-6 | + | II-1B-56 |
| I-6 | + | II-1B-57 |
| I-6 | + | II-1B-58 |
| I-6 | + | II-1B-59 |
| I-6 | + | II-1B-60 |
| I-6 | + | II-1B-61 |
| I-6 | + | II-1B-62 |
| I-6 | + | II-1B-63 |
| I-6 | + | II-1B-64 |
| I-6 | + | II-1B-65 |
| I-6 | + | II-1B-66 |
| I-6 | + | II-1B-67 |
| I-6 | + | II-1B-68 |
| I-6 | + | II-1B-69 |
| I-6 | + | II-1B-70 |
| I-6 | + | II-1B-71 |
| I-6 | + | II-1B-72 |
| I-6 | + | II-1B-73 |
| I-6 | + | II-1B-74 |
| I-6 | + | II-1B-75 |
| I-6 | + | II-1B-76 |
| I-6 | + | II-1B-77 |
| I-6 | + | II-1B-78 |
| I-6 | + | II-1B-79 |
| I-6 | + | II-1B-80 |
| I-6 | + | II-1B-81 |
| I-6 | + | II-1B-82 |
| I-6 | + | II-1B-83 |
| I-6 | + | II-1B-84 |
| I-6 | + | II-1B-85 |
| I-6 | + | II-1B-86 |
| I-6 | + | II-1B-87 |
| I-6 | + | II-1B-88 |
| I-6 | + | II-2A-1 |
| I-6 | + | II-2A-2 |
| I-6 | + | II-2A-3 |
| I-6 | + | II-2A-4 |
| I-6 | + | II-2A-5 |
| I-6 | + | II-2A-6 |
| I-6 | + | II-2A-7 |
| I-6 | + | II-2A-8 |
| I-6 | + | II-2B-1 |
| I-6 | + | II-2B-2 |
| I-6 | + | II-2B-3 |
| I-6 | + | II-2B-4 |
| I-6 | + | II-2B-5 |
| I-6 | + | II-2B-6 |
| I-6 | + | II-3-1 |
| I-6 | + | II-3-2 |
| I-6 | + | II-3-3 |
| I-6 | + | II-3-4 |
| I-6 | + | II-3-5 |
| I-6 | + | II-3-6 |
| I-6 | + | II-3-7 |
| I-6 | + | II-3-8 |
| I-6 | + | II-3-9 |
| I-6 | + | II-3-10 |
| I-6 | + | II-3-11 |
| I-6 | + | II-3-12 |
| I-6 | + | II-3-13 |
| I-6 | + | II-3-14 |
| I-6 | + | II-3-15 |
| I-6 | + | II-3-16 |
| I-6 | + | II-3-17 |
| I-6 | + | II-3-18 |
| I-6 | + | II-3-19 |
| I-6 | + | II-3-20 |
| I-6 | + | II-3-21 |
| I-6 | + | II-3-22 |
| I-6 | + | II-3-23 |
| I-6 | + | II-3-24 |
| I-6 | + | II-3-25 |
| I-6 | + | II-3-26 |
| I-6 | + | II-3-27 |
| I-6 | + | II-3-28 |
| I-6 | + | II-3-29 |
| I-6 | + | II-3-30 |
| I-6 | + | II-3-31 |
| I-6 | + | II-3-32 |
| I-6 | + | II-3-33 |
| I-6 | + | II-3-34 |
| I-6 | + | II-3-35 |
| I-6 | + | II-3-36 |
| I-6 | + | II-3-37 |
| I-6 | + | II-3-38 |
| I-6 | + | II-3-39 |
| I-6 | + | II-3-40 |
| I-6 | + | II-3-41 |
| I-6 | + | II-3-42 |
| I-6 | + | II-3-43 |
| I-6 | + | II-3-44 |
| I-6 | + | II-3-45 |
| I-6 | + | II-3-46 |
| I-6 | + | II-3-47 |
| I-6 | + | II-3-48 |
| I-6 | + | II-3-49 |
| I-6 | + | II-3-50 |
| I-6 | + | II-3-51 |
| I-6 | + | II-3-52 |
| I-6 | + | II-3-53 |
| I-6 | + | II-3-54 |
| I-6 | + | II-3-55 |
| I-6 | + | II-3-56 |
| I-6 | + | II-3-57 |
| I-6 | + | II-3-58 |
| I-6 | + | II-4A-1 |
| I-6 | + | II-4A-2 |
| I-6 | + | II-4A-3 |
| I-6 | + | II-4A-4 |
| I-6 | + | II-4A-5 |
| I-6 | + | II-4A-6 |
| I-6 | + | II-4A-7 |
| I-6 | + | II-4A-8 |
| I-6 | + | II-4A-9 |
| I-6 | + | II-4B-1 |
| I-6 | + | II-4B-2 |
| I-6 | + | II-4B-3 |
| I-6 | + | II-4B-4 |
| I-6 | + | II-4C-4 |
| I-6 | + | II-5-1 |
| I-6 | + | II-5-2 |
| I-6 | + | II-6-1 |
| I-6 | + | II-6-2 |
| I-6 | + | II-6-3 |
| I-6 | + | II-6-4 |
| I-6 | + | II-6-5 |
| I-6 | + | II-6-6 |
| I-6 | + | II-7A-1 |
| I-6 | + | II-7A-2 |
| I-6 | + | II-7A-3 |
| I-6 | + | II-7A-4 |
| I-6 | + | II-7A-5 |
| I-6 | + | II-7B-1 |
| I-6 | + | II-7C-1 |
| I-6 | + | II-7C-2 |
| I-6 | + | II-8A-1 |
| I-6 | + | II-8B-1 |
| I-6 | + | II-8C-1 |
| I-6 | + | II-9A-1 |
| I-6 | + | II-9B-1 |
| I-6 | + | II-9B-2 |
| I-6 | + | II-9C-1 |
| I-6 | + | II-10A-1 |
| I-6 | + | II-10A-2 |
| I-6 | + | II-10B-1 |
| I-6 | + | II-12A-1 |
| I-6 | + | II-12B-1 |
| I-6 | + | II-12B-2 |
| I-6 | + | II-12B-3 |
| I-6 | + | II-12C-1 |
| I-6 | + | II-12C-2 |
| I-6 | + | II-13-1 |
| I-6 | + | II-13-2 |
| I-6 | + | II-13-3 |
| I-6 | + | II-13-4 |
| I-6 | + | II-13-5 |
| I-6 | + | II-13-6 |
| I-6 | + | II-15-1 |
| I-6 | + | II-15-2 |
| I-6 | + | II-15-3 |
| I-6 | + | II-15-4 |
| I-6 | + | II-15-5 |
| I-6 | + | II-15-6 |
| I-6 | + | II-15-7 |
| I-6 | + | II-15-8 |
| I-6 | + | II-15-9 |
| I-6 | + | II-15-10 |
| I-6 | + | II-15-11 |
| I-6 | + | II-15-12 |
| I-6 | + | II-15-13 |
| I-6 | + | II-16-1 |
| I-6 | + | II-17-1 |
| I-6 | + | II-18A-1 |
| I-6 | + | II-18A-2 |
| I-6 | + | II-18A-3 |
| I-6 | + | II-18A-4 |
| I-6 | + | II-18A-5 |
| I-6 | + | II-18B-1 |
| I-6 | + | II-19-1 |
| I-6 | + | II-20A-1 |
| I-6 | + | II-20B-1 |
| I-6 | + | II-20C-1 |
| I-6 | + | II-20D-1 |
| I-6 | + | II-20D-2 |
| I-6 | + | II-21-1 |
| I-6 | + | II-21-2 |
| I-6 | + | II-21-3 |
| I-6 | + | II-21-4 |
| I-6 | + | II-21-5 |
| I-6 | + | II-21-6 |
| I-6 | + | II-21-7 |
| I-6 | + | II-22A-1 |
| I-6 | + | II-22B-1 |
| I-6 | + | II-23A-1 |
| I-6 | + | II-23A-2 |
| I-6 | + | II-23B-1 |
| I-6 | + | II-25-1 |
| I-6 | + | II-28-1 |
| I-6 | + | II-28-2 |
| I-6 | + | II-28-3 |
| I-6 | + | II-28-4 |
| I-6 | + | II-29-1 |
| I-6 | + | II-29-2 |
| I-6 | + | II-29-3 |
| I-6 | + | II-29-4 |
| I-6 | + | II-29-5 |
| I-6 | + | II-29-6 |
| I-6 | + | II-29-7 |
| I-6 | + | II-29-8 |
| I-6 | + | II-29-9 |
| I-6 | + | II-29-10 |
| I-6 | + | II-29-11 |
| I-6 | + | II-29-12 |
| I-6 | + | II-29-13 |
| I-6 | + | II-29-14 |
| I-6 | + | II-29-15 |
| I-6 | + | II-29-16 |
| I-6 | + | II-29-17 |
| I-6 | + | II-29-18 |
| I-6 | + | II-29-19 |
| I-6 | + | II-29-20 |
| I-6 | + | II-29-21 |
| I-6 | + | II-29-22 |
| I-6 | + | II-29-23 |
| I-6 | + | II-29-24 |
| I-6 | + | II-29-25 |
| I-6 | + | II-29-26 |
| I-6 | + | II-29-27 |
| I-6 | + | II-29-28 |
| I-6 | + | II-29-29 |
| I-6 | + | II-29-30 |
| I-6 | + | II-29-31 |
| I-7 | + | II-1A-1 |
| I-7 | + | II-1A-2 |
| I-7 | + | II-1A-3 |
| I-7 | + | II-1A-4 |
| I-7 | + | II-1A-5 |
| I-7 | + | II-1A-6 |
| I-7 | + | II-1A-7 |
| I-7 | + | II-1A-8 |
| I-7 | + | II-1A-9 |
| I-7 | + | II-1A-10 |
| I-7 | + | II-1A-11 |
| I-7 | + | II-1A-12 |
| I-7 | + | II-1A-13 |
| I-7 | + | II-1A-14 |
| I-7 | + | II-1A-15 |
| I-7 | + | II-1A-16 |
| I-7 | + | II-1A-17 |
| I-7 | + | II-1A-18 |
| I-7 | + | II-1A-19 |
| I-7 | + | II-1A-20 |
| I-7 | + | II-1A-21 |
| I-7 | + | II-1A-22 |
| I-7 | + | II-1A-23 |
| I-7 | + | II-1A-24 |
| I-7 | + | II-1A-25 |
| I-7 | + | II-1A-26 |
| I-7 | + | II-1A-27 |
| I-7 | + | II-1A-28 |
| I-7 | + | II-1A-29 |
| I-7 | + | II-1A-30 |
| I-7 | + | II-1A-31 |
| I-7 | + | II-1A-32 |
| I-7 | + | II-1A-33 |
| I-7 | + | II-1A-34 |
| I-7 | + | II-1A-35 |
| I-7 | + | II-1B-1 |
| I-7 | + | II-1B-2 |
| I-7 | + | II-1B-3 |
| I-7 | + | II-1B-4 |
| I-7 | + | II-1B-5 |
| I-7 | + | II-1B-6 |
| I-7 | + | II-1B-7 |
| I-7 | + | II-1B-8 |
| I-7 | + | II-1B-9 |
| I-7 | + | II-1B-10 |
| I-7 | + | II-1B-11 |
| I-7 | + | II-1B-12 |
| I-7 | + | II-1B-13 |
| I-7 | + | II-1B-14 |
| I-7 | + | II-1B-15 |
| I-7 | + | II-1B-16 |
| I-7 | + | II-1B-17 |
| I-7 | + | II-1B-18 |
| I-7 | + | II-1B-19 |
| I-7 | + | II-1B-20 |
| I-7 | + | II-1B-21 |
| I-7 | + | II-1B-22 |
| I-7 | + | II-1B-23 |
| I-7 | + | II-1B-24 |
| I-7 | + | II-1B-25 |
| I-7 | + | II-1B-26 |
| I-7 | + | II-1B-27 |
| I-7 | + | II-1B-28 |
| I-7 | + | II-1B-29 |
| I-7 | + | II-1B-30 |
| I-7 | + | II-1B-31 |
| I-7 | + | II-1B-32 |
| I-7 | + | II-1B-33 |
| I-7 | + | II-1B-34 |
| I-7 | + | II-1B-35 |
| I-7 | + | II-1B-36 |
| I-7 | + | II-1B-37 |
| I-7 | + | II-1B-38 |
| I-7 | + | II-1B-39 |
| I-7 | + | II-1B-40 |
| I-7 | + | II-1B-41 |
| I-7 | + | II-1B-42 |
| I-7 | + | II-1B-43 |
| I-7 | + | II-1B-44 |
| I-7 | + | II-1B-45 |
| I-7 | + | II-1B-46 |
| I-7 | + | II-1B-47 |
| I-7 | + | II-1B-48 |
| I-7 | + | II-1B-49 |
| I-7 | + | II-1B-50 |
| I-7 | + | II-1B-51 |
| I-7 | + | II-1B-52 |
| I-7 | + | II-1B-53 |
| I-7 | + | II-1B-54 |
| I-7 | + | II-1B-55 |
| I-7 | + | II-1B-56 |
| I-7 | + | II-1B-57 |
| I-7 | + | II-1B-58 |
| I-7 | + | II-1B-59 |
| I-7 | + | II-1B-60 |
| I-7 | + | II-1B-61 |
| I-7 | + | II-1B-62 |
| I-7 | + | II-1B-63 |
| I-7 | + | II-1B-64 |
| I-7 | + | II-1B-65 |
| I-7 | + | II-1B-66 |
| I-7 | + | II-1B-67 |
| I-7 | + | II-1B-68 |
| I-7 | + | II-1B-69 |
| I-7 | + | II-1B-70 |
| I-7 | + | II-1B-71 |
| I-7 | + | II-1B-72 |
| I-7 | + | II-1B-73 |
| I-7 | + | II-1B-74 |
| I-7 | + | II-1B-75 |
| I-7 | + | II-1B-76 |
| I-7 | + | II-1B-77 |
| I-7 | + | II-1B-78 |
| I-7 | + | II-1B-79 |
| I-7 | + | II-1B-80 |
| I-7 | + | II-1B-81 |
| I-7 | + | II-1B-82 |
| I-7 | + | II-1B-83 |
| I-7 | + | II-1B-84 |
| I-7 | + | II-1B-85 |
| I-7 | + | II-1B-86 |
| I-7 | + | II-1B-87 |
| I-7 | + | II-1B-88 |
| I-7 | + | II-2A-1 |
| I-7 | + | II-2A-2 |
| I-7 | + | II-2A-3 |
| I-7 | + | II-2A-4 |
| I-7 | + | II-2A-5 |
| I-7 | + | II-2A-6 |
| I-7 | + | II-2A-7 |
| I-7 | + | II-2A-8 |
| I-7 | + | II-2B-1 |
| I-7 | + | II-2B-2 |
| I-7 | + | II-2B-3 |
| I-7 | + | II-2B-4 |
| I-7 | + | II-2B-5 |
| I-7 | + | II-2B-6 |
| I-7 | + | II-3-1 |
| I-7 | + | II-3-2 |
| I-7 | + | II-3-3 |
| I-7 | + | II-3-4 |
| I-7 | + | II-3-5 |
| I-7 | + | II-3-6 |
| I-7 | + | II-3-7 |
| I-7 | + | II-3-8 |
| I-7 | + | II-3-9 |
| I-7 | + | II-3-10 |
| I-7 | + | II-3-11 |
| I-7 | + | II-3-12 |
| I-7 | + | II-3-13 |
| I-7 | + | II-3-14 |
| I-7 | + | II-3-15 |
| I-7 | + | II-3-16 |
| I-7 | + | II-3-17 |
| I-7 | + | II-3-18 |
| I-7 | + | II-3-19 |
| I-7 | + | II-3-20 |
| I-7 | + | II-3-21 |
| I-7 | + | II-3-22 |
| I-7 | + | II-3-23 |
| I-7 | + | II-3-24 |
| I-7 | + | II-3-25 |
| I-7 | + | II-3-26 |
| I-7 | + | II-3-27 |
| I-7 | + | II-3-28 |
| I-7 | + | II-3-29 |
| I-7 | + | II-3-30 |
| I-7 | + | II-3-31 |
| I-7 | + | II-3-32 |
| I-7 | + | II-3-33 |
| I-7 | + | II-3-34 |
| I-7 | + | II-3-35 |
| I-7 | + | II-3-36 |
| I-7 | + | II-3-37 |
| I-7 | + | II-3-38 |
| I-7 | + | II-3-39 |
| I-7 | + | II-3-40 |
| I-7 | + | II-3-41 |
| I-7 | + | II-3-42 |
| I-7 | + | II-3-43 |
| I-7 | + | II-3-44 |
| I-7 | + | II-3-45 |
| I-7 | + | II-3-46 |
| I-7 | + | II-3-47 |
| I-7 | + | II-3-48 |
| I-7 | + | II-3-49 |
| I-7 | + | II-3-50 |
| I-7 | + | II-3-51 |
| I-7 | + | II-3-52 |
| I-7 | + | II-3-53 |
| I-7 | + | II-3-54 |
| I-7 | + | II-3-55 |
| I-7 | + | II-3-56 |
| I-7 | + | II-3-57 |
| I-7 | + | II-3-58 |
| I-7 | + | II-4A-1 |
| I-7 | + | II-4A-2 |
| I-7 | + | II-4A-3 |
| I-7 | + | II-4A-4 |
| I-7 | + | II-4A-5 |
| I-7 | + | II-4A-6 |
| I-7 | + | II-4A-7 |
| I-7 | + | II-4A-8 |
| I-7 | + | II-4A-9 |
| I-7 | + | II-4B-1 |
| I-7 | + | II-4B-2 |
| I-7 | + | II-4B-3 |
| I-7 | + | II-4B-4 |
| I-7 | + | II-4C-4 |
| I-7 | + | II-5-1 |
| I-7 | + | II-5-2 |
| I-7 | + | II-7-1 |
| I-7 | + | II-7-2 |
| I-7 | + | II-7-3 |
| I-7 | + | II-7-4 |
| I-7 | + | II-7-5 |
| I-7 | + | II-7-6 |
| I-7 | + | II-7A-1 |
| I-7 | + | II-7A-2 |
| I-7 | + | II-7A-3 |
| I-7 | + | II-7A-4 |
| I-7 | + | II-7A-5 |
| I-7 | + | II-7B-1 |
| I-7 | + | II-7C-1 |
| I-7 | + | II-7C-2 |
| I-7 | + | II-8A-1 |
| I-7 | + | II-8B-1 |
| I-7 | + | II-8C-1 |
| I-7 | + | II-9A-1 |
| I-7 | + | II-9B-1 |
| I-7 | + | II-9B-2 |
| I-7 | + | II-9C-1 |
| I-7 | + | II-10A-1 |
| I-7 | + | II-10A-2 |
| I-7 | + | II-10B-1 |
| I-7 | + | II-12A-1 |
| I-7 | + | II-12B-1 |
| I-7 | + | II-12B-2 |
| I-7 | + | II-12B-3 |
| I-7 | + | II-12C-1 |
| I-7 | + | II-12C-2 |
| I-7 | + | II-13-1 |
| I-7 | + | II-13-2 |
| I-7 | + | II-13-3 |
| I-7 | + | II-13-4 |
| I-7 | + | II-13-5 |
| I-7 | + | II-13-6 |
| I-7 | + | II-15-1 |
| I-7 | + | II-15-2 |
| I-7 | + | II-15-3 |
| I-7 | + | II-15-4 |
| I-7 | + | II-15-5 |
| I-7 | + | II-15-6 |
| I-7 | + | II-15-7 |
| I-7 | + | II-15-8 |
| I-7 | + | II-15-9 |
| I-7 | + | II-15-10 |
| I-7 | + | II-15-11 |
| I-7 | + | II-15-12 |
| I-7 | + | II-15-13 |
| I-7 | + | II-16-1 |
| I-7 | + | II-17-1 |
| I-7 | + | II-18A-1 |
| I-7 | + | II-18A-2 |
| I-7 | + | II-18A-3 |
| I-7 | + | II-18A-4 |
| I-7 | + | II-18A-5 |
| I-7 | + | II-18B-1 |
| I-7 | + | II-19-1 |
| I-7 | + | II-20A-1 |
| I-7 | + | II-20B-1 |
| I-7 | + | II-20C-1 |
| I-7 | + | II-20D-1 |
| I-7 | + | II-20D-2 |
| I-7 | + | II-21-1 |
| I-7 | + | II-21-2 |
| I-7 | + | II-21-3 |
| I-7 | + | II-21-4 |
| I-7 | + | II-21-5 |
| I-7 | + | II-21-6 |
| I-7 | + | II-21-7 |
| I-7 | + | II-22A-1 |
| I-7 | + | II-22B-1 |
| I-7 | + | II-23A-1 |
| I-7 | + | II-23A-2 |
| I-7 | + | II-23B-1 |
| I-7 | + | II-25-1 |
| I-7 | + | II-28-1 |
| I-7 | + | II-28-2 |
| I-7 | + | II-28-3 |
| I-7 | + | II-28-4 |
| I-7 | + | II-29-1 |
| I-7 | + | II-29-2 |
| I-7 | + | II-29-3 |
| I-7 | + | II-29-4 |
| I-7 | + | II-29-5 |
| I-7 | + | II-29-6 |
| I-7 | + | II-29-7 |
| I-7 | + | II-29-8 |
| I-7 | + | II-29-9 |
| I-7 | + | II-29-10 |
| I-7 | + | II-29-11 |
| I-7 | + | II-29-12 |
| I-7 | + | II-29-13 |
| I-7 | + | II-29-14 |
| I-7 | + | II-29-15 |
| I-7 | + | II-29-16 |
| I-7 | + | II-29-17 |
| I-7 | + | II-29-18 |
| I-7 | + | II-29-19 |
| I-7 | + | II-29-20 |
| I-7 | + | II-29-21 |
| I-7 | + | II-29-22 |
| I-7 | + | II-29-23 |
| I-7 | + | II-29-24 |
| I-7 | + | II-29-25 |
| I-7 | + | II-29-26 |
| I-7 | + | II-29-27 |
| I-7 | + | II-29-28 |
| I-7 | + | II-29-29 |
| I-7 | + | II-29-30 |
| I-7 | + | II-29-31 |
| I-8 | + | II-1A-1 |
| I-8 | + | II-1A-2 |
| I-8 | + | II-1A-3 |
| I-8 | + | II-1A-4 |
| I-8 | + | II-1A-5 |
| I-8 | + | II-1A-6 |
| I-8 | + | II-1A-7 |
| I-8 | + | II-1A-8 |
| I-8 | + | II-1A-9 |
| I-8 | + | II-1A-10 |
| I-8 | + | II-1A-11 |
| I-8 | + | II-1A-12 |
| I-8 | + | II-1A-13 |
| I-8 | + | II-1A-14 |
| I-8 | + | II-1A-15 |
| I-8 | + | II-1A-16 |
| I-8 | + | II-1A-17 |
| I-8 | + | II-1A-18 |
| I-8 | + | II-1A-19 |
| I-8 | + | II-1A-20 |
| I-8 | + | II-1A-21 |
| I-8 | + | II-1A-22 |
| I-8 | + | II-1A-23 |
| I-8 | + | II-1A-24 |
| I-8 | + | II-1A-25 |
| I-8 | + | II-1A-26 |
| I-8 | + | II-1A-27 |
| I-8 | + | II-1A-28 |
| I-8 | + | II-1A-29 |
| I-8 | + | II-1A-30 |
| I-8 | + | II-1A-31 |
| I-8 | + | II-1A-32 |
| I-8 | + | II-1A-33 |
| I-8 | + | II-1A-34 |
| I-8 | + | II-1A-35 |
| I-8 | + | II-1B-1 |
| I-8 | + | II-1B-2 |
| I-8 | + | II-1B-3 |
| I-8 | + | II-1B-4 |
| I-8 | + | II-1B-5 |
| I-8 | + | II-1B-6 |
| I-8 | + | II-1B-7 |
| I-8 | + | II-1B-8 |
| I-8 | + | II-1B-9 |
| I-8 | + | II-1B-10 |
| I-8 | + | II-1B-11 |
| I-8 | + | II-1B-12 |
| I-8 | + | II-1B-13 |
| I-8 | + | II-1B-14 |
| I-8 | + | II-1B-15 |
| I-8 | + | II-1B-16 |
| I-8 | + | II-1B-17 |
| I-8 | + | II-1B-18 |
| I-8 | + | II-1B-19 |
| I-8 | + | II-1B-20 |
| I-8 | + | II-1B-21 |
| I-8 | + | II-1B-22 |
| I-8 | + | II-1B-23 |
| I-8 | + | II-1B-24 |
| I-8 | + | II-1B-25 |
| I-8 | + | II-1B-26 |
| I-8 | + | II-1B-27 |
| I-8 | + | II-1B-28 |
| I-8 | + | II-1B-29 |
| I-8 | + | II-1B-30 |
| I-8 | + | II-1B-31 |
| I-8 | + | II-1B-32 |
| I-8 | + | II-1B-33 |
| I-8 | + | II-1B-34 |
| I-8 | + | II-1B-35 |
| I-8 | + | II-1B-36 |
| I-8 | + | II-1B-37 |
| I-8 | + | II-1B-38 |
| I-8 | + | II-1B-39 |
| I-8 | + | II-1B-40 |
| I-8 | + | II-1B-41 |
| I-8 | + | II-1B-42 |
| I-8 | + | II-1B-43 |
| I-8 | + | II-1B-44 |
| I-8 | + | II-1B-45 |
| I-8 | + | II-1B-46 |
| I-8 | + | II-1B-47 |
| I-8 | + | II-1B-48 |
| I-8 | + | II-1B-49 |
| I-8 | + | II-1B-50 |
| I-8 | + | II-1B-51 |
| I-8 | + | II-1B-52 |
| I-8 | + | II-1B-53 |
| I-8 | + | II-1B-54 |
| I-8 | + | II-1B-55 |
| I-8 | + | II-1B-56 |
| I-8 | + | II-1B-57 |
| I-8 | + | II-1B-58 |
| I-8 | + | II-1B-59 |
| I-8 | + | II-1B-60 |
| I-8 | + | II-1B-61 |
| I-8 | + | II-1B-62 |
| I-8 | + | II-1B-63 |
| I-8 | + | II-1B-64 |
| I-8 | + | II-1B-65 |
| I-8 | + | II-1B-66 |
| I-8 | + | II-1B-67 |
| I-8 | + | II-1B-68 |
| I-8 | + | II-1B-69 |
| I-8 | + | II-1B-70 |
| I-8 | + | II-1B-71 |
| I-8 | + | II-1B-72 |
| I-8 | + | II-1B-73 |
| I-8 | + | II-1B-74 |
| I-8 | + | II-1B-75 |
| I-8 | + | II-1B-76 |
| I-8 | + | II-1B-77 |
| I-8 | + | II-1B-78 |
| I-8 | + | II-1B-79 |
| I-8 | + | II-1B-80 |
| I-8 | + | II-1B-81 |
| I-8 | + | II-1B-82 |
| I-8 | + | II-1B-83 |
| I-8 | + | II-1B-84 |
| I-8 | + | II-1B-85 |
| I-8 | + | II-1B-86 |
| I-8 | + | II-1B-87 |
| I-8 | + | II-1B-88 |
| I-8 | + | II-2A-1 |
| I-8 | + | II-2A-2 |
| I-8 | + | II-2A-3 |
| I-8 | + | II-2A-4 |
| I-8 | + | II-2A-5 |
| I-8 | + | II-2A-6 |
| I-8 | + | II-2A-7 |
| I-8 | + | II-2A-8 |
| I-8 | + | II-2B-1 |
| I-8 | + | II-2B-2 |
| I-8 | + | II-2B-3 |
| I-8 | + | II-2B-4 |
| I-8 | + | II-2B-5 |
| I-8 | + | II-2B-6 |
| I-8 | + | II-3-1 |
| I-8 | + | II-3-2 |
| I-8 | + | II-3-3 |
| I-8 | + | II-3-4 |
| I-8 | + | II-3-5 |
| I-8 | + | II-3-6 |
| I-8 | + | II-3-7 |
| I-8 | + | II-3-8 |
| I-8 | + | II-3-9 |
| I-8 | + | II-3-10 |
| I-8 | + | II-3-11 |
| I-8 | + | II-3-12 |
| I-8 | + | II-3-13 |
| I-8 | + | II-3-14 |
| I-8 | + | II-3-15 |
| I-8 | + | II-3-16 |
| I-8 | + | II-3-17 |
| I-8 | + | II-3-18 |
| I-8 | + | II-3-19 |
| I-8 | + | II-3-20 |
| I-8 | + | II-3-21 |
| I-8 | + | II-3-22 |
| I-8 | + | II-3-23 |
| I-8 | + | II-3-24 |
| I-8 | + | II-3-25 |
| I-8 | + | II-3-26 |
| I-8 | + | II-3-27 |
| I-8 | + | II-3-28 |
| I-8 | + | II-3-29 |
| I-8 | + | II-3-30 |
| I-8 | + | II-3-31 |
| I-8 | + | II-3-32 |
| I-8 | + | II-3-33 |
| I-8 | + | II-3-34 |
| I-8 | + | II-3-35 |
| I-8 | + | II-3-36 |
| I-8 | + | II-3-37 |
| I-8 | + | II-3-38 |
| I-8 | + | II-3-39 |
| I-8 | + | II-3-40 |
| I-8 | + | II-3-41 |
| I-8 | + | II-3-42 |
| I-8 | + | II-3-43 |
| I-8 | + | II-3-44 |
| I-8 | + | II-3-45 |
| I-8 | + | II-3-46 |
| I-8 | + | II-3-47 |
| I-8 | + | II-3-48 |
| I-8 | + | II-3-49 |
| I-8 | + | II-3-50 |
| I-8 | + | II-3-51 |
| I-8 | + | II-3-52 |
| I-8 | + | II-3-53 |
| I-8 | + | II-3-54 |
| I-8 | + | II-3-55 |
| I-8 | + | II-3-56 |
| I-8 | + | II-3-57 |
| I-8 | + | II-3-58 |
| I-8 | + | II-4A-1 |
| I-8 | + | II-4A-2 |
| I-8 | + | II-4A-3 |
| I-8 | + | II-4A-4 |
| I-8 | + | II-4A-5 |
| I-8 | + | II-4A-6 |
| I-8 | + | II-4A-7 |
| I-8 | + | II-4A-8 |
| I-8 | + | II-4A-9 |
| I-8 | + | II-4B-1 |
| I-8 | + | II-4B-2 |
| I-8 | + | II-4B-3 |
| I-8 | + | II-4B-4 |
| I-8 | + | II-4C-4 |
| I-8 | + | II-5-1 |
| I-8 | + | II-5-2 |
| I-8 | + | II-8-1 |
| I-8 | + | II-8-2 |
| I-8 | + | II-8-3 |
| I-8 | + | II-8-4 |
| I-8 | + | II-8-5 |
| I-8 | + | II-8-6 |
| I-8 | + | II-7A-1 |
| I-8 | + | II-7A-2 |
| I-8 | + | II-7A-3 |
| I-8 | + | II-7A-4 |
| I-8 | + | II-7A-5 |
| I-8 | + | II-7B-1 |
| I-8 | + | II-7C-1 |
| I-8 | + | II-7C-2 |
| I-8 | + | II-8A-1 |
| I-8 | + | II-8B-1 |
| I-8 | + | II-8C-1 |
| I-8 | + | II-9A-1 |
| I-8 | + | II-9B-1 |
| I-8 | + | II-9B-2 |
| I-8 | + | II-9C-1 |
| I-8 | + | II-10A-1 |
| I-8 | + | II-10A-2 |
| I-8 | + | II-10B-1 |
| I-8 | + | II-12A-1 |
| I-8 | + | II-12B-1 |
| I-8 | + | II-12B-2 |
| I-8 | + | II-12B-3 |
| I-8 | + | II-12C-1 |
| I-8 | + | II-12C-2 |
| I-8 | + | II-13-1 |
| I-8 | + | II-13-2 |
| I-8 | + | II-13-3 |
| I-8 | + | II-13-4 |
| I-8 | + | II-13-5 |
| I-8 | + | II-13-6 |
| I-8 | + | II-15-1 |
| I-8 | + | II-15-2 |
| I-8 | + | II-15-3 |
| I-8 | + | II-15-4 |
| I-8 | + | II-15-5 |
| I-8 | + | II-15-6 |
| I-8 | + | II-15-7 |
| I-8 | + | II-15-8 |
| I-8 | + | II-15-9 |
| I-8 | + | II-15-10 |
| I-8 | + | II-15-11 |
| I-8 | + | II-15-12 |
| I-8 | + | II-15-13 |
| I-8 | + | II-16-1 |
| I-8 | + | II-17-1 |
| I-8 | + | II-18A-1 |
| I-8 | + | II-18A-2 |
| I-8 | + | II-18A-3 |
| I-8 | + | II-18A-4 |
| I-8 | + | II-18A-5 |
| I-8 | + | II-18B-1 |
| I-8 | + | II-19-1 |
| I-8 | + | II-20A-1 |
| I-8 | + | II-20B-1 |
| I-8 | + | II-20C-1 |
| I-8 | + | II-20D-1 |
| I-8 | + | II-20D-2 |
| I-8 | + | II-21-1 |
| I-8 | + | II-21-2 |
| I-8 | + | II-21-3 |
| I-8 | + | II-21-4 |
| I-8 | + | II-21-5 |
| I-8 | + | II-21-6 |
| I-8 | + | II-21-7 |
| I-8 | + | II-22A-1 |
| I-8 | + | II-22B-1 |
| I-8 | + | II-23A-1 |
| I-8 | + | II-23A-2 |
| I-8 | + | II-23B-1 |
| I-8 | + | II-25-1 |
| I-8 | + | II-28-1 |
| I-8 | + | II-28-2 |
| I-8 | + | II-28-3 |
| I-8 | + | II-28-4 |
| I-8 | + | II-29-1 |
| I-8 | + | II-29-2 |
| I-8 | + | II-29-3 |
| I-8 | + | II-29-4 |
| I-8 | + | II-29-5 |
| I-8 | + | II-29-6 |
| I-8 | + | II-29-7 |
| I-8 | + | II-29-8 |
| I-8 | + | II-29-9 |
| I-8 | + | II-29-10 |
| I-8 | + | II-29-11 |
| I-8 | + | II-29-12 |
| I-8 | + | II-29-13 |
| I-8 | + | II-29-14 |
| I-8 | + | II-29-15 |
| I-8 | + | II-29-16 |
| I-8 | + | II-29-17 |
| I-8 | + | II-29-18 |
| I-8 | + | II-29-19 |
| I-8 | + | II-29-20 |
| I-8 | + | II-29-21 |
| I-8 | + | II-29-22 |
| I-8 | + | II-29-23 |
| I-8 | + | II-29-24 |
| I-8 | + | II-29-25 |
| I-8 | + | II-29-26 |
| I-8 | + | II-29-27 |
| I-8 | + | II-29-28 |
| I-8 | + | II-29-29 |
| I-8 | + | II-29-30 |
| I-8 | + | II-29-31 |
| I-14 | + | II-1A-1 |
| I-14 | + | II-1A-2 |
| I-14 | + | II-1A-3 |
| I-14 | + | II-1A-4 |
| I-14 | + | II-1A-5 |
| I-14 | + | II-1A-6 |
| I-14 | + | II-1A-7 |
| I-14 | + | II-1A-8 |
| I-14 | + | II-1A-9 |
| I-14 | + | II-1A-10 |
| I-14 | + | II-1A-11 |
| I-14 | + | II-1A-12 |
| I-14 | + | II-1A-13 |
| I-14 | + | II-1A-14 |
| I-14 | + | II-1A-15 |
| I-14 | + | II-1A-16 |
| I-14 | + | II-1A-17 |
| I-14 | + | II-1A-18 |
| I-14 | + | II-1A-19 |
| I-14 | + | II-1A-20 |
| I-14 | + | II-1A-21 |
| I-14 | + | II-1A-22 |
| I-14 | + | II-1A-23 |
| I-14 | + | II-1A-24 |
| I-14 | + | II-1A-25 |
| I-14 | + | II-1A-26 |
| I-14 | + | II-1A-27 |
| I-14 | + | II-1A-28 |
| I-14 | + | II-1A-29 |
| I-14 | + | II-1A-30 |
| I-14 | + | II-1A-31 |
| I-14 | + | II-1A-32 |
| I-14 | + | II-1A-33 |
| I-14 | + | II-1A-34 |
| I-14 | + | II-1A-35 |
| I-14 | + | II-1B-1 |
| I-14 | + | II-1B-2 |
| I-14 | + | II-1B-3 |
| I-14 | + | II-1B-4 |
| I-14 | + | II-1B-5 |
| I-14 | + | II-1B-6 |
| I-14 | + | II-1B-7 |
| I-14 | + | II-1B-8 |
| I-14 | + | II-1B-9 |
| I-14 | + | II-1B-10 |
| I-14 | + | II-1B-11 |
| I-14 | + | II-1B-12 |
| I-14 | + | II-1B-13 |
| I-14 | + | II-1B-14 |
| I-14 | + | II-1B-15 |
| I-14 | + | II-1B-16 |
| I-14 | + | II-1B-17 |
| I-14 | + | II-1B-18 |
| I-14 | + | II-1B-19 |
| I-14 | + | II-1B-20 |
| I-14 | + | II-1B-21 |
| I-14 | + | II-1B-22 |
| I-14 | + | II-1B-23 |
| I-14 | + | II-1B-24 |
| I-14 | + | II-1B-25 |
| I-14 | + | II-1B-26 |
| I-14 | + | II-1B-27 |
| I-14 | + | II-1B-28 |
| I-14 | + | II-1B-29 |
| I-14 | + | II-1B-30 |
| I-14 | + | II-1B-31 |
| I-14 | + | II-1B-32 |
| I-14 | + | II-1B-33 |
| I-14 | + | II-1B-34 |
| I-14 | + | II-1B-35 |
| I-14 | + | II-1B-36 |
| I-14 | + | II-1B-37 |
| I-14 | + | II-1B-38 |
| I-14 | + | II-1B-39 |
| I-14 | + | II-1B-40 |
| I-14 | + | II-1B-41 |
| I-14 | + | II-1B-42 |
| I-14 | + | II-1B-43 |
| I-14 | + | II-1B-44 |
| I-14 | + | II-1B-45 |
| I-14 | + | II-1B-46 |
| I-14 | + | II-1B-47 |
| I-14 | + | II-1B-48 |
| I-14 | + | II-1B-49 |
| I-14 | + | II-1B-50 |
| I-14 | + | II-1B-51 |
| I-14 | + | II-1B-52 |
| I-14 | + | II-1B-53 |
| I-14 | + | II-1B-54 |
| I-14 | + | II-1B-55 |
| I-14 | + | II-1B-56 |
| I-14 | + | II-1B-57 |
| I-14 | + | II-1B-58 |
| I-14 | + | II-1B-59 |
| I-14 | + | II-1B-60 |
| I-14 | + | II-1B-61 |
| I-14 | + | II-1B-62 |
| I-14 | + | II-1B-63 |
| I-14 | + | II-1B-64 |
| I-14 | + | II-1B-65 |
| I-14 | + | II-1B-66 |
| I-14 | + | II-1B-67 |
| I-14 | + | II-1B-68 |
| I-14 | + | II-1B-69 |
| I-14 | + | II-1B-70 |
| I-14 | + | II-1B-71 |
| I-14 | + | II-1B-72 |
| I-14 | + | II-1B-73 |
| I-14 | + | II-1B-74 |
| I-14 | + | II-1B-75 |
| I-14 | + | II-1B-76 |
| I-14 | + | II-1B-77 |
| I-14 | + | II-1B-78 |
| I-14 | + | II-1B-79 |
| I-14 | + | II-1B-80 |
| I-14 | + | II-1B-81 |
| I-14 | + | II-1B-82 |
| I-14 | + | II-1B-83 |
| I-14 | + | II-1B-84 |
| I-14 | + | II-1B-85 |
| I-14 | + | II-1B-86 |
| I-14 | + | II-1B-87 |
| I-14 | + | II-1B-88 |
| I-14 | + | II-2A-1 |
| I-14 | + | II-2A-2 |
| I-14 | + | II-2A-3 |
| I-14 | + | II-2A-4 |
| I-14 | + | II-2A-5 |
| I-14 | + | II-2A-6 |
| I-14 | + | II-2A-7 |
| I-14 | + | II-2A-8 |
| I-14 | + | II-2B-1 |
| I-14 | + | II-2B-2 |
| I-14 | + | II-2B-3 |
| I-14 | + | II-2B-4 |
| I-14 | + | II-2B-5 |
| I-14 | + | II-2B-6 |
| I-14 | + | II-3-1 |
| I-14 | + | II-3-2 |
| I-14 | + | II-3-3 |
| I-14 | + | II-3-4 |
| I-14 | + | II-3-5 |
| I-14 | + | II-3-6 |
| I-14 | + | II-3-7 |
| I-14 | + | II-3-8 |
| I-14 | + | II-3-9 |
| I-14 | + | II-3-10 |
| I-14 | + | II-3-11 |
| I-14 | + | II-3-12 |
| I-14 | + | II-3-13 |
| I-14 | + | II-3-14 |
| I-14 | + | II-3-15 |
| I-14 | + | II-3-16 |
| I-14 | + | II-3-17 |
| I-14 | + | II-3-18 |
| I-14 | + | II-3-19 |
| I-14 | + | II-3-20 |
| I-14 | + | II-3-21 |
| I-14 | + | II-3-22 |
| I-14 | + | II-3-23 |
| I-14 | + | II-3-24 |
| I-14 | + | II-3-25 |
| I-14 | + | II-3-26 |
| I-14 | + | II-3-27 |
| I-14 | + | II-3-28 |
| I-14 | + | II-3-29 |
| I-14 | + | II-3-30 |
| I-14 | + | II-3-31 |
| I-14 | + | II-3-32 |
| I-14 | + | II-3-33 |
| I-14 | + | II-3-34 |
| I-14 | + | II-3-35 |
| I-14 | + | II-3-36 |
| I-14 | + | II-3-37 |
| I-14 | + | II-3-38 |
| I-14 | + | II-3-39 |
| I-14 | + | II-3-40 |
| I-14 | + | II-3-41 |
| I-14 | + | II-3-42 |
| I-14 | + | II-3-43 |
| I-14 | + | II-3-44 |
| I-14 | + | II-3-45 |
| I-14 | + | II-3-46 |
| I-14 | + | II-3-47 |
| I-14 | + | II-3-48 |
| I-14 | + | II-3-49 |
| I-14 | + | II-3-50 |
| I-14 | + | II-3-51 |
| I-14 | + | II-3-52 |
| I-14 | + | II-3-53 |
| I-14 | + | II-3-54 |
| I-14 | + | II-3-55 |
| I-14 | + | II-3-56 |
| I-14 | + | II-3-57 |
| I-14 | + | II-3-58 |
| I-14 | + | II-4A-1 |
| I-14 | + | II-4A-2 |
| I-14 | + | II-4A-3 |
| I-14 | + | II-4A-4 |
| I-14 | + | II-4A-5 |
| I-14 | + | II-4A-6 |
| I-14 | + | II-4A-7 |
| I-14 | + | II-4A-8 |
| I-14 | + | II-4A-9 |
| I-14 | + | II-4B-1 |
| I-14 | + | II-4B-2 |
| I-14 | + | II-4B-3 |
| I-14 | + | II-4B-4 |
| I-14 | + | II-4C-4 |
| I-14 | + | II-5-1 |
| I-14 | + | II-5-2 |
| I-14 | + | II-14-1 |
| I-14 | + | II-14-2 |
| I-14 | + | II-14-3 |
| I-14 | + | II-14-4 |
| I-14 | + | II-14-5 |
| I-14 | + | II-14-6 |
| I-14 | + | II-7A-1 |
| I-14 | + | II-7A-2 |
| I-14 | + | II-7A-3 |
| I-14 | + | II-7A-4 |
| I-14 | + | II-7A-5 |
| I-14 | + | II-7B-1 |
| I-14 | + | II-7C-1 |
| I-14 | + | II-7C-2 |
| I-14 | + | II-8A-1 |
| I-14 | + | II-8B-1 |
| I-14 | + | II-8C-1 |
| I-14 | + | II-9A-1 |
| I-14 | + | II-9B-1 |
| I-14 | + | II-9B-2 |
| I-14 | + | II-9C-1 |
| I-14 | + | II-10A-1 |
| I-14 | + | II-10A-2 |
| I-14 | + | II-10B-1 |
| I-14 | + | II-12A-1 |
| I-14 | + | II-12B-1 |
| I-14 | + | II-12B-2 |
| I-14 | + | II-12B-3 |
| I-14 | + | II-12C-1 |
| I-14 | + | II-12C-2 |
| I-14 | + | II-13-1 |
| I-14 | + | II-13-2 |
| I-14 | + | II-13-3 |
| I-14 | + | II-13-4 |
| I-14 | + | II-13-5 |
| I-14 | + | II-13-6 |
| I-14 | + | II-15-1 |
| I-14 | + | II-15-2 |
| I-14 | + | II-15-3 |
| I-14 | + | II-15-4 |
| I-14 | + | II-15-5 |
| I-14 | + | II-15-6 |
| I-14 | + | II-15-7 |
| I-14 | + | II-15-8 |
| I-14 | + | II-15-9 |
| I-14 | + | II-15-10 |
| I-14 | + | II-15-11 |
| I-14 | + | II-15-12 |
| I-14 | + | II-15-13 |
| I-14 | + | II-16-1 |
| I-14 | + | II-17-1 |
| I-14 | + | II-18A-1 |
| I-14 | + | II-18A-2 |
| I-14 | + | II-18A-3 |
| I-14 | + | II-18A-4 |
| I-14 | + | II-18A-5 |
| I-14 | + | II-18B-1 |
| I-14 | + | II-19-1 |
| I-14 | + | II-20A-1 |
| I-14 | + | II-20B-1 |
| I-14 | + | II-20C-1 |
| I-14 | + | II-20D-1 |
| I-14 | + | II-20D-2 |
| I-14 | + | II-21-1 |
| I-14 | + | II-21-2 |
| I-14 | + | II-21-3 |
| I-14 | + | II-21-4 |
| I-14 | + | II-21-5 |
| I-14 | + | II-21-6 |
| I-14 | + | II-21-7 |
| I-14 | + | II-22A-1 |
| I-14 | + | II-22B-1 |
| I-14 | + | II-23A-1 |
| I-14 | + | II-23A-2 |
| I-14 | + | II-23B-1 |
| I-14 | + | II-25-1 |
| I-14 | + | II-28-1 |
| I-14 | + | II-28-2 |
| I-14 | + | II-28-3 |
| I-14 | + | II-28-4 |
| I-14 | + | II-29-1 |
| I-14 | + | II-29-2 |
| I-14 | + | II-29-3 |
| I-14 | + | II-29-4 |
| I-14 | + | II-29-5 |
| I-14 | + | II-29-6 |
| I-14 | + | II-29-7 |
| I-14 | + | II-29-8 |
| I-14 | + | II-29-9 |
| I-14 | + | II-29-10 |
| I-14 | + | II-29-11 |
| I-14 | + | II-29-12 |
| I-14 | + | II-29-13 |
| I-14 | + | II-29-14 |
| I-14 | + | II-29-15 |
| I-14 | + | II-29-16 |
| I-14 | + | II-29-17 |
| I-14 | + | II-29-18 |
| I-14 | + | II-29-19 |
| I-14 | + | II-29-20 |
| I-14 | + | II-29-21 |
| I-14 | + | II-29-22 |
| I-14 | + | II-29-23 |
| I-14 | + | II-29-24 |
| I-14 | + | II-29-25 |
| I-14 | + | II-29-26 |
| I-14 | + | II-29-27 |
| I-14 | + | II-29-28 |
| I-14 | + | II-29-29 |
| I-14 | + | II-29-30 |
| I-14 | + | II-29-31 |
| I-15 | + | II-1A-1 |
| I-15 | + | II-1A-2 |
| I-15 | + | II-1A-3 |
| I-15 | + | II-1A-4 |
| I-15 | + | II-1A-5 |
| I-15 | + | II-1A-6 |
| I-15 | + | II-1A-7 |
| I-15 | + | II-1A-8 |
| I-15 | + | II-1A-9 |
| I-15 | + | II-1A-10 |
| I-15 | + | II-1A-11 |
| I-15 | + | II-1A-12 |
| I-15 | + | II-1A-13 |
| I-15 | + | II-1A-14 |
| I-15 | + | II-1A-15 |
| I-15 | + | II-1A-16 |
| I-15 | + | II-1A-17 |
| I-15 | + | II-1A-18 |
| I-15 | + | II-1A-19 |
| I-15 | + | II-1A-20 |
| I-15 | + | II-1A-21 |
| I-15 | + | II-1A-22 |
| I-15 | + | II-1A-23 |
| I-15 | + | II-1A-24 |
| I-15 | + | II-1A-25 |
| I-15 | + | II-1A-26 |
| I-15 | + | II-1A-27 |
| I-15 | + | II-1A-28 |
| I-15 | + | II-1A-29 |
| I-15 | + | II-1A-30 |
| I-15 | + | II-1A-31 |
| I-15 | + | II-1A-32 |
| I-15 | + | II-1A-33 |
| I-15 | + | II-1A-34 |
| I-15 | + | II-1A-35 |
| I-15 | + | II-1B-1 |
| I-15 | + | II-1B-2 |
| I-15 | + | II-1B-3 |
| I-15 | + | II-1B-4 |
| I-15 | + | II-1B-5 |
| I-15 | + | II-1B-6 |
| I-15 | + | II-1B-7 |
| I-15 | + | II-1B-8 |
| I-15 | + | II-1B-9 |
| I-15 | + | II-1B-10 |
| I-15 | + | II-1B-11 |
| I-15 | + | II-1B-12 |
| I-15 | + | II-1B-13 |
| I-15 | + | II-1B-14 |
| I-15 | + | II-1B-15 |
| I-15 | + | II-1B-16 |
| I-15 | + | II-1B-17 |
| I-15 | + | II-1B-18 |
| I-15 | + | II-1B-19 |
| I-15 | + | II-1B-20 |
| I-15 | + | II-1B-21 |
| I-15 | + | II-1B-22 |
| I-15 | + | II-1B-23 |
| I-15 | + | II-1B-24 |
| I-15 | + | II-1B-25 |
| I-15 | + | II-1B-26 |
| I-15 | + | II-1B-27 |
| I-15 | + | II-1B-28 |
| I-15 | + | II-1B-29 |
| I-15 | + | II-1B-30 |
| I-15 | + | II-1B-31 |
| I-15 | + | II-1B-32 |
| I-15 | + | II-1B-33 |
| I-15 | + | II-1B-34 |
| I-15 | + | II-1B-35 |
| I-15 | + | II-1B-36 |
| I-15 | + | II-1B-37 |
| I-15 | + | II-1B-38 |
| I-15 | + | II-1B-39 |
| I-15 | + | II-1B-40 |
| I-15 | + | II-1B-41 |
| I-15 | + | II-1B-42 |
| I-15 | + | II-1B-43 |
| I-15 | + | II-1B-44 |
| I-15 | + | II-1B-45 |
| I-15 | + | II-1B-46 |
| I-15 | + | II-1B-47 |
| I-15 | + | II-1B-48 |
| I-15 | + | II-1B-49 |
| I-15 | + | II-1B-50 |
| I-15 | + | II-1B-51 |
| I-15 | + | II-1B-52 |
| I-15 | + | II-1B-53 |
| I-15 | + | II-1B-54 |
| I-15 | + | II-1B-55 |
| I-15 | + | II-1B-56 |
| I-15 | + | II-1B-57 |
| I-15 | + | II-1B-58 |
| I-15 | + | II-1B-59 |
| I-15 | + | II-1B-60 |
| I-15 | + | II-1B-61 |
| I-15 | + | II-1B-62 |
| I-15 | + | II-1B-63 |
| I-15 | + | II-1B-64 |
| I-15 | + | II-1B-65 |
| I-15 | + | II-1B-66 |
| I-15 | + | II-1B-67 |
| I-15 | + | II-1B-68 |
| I-15 | + | II-1B-69 |
| I-15 | + | II-1B-70 |
| I-15 | + | II-1B-71 |
| I-15 | + | II-1B-72 |
| I-15 | + | II-1B-73 |
| I-15 | + | II-1B-74 |
| I-15 | + | II-1B-75 |
| I-15 | + | II-1B-76 |
| I-15 | + | II-1B-77 |
| I-15 | + | II-1B-78 |
| I-15 | + | II-1B-79 |
| I-15 | + | II-1B-80 |
| I-15 | + | II-1B-81 |
| I-15 | + | II-1B-82 |
| I-15 | + | II-1B-83 |
| I-15 | + | II-1B-84 |
| I-15 | + | II-1B-85 |
| I-15 | + | II-1B-86 |
| I-15 | + | II-1B-87 |
| I-15 | + | II-1B-88 |
| I-15 | + | II-2A-1 |
| I-15 | + | II-2A-2 |
| I-15 | + | II-2A-3 |
| I-15 | + | II-2A-4 |
| I-15 | + | II-2A-5 |
| I-15 | + | II-2A-6 |
| I-15 | + | II-2A-7 |
| I-15 | + | II-2A-8 |
| I-15 | + | II-2B-1 |
| I-15 | + | II-2B-2 |
| I-15 | + | II-2B-3 |
| I-15 | + | II-2B-4 |
| I-15 | + | II-2B-5 |
| I-15 | + | II-2B-6 |
| I-15 | + | II-3-1 |
| I-15 | + | II-3-2 |
| I-15 | + | II-3-3 |
| I-15 | + | II-3-4 |
| I-15 | + | II-3-5 |
| I-15 | + | II-3-6 |
| I-15 | + | II-3-7 |
| I-15 | + | II-3-8 |
| I-15 | + | II-3-9 |
| I-15 | + | II-3-10 |
| I-15 | + | II-3-11 |
| I-15 | + | II-3-12 |
| I-15 | + | II-3-13 |
| I-15 | + | II-3-14 |
| I-15 | + | II-3-15 |
| I-15 | + | II-3-16 |
| I-15 | + | II-3-17 |
| I-15 | + | II-3-18 |
| I-15 | + | II-3-19 |
| I-15 | + | II-3-20 |
| I-15 | + | II-3-21 |
| I-15 | + | II-3-22 |
| I-15 | + | II-3-23 |
| I-15 | + | II-3-24 |
| I-15 | + | II-3-25 |
| I-15 | + | II-3-26 |
| I-15 | + | II-3-27 |
| I-15 | + | II-3-28 |
| I-15 | + | II-3-29 |
| I-15 | + | II-3-30 |
| I-15 | + | II-3-31 |
| I-15 | + | II-3-32 |
| I-15 | + | II-3-33 |
| I-15 | + | II-3-34 |
| I-15 | + | II-3-35 |
| I-15 | + | II-3-36 |
| I-15 | + | II-3-37 |
| I-15 | + | II-3-38 |
| I-15 | + | II-3-39 |
| I-15 | + | II-3-40 |
| I-15 | + | II-3-41 |
| I-15 | + | II-3-42 |
| I-15 | + | II-3-43 |
| I-15 | + | II-3-44 |
| I-15 | + | II-3-45 |
| I-15 | + | II-3-46 |
| I-15 | + | II-3-47 |
| I-15 | + | II-3-48 |
| I-15 | + | II-3-49 |
| I-15 | + | II-3-50 |
| I-15 | + | II-3-51 |
| I-15 | + | II-3-52 |
| I-15 | + | II-3-53 |
| I-15 | + | II-3-54 |
| I-15 | + | II-3-55 |
| I-15 | + | II-3-56 |
| I-15 | + | II-3-57 |
| I-15 | + | II-3-58 |
| I-15 | + | II-4A-1 |
| I-15 | + | II-4A-2 |
| I-15 | + | II-4A-3 |
| I-15 | + | II-4A-4 |
| I-15 | + | II-4A-5 |
| I-15 | + | II-4A-6 |
| I-15 | + | II-4A-7 |
| I-15 | + | II-4A-8 |
| I-15 | + | II-4A-9 |
| I-15 | + | II-4B-1 |
| I-15 | + | II-4B-2 |
| I-15 | + | II-4B-3 |
| I-15 | + | II-4B-4 |
| I-15 | + | II-4C-4 |
| I-15 | + | II-5-1 |
| I-15 | + | II-5-2 |
| I-15 | + | II-15-1 |
| I-15 | + | II-15-2 |
| I-15 | + | II-15-3 |
| I-15 | + | II-15-4 |
| I-15 | + | II-15-5 |
| I-15 | + | II-15-6 |
| I-15 | + | II-7A-1 |
| I-15 | + | II-7A-2 |
| I-15 | + | II-7A-3 |
| I-15 | + | II-7A-4 |
| I-15 | + | II-7A-5 |
| I-15 | + | II-7B-1 |
| I-15 | + | II-7C-1 |
| I-15 | + | II-7C-2 |
| I-15 | + | II-8A-1 |
| I-15 | + | II-8B-1 |
| I-15 | + | II-8C-1 |
| I-15 | + | II-9A-1 |
| I-15 | + | II-9B-1 |
| I-15 | + | II-9B-2 |
| I-15 | + | II-9C-1 |
| I-15 | + | II-10A-1 |
| I-15 | + | II-10A-2 |
| I-15 | + | II-10B-1 |
| I-15 | + | II-12A-1 |
| I-15 | + | II-12B-1 |
| I-15 | + | II-12B-2 |
| I-15 | + | II-12B-3 |
| I-15 | + | II-12C-1 |
| I-15 | + | II-12C-2 |
| I-15 | + | II-13-1 |
| I-15 | + | II-13-2 |
| I-15 | + | II-13-3 |
| I-15 | + | II-13-4 |
| I-15 | + | II-13-5 |
| I-15 | + | II-13-6 |
| I-15 | + | II-15-1 |
| I-15 | + | II-15-2 |
| I-15 | + | II-15-3 |
| I-15 | + | II-15-4 |
| I-15 | + | II-15-5 |
| I-15 | + | II-15-6 |
| I-15 | + | II-15-7 |
| I-15 | + | II-15-8 |
| I-15 | + | II-15-9 |
| I-15 | + | II-15-10 |
| I-15 | + | II-15-11 |
| I-15 | + | II-15-12 |
| I-15 | + | II-15-13 |
| I-15 | + | II-16-1 |
| I-15 | + | II-17-1 |
| I-15 | + | II-18A-1 |
| I-15 | + | II-18A-2 |
| I-15 | + | II-18A-3 |
| I-15 | + | II-18A-4 |
| I-15 | + | II-18A-5 |
| I-15 | + | II-18B-1 |
| I-15 | + | II-19-1 |
| I-15 | + | II-20A-1 |
| I-15 | + | II-20B-1 |
| I-15 | + | II-20C-1 |
| I-15 | + | II-20D-1 |
| I-15 | + | II-20D-2 |
| I-15 | + | II-21-1 |
| I-15 | + | II-21-2 |
| I-15 | + | II-21-3 |
| I-15 | + | II-21-4 |
| I-15 | + | II-21-5 |
| I-15 | + | II-21-6 |
| I-15 | + | II-21-7 |
| I-15 | + | II-22A-1 |
| I-15 | + | II-22B-1 |
| I-15 | + | II-23A-1 |
| I-15 | + | II-23A-2 |
| I-15 | + | II-23B-1 |
| I-15 | + | II-25-1 |
| I-15 | + | II-28-1 |
| I-15 | + | II-28-2 |
| I-15 | + | II-28-3 |
| I-15 | + | II-28-4 |
| I-15 | + | II-29-1 |
| I-15 | + | II-29-2 |
| I-15 | + | II-29-3 |
| I-15 | + | II-29-4 |
| I-15 | + | II-29-5 |
| I-15 | + | II-29-6 |
| I-15 | + | II-29-7 |
| I-15 | + | II-29-8 |
| I-15 | + | II-29-9 |
| I-15 | + | II-29-10 |
| I-15 | + | II-29-11 |
| I-15 | + | II-29-12 |
| I-15 | + | II-29-13 |
| I-15 | + | II-29-14 |
| I-15 | + | II-29-15 |
| I-15 | + | II-29-16 |
| I-15 | + | II-29-17 |
| I-15 | + | II-29-18 |
| I-15 | + | II-29-19 |
| I-15 | + | II-29-20 |
| I-15 | + | II-29-21 |
| I-15 | + | II-29-22 |
| I-15 | + | II-29-23 |
| I-15 | + | II-29-24 |
| I-15 | + | II-29-25 |
| I-15 | + | II-29-26 |
| I-15 | + | II-29-27 |
| I-15 | + | II-29-28 |
| I-15 | + | II-29-29 |
| I-15 | + | II-29-30 |
| I-15 | + | II-29-31 |
| I-16 | + | II-1A-1 |
| I-16 | + | II-1A-2 |
| I-16 | + | II-1A-3 |
| I-16 | + | II-1A-4 |
| I-16 | + | II-1A-5 |
| I-16 | + | II-1A-6 |
| I-16 | + | II-1A-7 |
| I-16 | + | II-1A-8 |
| I-16 | + | II-1A-9 |
| I-16 | + | II-1A-10 |
| I-16 | + | II-1A-11 |
| I-16 | + | II-1A-12 |
| I-16 | + | II-1A-13 |
| I-16 | + | II-1A-14 |
| I-16 | + | II-1A-15 |
| I-16 | + | II-1A-16 |
| I-16 | + | II-1A-17 |
| I-16 | + | II-1A-18 |
| I-16 | + | II-1A-19 |
| I-16 | + | II-1A-20 |
| I-16 | + | II-1A-21 |
| I-16 | + | II-1A-22 |
| I-16 | + | II-1A-23 |
| I-16 | + | II-1A-24 |
| I-16 | + | II-1A-25 |
| I-16 | + | II-1A-26 |
| I-16 | + | II-1A-27 |
| I-16 | + | II-1A-28 |
| I-16 | + | II-1A-29 |
| I-16 | + | II-1A-30 |
| I-16 | + | II-1A-31 |
| I-16 | + | II-1A-32 |
| I-16 | + | II-1A-33 |
| I-16 | + | II-1A-34 |
| I-16 | + | II-1A-35 |
| I-16 | + | II-1B-1 |
| I-16 | + | II-1B-2 |
| I-16 | + | II-1B-3 |
| I-16 | + | II-1B-4 |
| I-16 | + | II-1B-5 |
| I-16 | + | II-1B-6 |
| I-16 | + | II-1B-7 |
| I-16 | + | II-1B-8 |
| I-16 | + | II-1B-9 |
| I-16 | + | II-1B-10 |
| I-16 | + | II-1B-11 |
| I-16 | + | II-1B-12 |
| I-16 | + | II-1B-13 |
| I-16 | + | II-1B-14 |
| I-16 | + | II-1B-15 |
| I-16 | + | II-1B-16 |
| I-16 | + | II-1B-17 |
| I-16 | + | II-1B-18 |
| I-16 | + | II-1B-19 |
| I-16 | + | II-1B-20 |
| I-16 | + | II-1B-21 |
| I-16 | + | II-1B-22 |
| I-16 | + | II-1B-23 |
| I-16 | + | II-1B-24 |
| I-16 | + | II-1B-25 |
| I-16 | + | II-1B-26 |
| I-16 | + | II-1B-27 |
| I-16 | + | II-1B-28 |
| I-16 | + | II-1B-29 |
| I-16 | + | II-1B-30 |
| I-16 | + | II-1B-31 |
| I-16 | + | II-1B-32 |
| I-16 | + | II-1B-33 |
| I-16 | + | II-1B-34 |
| I-16 | + | II-1B-35 |
| I-16 | + | II-1B-36 |
| I-16 | + | II-1B-37 |
| I-16 | + | II-1B-38 |
| I-16 | + | II-1B-39 |
| I-16 | + | II-1B-40 |
| I-16 | + | II-1B-41 |
| I-16 | + | II-1B-42 |
| I-16 | + | II-1B-43 |
| I-16 | + | II-1B-44 |
| I-16 | + | II-1B-45 |
| I-16 | + | II-1B-46 |
| I-16 | + | II-1B-47 |
| I-16 | + | II-1B-48 |
| I-16 | + | II-1B-49 |
| I-16 | + | II-1B-50 |
| I-16 | + | II-1B-51 |
| I-16 | + | II-1B-52 |
| I-16 | + | II-1B-53 |
| I-16 | + | II-1B-54 |
| I-16 | + | II-1B-55 |
| I-16 | + | II-1B-56 |
| I-16 | + | II-1B-57 |
| I-16 | + | II-1B-58 |
| I-16 | + | II-1B-59 |
| I-16 | + | II-1B-60 |
| I-16 | + | II-1B-61 |
| I-16 | + | II-1B-62 |
| I-16 | + | II-1B-63 |
| I-16 | + | II-1B-64 |
| I-16 | + | II-1B-65 |
| I-16 | + | II-1B-66 |
| I-16 | + | II-1B-67 |
| I-16 | + | II-1B-68 |
| I-16 | + | II-1B-69 |
| I-16 | + | II-1B-70 |
| I-16 | + | II-1B-71 |
| I-16 | + | II-1B-72 |
| I-16 | + | II-1B-73 |
| I-16 | + | II-1B-74 |
| I-16 | + | II-1B-75 |
| I-16 | + | II-1B-76 |
| I-16 | + | II-1B-77 |
| I-16 | + | II-1B-78 |
| I-16 | + | II-1B-79 |
| I-16 | + | II-1B-80 |
| I-16 | + | II-1B-81 |
| I-16 | + | II-1B-82 |
| I-16 | + | II-1B-83 |
| I-16 | + | II-1B-84 |
| I-16 | + | II-1B-85 |
| I-16 | + | II-1B-86 |
| I-16 | + | II-1B-87 |
| I-16 | + | II-1B-88 |
| I-16 | + | II-2A-1 |
| I-16 | + | II-2A-2 |
| I-16 | + | II-2A-3 |
| I-16 | + | II-2A-4 |
| I-16 | + | II-2A-5 |
| I-16 | + | II-2A-6 |
| I-16 | + | II-2A-7 |
| I-16 | + | II-2A-8 |
| I-16 | + | II-2B-1 |
| I-16 | + | II-2B-2 |
| I-16 | + | II-2B-3 |
| I-16 | + | II-2B-4 |
| I-16 | + | II-2B-5 |
| I-16 | + | II-2B-6 |
| I-16 | + | II-3-1 |
| I-16 | + | II-3-2 |
| I-16 | + | II-3-3 |
| I-16 | + | II-3-4 |
| I-16 | + | II-3-5 |
| I-16 | + | II-3-6 |
| I-16 | + | II-3-7 |
| I-16 | + | II-3-8 |
| I-16 | + | II-3-9 |
| I-16 | + | II-3-10 |
| I-16 | + | II-3-11 |
| I-16 | + | II-3-12 |
| I-16 | + | II-3-13 |
| I-16 | + | II-3-14 |
| I-16 | + | II-3-15 |
| I-16 | + | II-3-16 |
| I-16 | + | II-3-17 |
| I-16 | + | II-3-18 |
| I-16 | + | II-3-19 |
| I-16 | + | II-3-20 |
| I-16 | + | II-3-21 |
| I-16 | + | II-3-22 |
| I-16 | + | II-3-23 |
| I-16 | + | II-3-24 |
| I-16 | + | II-3-25 |
| I-16 | + | II-3-26 |
| I-16 | + | II-3-27 |
| I-16 | + | II-3-28 |
| I-16 | + | II-3-29 |
| I-16 | + | II-3-30 |
| I-16 | + | II-3-31 |
| I-16 | + | II-3-32 |
| I-16 | + | II-3-33 |
| I-16 | + | II-3-34 |
| I-16 | + | II-3-35 |
| I-16 | + | II-3-36 |
| I-16 | + | II-3-37 |
| I-16 | + | II-3-38 |
| I-16 | + | II-3-39 |
| I-16 | + | II-3-40 |
| I-16 | + | II-3-41 |
| I-16 | + | II-3-42 |
| I-16 | + | II-3-43 |
| I-16 | + | II-3-44 |
| I-16 | + | II-3-45 |
| I-16 | + | II-3-46 |
| I-16 | + | II-3-47 |
| I-16 | + | II-3-48 |
| I-16 | + | II-3-49 |
| I-16 | + | II-3-50 |
| I-16 | + | II-3-51 |
| I-16 | + | II-3-52 |
| I-16 | + | II-3-53 |
| I-16 | + | II-3-54 |
| I-16 | + | II-3-55 |
| I-16 | + | II-3-56 |
| I-16 | + | II-3-57 |
| I-16 | + | II-3-58 |
| I-16 | + | II-4A-1 |
| I-16 | + | II-4A-2 |
| I-16 | + | II-4A-3 |
| I-16 | + | II-4A-4 |
| I-16 | + | II-4A-5 |
| I-16 | + | II-4A-6 |
| I-16 | + | II-4A-7 |
| I-16 | + | II-4A-8 |
| I-16 | + | II-4A-9 |
| I-16 | + | II-4B-1 |
| I-16 | + | II-4B-2 |
| I-16 | + | II-4B-3 |
| I-16 | + | II-4B-4 |
| I-16 | + | II-4C-4 |
| I-16 | + | II-5-1 |
| I-16 | + | II-5-2 |
| I-16 | + | II-16-1 |
| I-16 | + | II-16-2 |
| I-16 | + | II-16-3 |
| I-16 | + | II-16-4 |
| I-16 | + | II-16-5 |
| I-16 | + | II-16-6 |
| I-16 | + | II-7A-1 |
| I-16 | + | II-7A-2 |
| I-16 | + | II-7A-3 |
| I-16 | + | II-7A-4 |
| I-16 | + | II-7A-5 |
| I-16 | + | II-7B-1 |
| I-16 | + | II-7C-1 |
| I-16 | + | II-7C-2 |
| I-16 | + | II-8A-1 |
| I-16 | + | II-8B-1 |
| I-16 | + | II-8C-1 |
| I-16 | + | II-9A-1 |
| I-16 | + | II-9B-1 |
| I-16 | + | II-9B-2 |
| I-16 | + | II-9C-1 |
| I-16 | + | II-10A-1 |
| I-16 | + | II-10A-2 |
| I-16 | + | II-10B-1 |
| I-16 | + | II-12A-1 |
| I-16 | + | II-12B-1 |
| I-16 | + | II-12B-2 |
| I-16 | + | II-12B-3 |
| I-16 | + | II-12C-1 |
| I-16 | + | II-12C-2 |
| I-16 | + | II-13-1 |
| I-16 | + | II-13-2 |
| I-16 | + | II-13-3 |
| I-16 | + | II-13-4 |
| I-16 | + | II-13-5 |
| I-16 | + | II-13-6 |
| I-16 | + | II-15-1 |
| I-16 | + | II-15-2 |
| I-16 | + | II-15-3 |
| I-16 | + | II-15-4 |
| I-16 | + | II-15-5 |
| I-16 | + | II-15-6 |
| I-16 | + | II-15-7 |
| I-16 | + | II-15-8 |
| I-16 | + | II-15-9 |
| I-16 | + | II-15-10 |
| I-16 | + | II-15-11 |
| I-16 | + | II-15-12 |
| I-16 | + | II-15-13 |
| I-16 | + | II-16-1 |
| I-16 | + | II-17-1 |
| I-16 | + | II-18A-1 |
| I-16 | + | II-18A-2 |
| I-16 | + | II-18A-3 |
| I-16 | + | II-18A-4 |
| I-16 | + | II-18A-5 |
| I-16 | + | II-18B-1 |
| I-16 | + | II-19-1 |
| I-16 | + | II-20A-1 |
| I-16 | + | II-20B-1 |
| I-16 | + | II-20C-1 |
| I-16 | + | II-20D-1 |
| I-16 | + | II-20D-2 |
| I-16 | + | II-21-1 |
| I-16 | + | II-21-2 |
| I-16 | + | II-21-3 |
| I-16 | + | II-21-4 |
| I-16 | + | II-21-5 |
| I-16 | + | II-21-6 |
| I-16 | + | II-21-7 |
| I-16 | + | II-22A-1 |
| I-16 | + | II-22B-1 |
| I-16 | + | II-23A-1 |
| I-16 | + | II-23A-2 |
| I-16 | + | II-23B-1 |
| I-16 | + | II-25-1 |
| I-16 | + | II-28-1 |
| I-16 | + | II-28-2 |
| I-16 | + | II-28-3 |
| I-16 | + | II-28-4 |
| I-16 | + | II-29-1 |
| I-16 | + | II-29-2 |
| I-16 | + | II-29-3 |
| I-16 | + | II-29-4 |
| I-16 | + | II-29-5 |
| I-16 | + | II-29-6 |
| I-16 | + | II-29-7 |
| I-16 | + | II-29-8 |
| I-16 | + | II-29-9 |
| I-16 | + | II-29-10 |
| I-16 | + | II-29-11 |
| I-16 | + | II-29-12 |
| I-16 | + | II-29-13 |
| I-16 | + | II-29-14 |
| I-16 | + | II-29-15 |
| I-16 | + | II-29-16 |
| I-16 | + | II-29-17 |
| I-16 | + | II-29-18 |
| I-16 | + | II-29-19 |
| I-16 | + | II-29-20 |
| I-16 | + | II-29-21 |
| I-16 | + | II-29-22 |
| I-16 | + | II-29-23 |
| I-16 | + | II-29-24 |
| I-16 | + | II-29-25 |
| I-16 | + | II-29-26 |
| I-16 | + | II-29-27 |
| I-16 | + | II-29-28 |
| I-16 | + | II-29-29 |
| I-16 | + | II-29-30 |
| I-16 | + | II-29-31 |

A preferred group of active compound combinations according to the invention are those which, in addition to an active compound of the formula (II), in particular one of the active compounds 1 to 103 listed below and referred to as being very particularly preferred, comprise the compound of the formula (I-1).

A further preferred group of active compound combinations according to the invention are those which, in addition to an active compound of the formula (II), in particular one of the active compounds 1 to 103 listed below and referred to as being very particularly preferred, comprise the compound of the formula (I-2).

A further preferred group of active compound combinations according to the invention are those which, in addition to an active compound of the formula (II), in particular one of the active compounds 1 to 103 listed below and referred to as being very particularly preferred, comprise the compound of the formula (I-3).

A further preferred group of active compound combinations according to the invention are those which, in addition to an active compound of the formula (II), in particular one of the active compounds 1 to 103 listed below and referred to as being very particularly preferred, comprise the compound of the formula (I-4).

A further preferred group of active compound combinations according to the invention are those which, in addition to an active compound of the formula (II), in particular one of the active compounds 1 to 103 listed below and referred to as being very particularly preferred, comprise the compound of the formula (I-5).

A further preferred group of active compound combinations according to the invention are those which, in addition to an active compound of the formula (II), in particular one of the active compounds 1 to 103 listed below and referred to as being very particularly preferred, comprise the compound of the formula (I-6).

A further preferred group of active compound combinations according to the invention are those which, in addition to an active compound of the formula (II), in particular one of the active compounds 1 to 103 listed below and referred to as being very particularly preferred, comprise the compound of the formula (I-7).

A further preferred group of active compound combinations according to the invention are those which, in addition to an active compound of the formula (II), in particular one of the active compounds 1 to 103 listed below and referred to as being very particularly preferred, comprise the compound of the formula (I-8).

A further preferred group of active compound combinations according to the invention are those which, in addition to an active compound of the formula (II), in particular one of the active compounds 1 to 103 listed below and referred to as being very particularly preferred, comprise the compound of the formula (I-14).

A further preferred group of active compound combinations according to the invention are those which, in addition to an active compound of the formula (II), in particular one of the active compounds 1 to 103 listed below and referred to as being very particularly preferred, comprise the compound of the formula (I-15).

A further preferred group of active compound combinations according to the invention are those which, in addition to an active compound of the formula (II), in particular one of the active compounds 1 to 103 listed below and referred to as being very particularly preferred, comprise the compound of the formula (I-16).

The following active compounds of the formula (II) are used with very particular preference in the active compound combinations according to the invention:

1. acrinathrin (II-3-1)

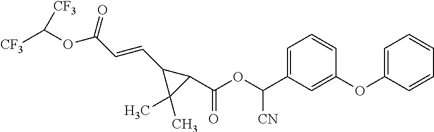

known from EP-A-048 186
   2. alpha-cypermethrin (II-3-18)

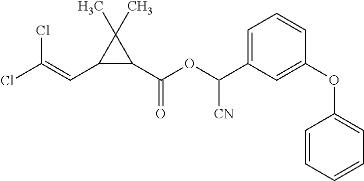

known from EP-A-067 461
   3. betacyfluthrin (II-3-3)

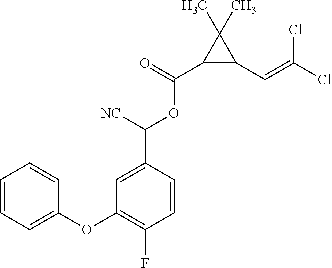

known from EP-A-206 149
   4. cyhalothrin (II-3-17)

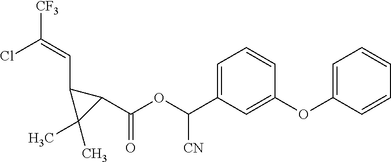

known from DE-A-2 802 962
   5. cypermethrin (II-3-18)

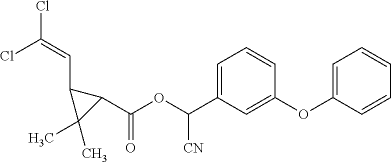

known from DE-A-2 326 077
   6. deltamethrin (II-3-20)

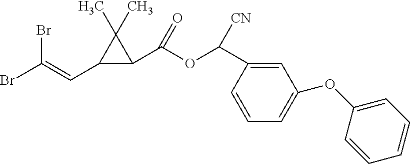

known from DE-A-2 326 077
   7. esfenvalerate (II-3-22)

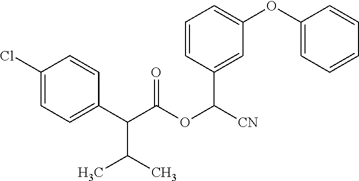

known from DE-A-2 737 297
   8. etofenprox (II-3-23)

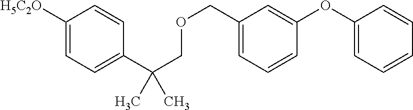

known from DE-A-3 117 510
   9. fenpropathrin (II-3-25)

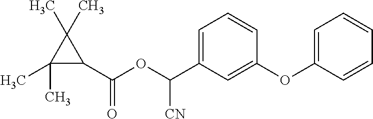

known from DE-A-2 231 312
   10. fenvalerate (II-3-27)

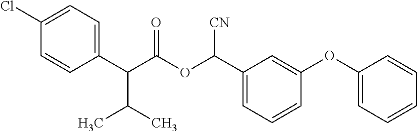

known from DE-A-2 335 347
   11. flucythrinate (II-3-29)

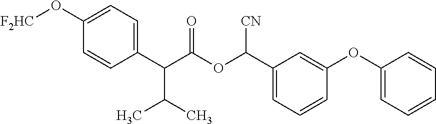

known from DE-A-2 757 066
   12 a. lambda-cyhalothrin (II-3-37)

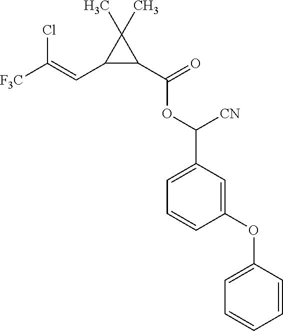

known from EP-A-106 469
   12b. gamma-cyhalothrin (II-3-34)

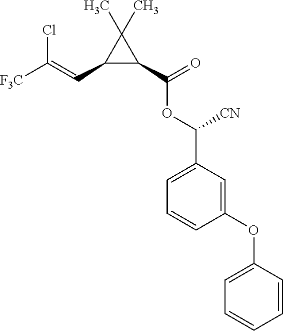

known from GB-A-02143823
   13. permethrin (II-3-39)

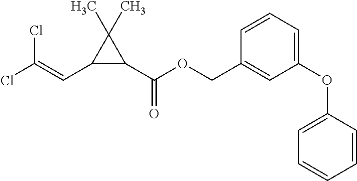

known from DE-A-2 326 077
   14. tau-fluvalinate (II-3-48)

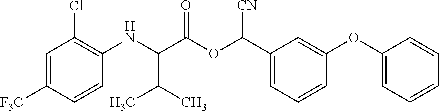

known from EP-A-038 617
   15. tralomethrin (II-3-52)

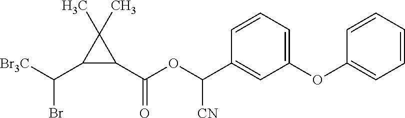

known from DE-A-2 742 546
   16. zeta-cypermethrin (II-3-18)

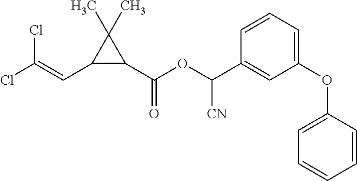

known from EP-A-026 542
   17. cyfluthrin (II-3-16)

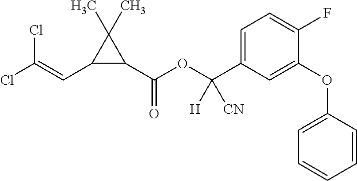

known from DE-A-27 09 264
   18. bifenthrin (II-3-4)

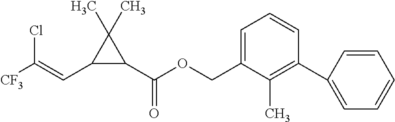

known from EP-A-049 977
   19. cycloprothrin (II-3-15)

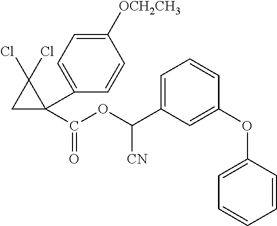

known from DE-A-2653189
   20. eflusilanate (II-3-56)

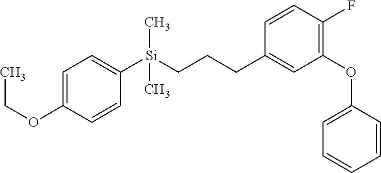

known from DE-A-36 04 781
   21. fubfenprox (II-3-33)

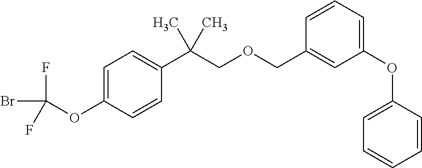

known from DE-A-37 08 231
   22. pyrethrin (II-3-55)

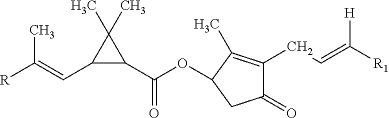

R═—CH₃ or —CO₂CH₃
R₁═—CH═CH₂ or —CH₃ or —CH₂CH₃
known from The Pesticide Manual, 1997, 11th Edition, p. 1056
   23. resmethrin (II-3-45)

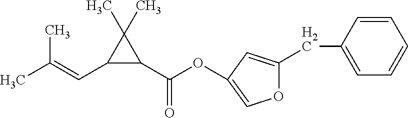

known from GB-A-1 168 797
   24. imidacloprid (II-4A-4)

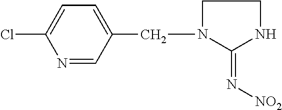

known from EP-A-00192060
   25. acetamiprid (II-4A-1)

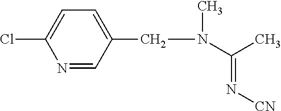

known from WO 91/04965
   26. thiamethoxam (II-4A-9)

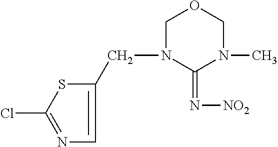

known from EP-A-00580553
   27. nitenpyram (II-4A-6)

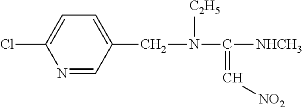

known from EP-A-00302389
   28. thiacloprid (II-4A-8)

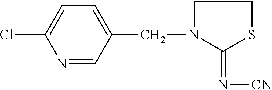

known from EP-A-00235725
   29. dinotefuran (II-4A-3)

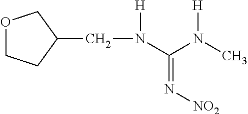

known from EP-A-00649845
   30. clothianidin (II-4A-2)

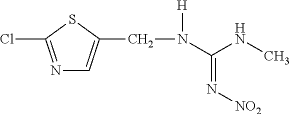

known from EP-A-00376279
   31. imidaclothiz (II-4A-5)

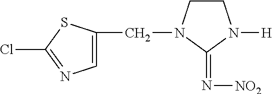

known from EP-A-00192060
   32. chlorfluazuron (II-15-2)

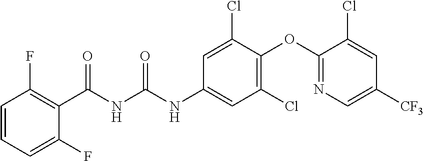

known from DE-A-2 818 830
   33. diflubenzuron (II-15-3)

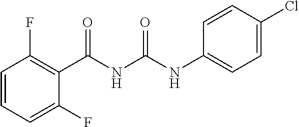

known from DE-A 2 123 236
   34. lufenuron (II-15-8)

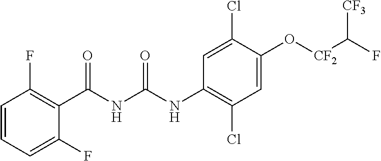

known from EP-A-179 022
   35. teflubenzuron (II-15-12)

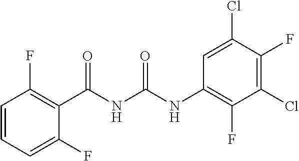

known from EP-A-052 833
   36. triflumuron (II-15-13)

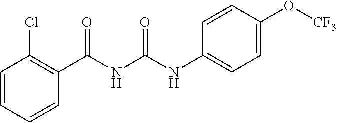

known from DE-A-2 601 780
   37. novaluron (II-15-9)

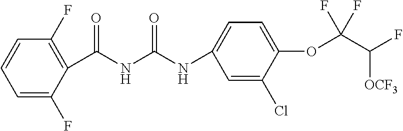

known from U.S. Pat. No. 4,980,376
   38. flufenoxuron (II-15-6)

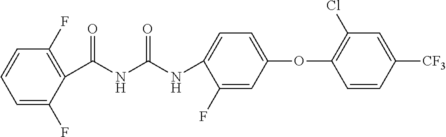

known from EP-A 161 019
   39. hexaflumuron (II-15-7)

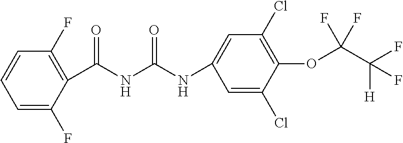

known from EP-A 71 279
   40. bistrifluoron (II-15-1)

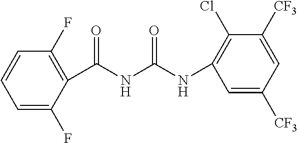

known from WO 98/00394
   41. noviflumuron (II-15-10)

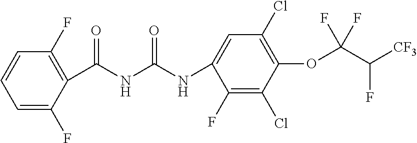

known from WO 98/19542
   42. buprofezin (II-16-1)

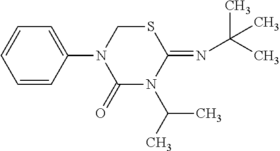

known from DE-A-2 824 126
   43. cyromazine (II-17-1)

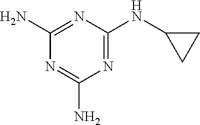

known from DE-A-2 736 876
   44. methoxyfenozide (II-18A-3)

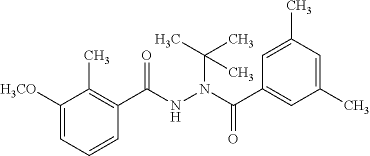

known from EP-A-639 559
   45. tebufenozide (II-18A-4)

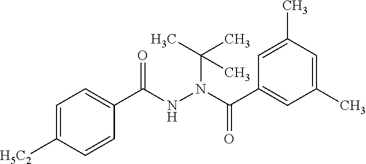

known from EP-A-339 854
   46. halofenozide (II-18A-2)

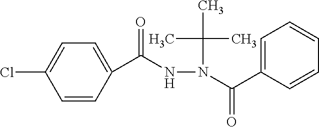

known from EP-A 228 564
   47. fufenozide JS-118 (II-18A-5)

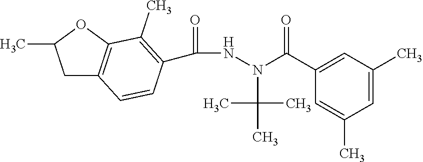

known from ZL 01108161.9, trade name Fu-Shen,
Modern Agrochemicals, Vol. 4, No. 3, 2005, 1-7
   48. chromafenozide (II-18A-1)

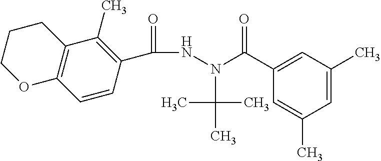

known from EP-A-496342
   49. endosulfan (II-2A-3)

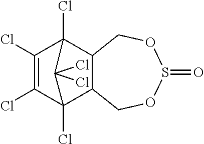

50. fipronil (II-2B-3)

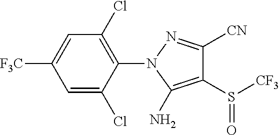

known from EP-A-295 117
   51. ethiprole (II-2B-2)

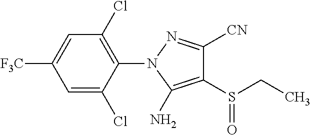

known from WO 97/22593
   52. pyrafluprole (II-2B-4)

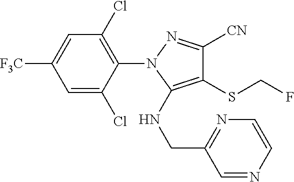

known from WO 01/00614
   53. pyriprole (II-2B-5)

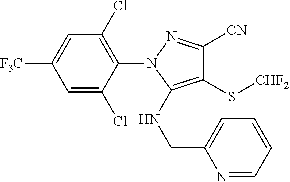

known from WO 02/10153
   54. flubendiamide (II-28-1)

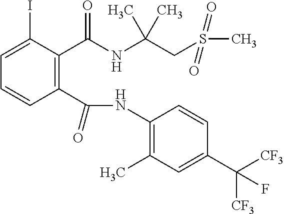

known from EP-A-01006107
   55. the compound (II-28-2)

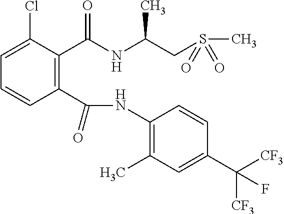

known from WO 06/022225

### 56. Rynaxapyr (II-28-3)

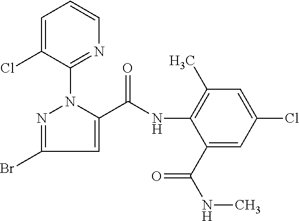 [0201] known from WO 03/015519

### 57. Cyazypyr (HGW 86) (II-28-4)

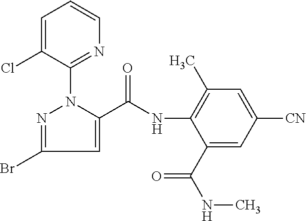 [0203] known from WO 04/067528
   58. emamectin (II-6-2)
known from EP-A-089 202
   59. emamectin benzoate (II-6-3)
known from EP-A-089202
   60. abamectin (II-6-1)
known from DE-A-27 17 040
   61. ivermectin (II-6-4)
known from EP-A-001 689
   62. milbemectin (II-6-6)
known from The Pesticide Manual, 11th Edition, 1997, p. 846
   63. lepimectin (II-6-5)
known from EP-A-675 133
   64. tebufenpyrad (II-21-5)

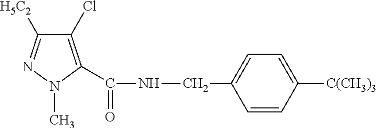

known from EP-A-289 879
   65. fenpyroximate (II-21-2)

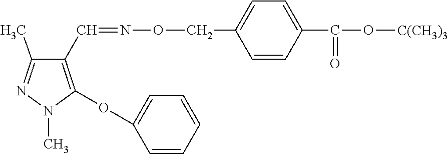

known from EP-A-234 045
   66. pyridaben (II-21-4)

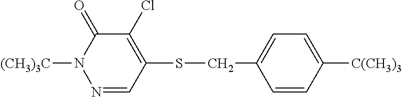

known from EP-A-134 439
   67. fenazaquin (II-21-1)

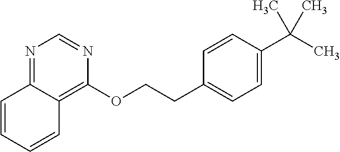

known from EP-A-326 329
   68. pyrimidifen (II-21-3)

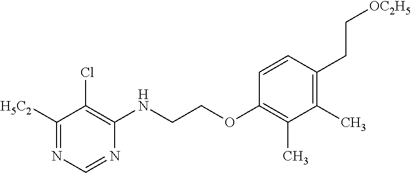

known from EP-A-196 524
   69. tolfenpyrad (II-21-6)

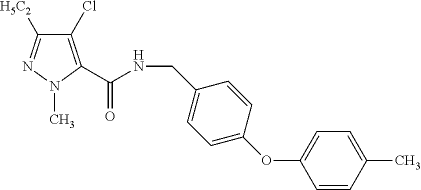

known from EP-A-365 925
   70. dicofol (II-29-11)

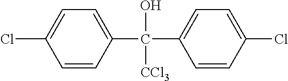

known from U.S. Pat. No. 2,812,280
   71. cyenopyrafen (II-20D-2)
(1E)-2-cyano-2-[4-(1,1-dimethylethyl)phenyl]-1-(1,3,4-trimethyl-1H-pyrazol-5-yl)ethenyl 2,2-dimethylpropanoate

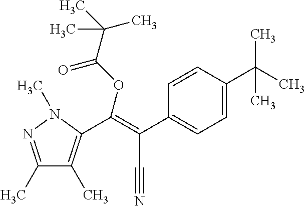

known from JP-A-2003 201 280
   72. cyflumetofen (II-20D-1)
2-methoxyethyl alpha-cyano-alpha-[4-(1,1-dimethylethyl)phenyl]-beta-oxo-2-(trifluoromethyl)benzenepropanoate

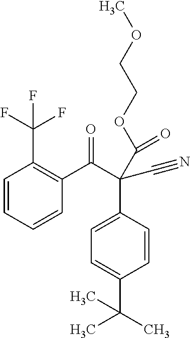

known from WO 2002/014263
   73. acequinocyl (II-20B-1)

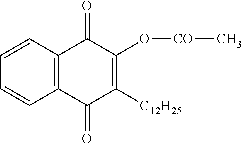

known from DE-A-26 41 343
   74. fluacrypyrim (II-20C-1)

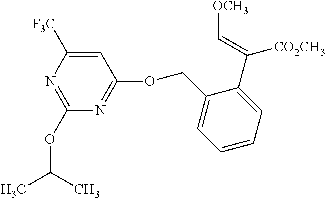

known from WO 96/16047
   75. bifenazate (II-25-1)

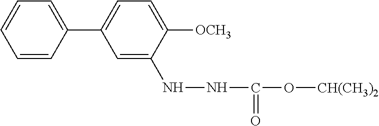

known from WO 93/10 083
   76. diafenthiuron (II-12A-1)

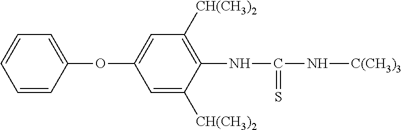

known from EP-A-210 487
   77. etoxazole (II-10B-1)

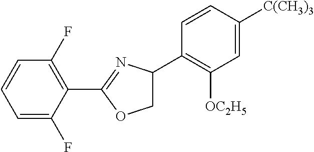

known from WO 93/22 297
   78. clofentezine (II-10A-1)

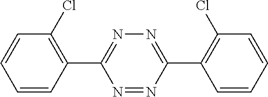

known from EP-A-005 912
   79. the macrolide of the formula

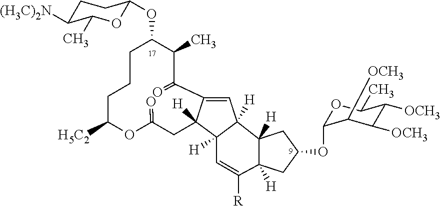

spinosad (II-5-1) a mixture of preferably
85% spinosyn A R═H
15% spinosyn B R═CH₃
known from EP-A-375 316
   80. triarathen (II-29-26)

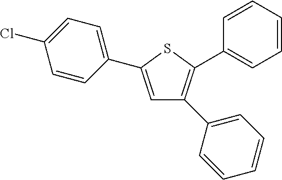

known from DE-A-2 724 494
   81. tetradifon (II-12C-2)

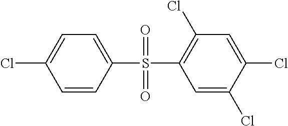

known from U.S. Pat. No. 2,812,281
   82. propargite (II-12C-1)

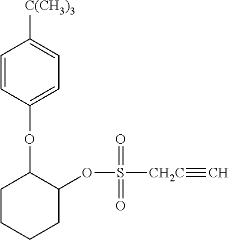

known from U.S. Pat. No. 3,272,854
   83. hexythiazox (II-10A-2)

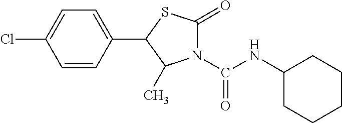

known from DE-A-3 037 105
   84. bromopropylate (II-29-4)

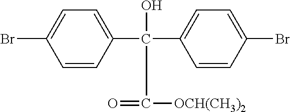

known from U.S. Pat. No. 3,784,696
   85. chinomethionat (II-29-6)

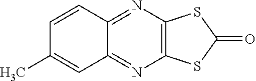

known from DE-A-1 100 372
   86. amitraz (II-19-1)

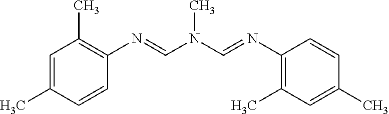

known from DE-A-2 061 132
   87. pyrifenquinazone (II-9B-2)
1-acetyl-3,4-dihydro-3-[(3-pyridinylmethyl)amino]-6-[1,2,2,2-tetrafluoro-1-(trifluoromethyl)ethyl-2(1H)-quinazolinone

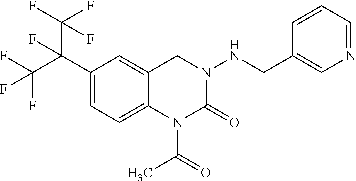

known from EP-A-01097932
   88. pymetrozine (II-9B-1)

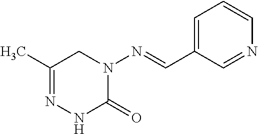

known from EP-A-314 615
   89. flonicamid (II-9C-1)

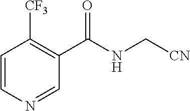

known from EP-A-00580374
   90. pyriproxyfen (II-7C-1)

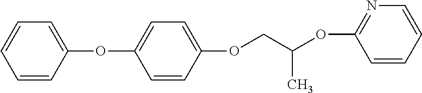

known from EP-A-128 648
   91. diofenolan (II-7C-2)

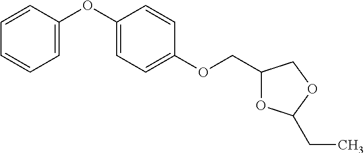

known from DE-A 2 655 910
   92. chlorfenapyr (II-13-1)

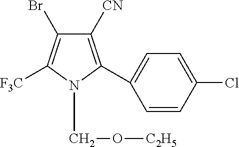

known from EP-A-347 488
   93. metaflumizone (II-22B-1)

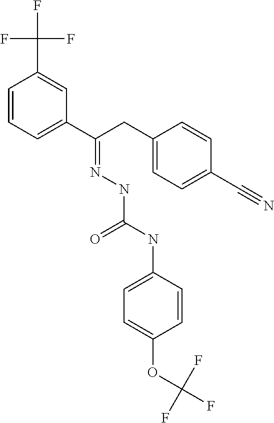

known from EP-A-00462456
   94. indoxacarb (II-22A-1)

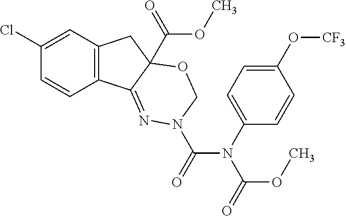

known from WO 92/11249 and also the +-enantiomer DPX-KN 128 known from ACS Symposium Series 800, p. 178
   95. chlorpyrifos (II-1B-12)

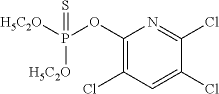

known from U.S. Pat. No. 3,244,586
   96. spirodiclofen (II-23A-1)

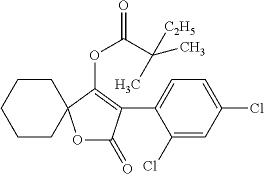

known from EP-A-528 156
   97. spiromesifen (II-23A-2)

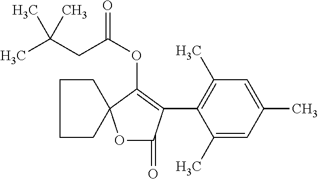

known from EP-A-528 156
   98. spirotetramat (II-23B-1)

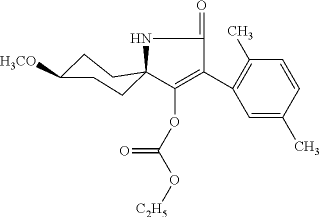

known from WO 04/007 448
   99. pyridalyl (II-29-23)

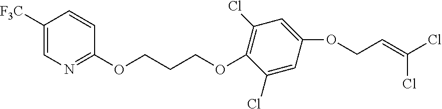

known from WO 96/11909
   100. 4-{[(6-chloropyrid-3-yl)methyl](methyl)amino}furan-2(5H)-one (II-29-28)

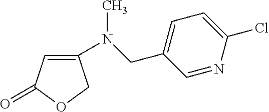

known from EP-A-0 539 588
   101. 4-{[(6-chloropyrid-3-yl)methyl](2,2-difluoroethyl)amino}furan-2(5H)-one (II-29-29)
known from WO 2007/115644

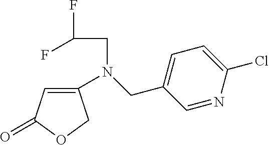

known from DE-A-102006015467
   102. spinetoram (II-5-2)

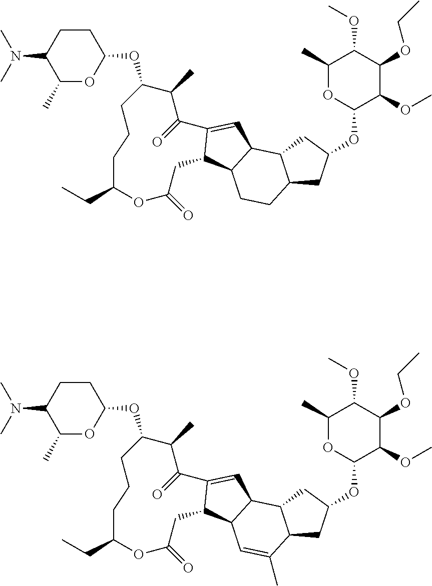

known from WO 97/00265, Crouse G D et. al. Pest. Management Science 57, 177-185, (2001)
103. 1-{2,4-dimethyl-5-[(2,2,2-trifluoroethyl)sulphinyl]phenyl}-3-(trifluoromethyl)-1H-1,2,4-triazole (II-29-31)

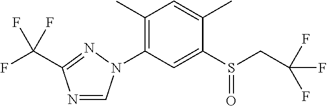

known from WO 1999/55668.

Most preference is given to active compound combinations comprising, as compound of the formula (I), the compound of the formula (I-5) or (I-8) and, as compound of the formula (II), an active compound selected from the group consisting of abamectin, acephate, acetamiprid, AKD 1022, alpha-cypermethrin, amitraz, bifenthrin, buprofezin, chloranthraniliprole, chlorfenapyr, chlorpyrifos, clothianidin, cyazypyr, cyenopyrafen, cyflumetofen, cypermethrin, cyromazine, deltamethrin, diafenthiuron, dinotefuran, emamectin benzoate, ethiprole, fenpyroximate, fipronil, flonicamid, flubendiamid, flufenoxuron, gamma-cyhalothrin, IKA 2002, imidacloprid, imidaclothiz, indoxacarb, L-cyhalothrin, lufenuron, metaflumizone, methoxyfenozide, milbemectin, novaluron, profenofos, pymetrozine, pyridaben, pyridalyl, spinetoram, spinosad, B-cyfluthrin, tebufenpyrad, thiacloprid, thiamethoxam, triazophos, triflumuron, compound II-28-2, compound II-29-28, compound II-29-29 and compound II-29-31.

In addition, the active compound combinations may also comprise further fungicidally, acaricidally or insecticidally active additives.

The improved activity becomes evident when the active compounds in the active compound combinations according to the invention are present in certain weight ratios. However, the weight ratios of the active compounds in the active compound combinations can be varied within a relatively wide range. In general, the combinations according to the invention comprise active compounds of the formula (I), in particular of the formulae (I-1) to (I-8), (I-14), (I-15), (I-16) and the mixing partner of the formula (II) in the preferred and particularly preferred mixing ratios stated in the table below:
the mixing ratios are based on weight ratios. The ratio is to be understood as active compound of the formula (I-1) to formula (I-8), (I-14), (I-15), (I-16):mixing partner

| | | | Particularly | Very particularly |
|---|---|---|---|---|
| | | Preferred mixing | preferred mixing | preferred mixing |
| | Mixing partner | ratio | ratio | ratio |
| 1. | acrinathrin | 125:1 to 1:125 | 25:1 to 1:25 | 5:1 to 1:5 |
| 2. | alpha-cypermethrin | 125:1 to 1:125 | 25:1 to 1:25 | 5:1 to 1:5 |
| 3. | betacyfluthrin | 125:1 to 1:125 | 25:1 to 1:25 | 5:1 to 1:5 |
| 4. | cyhalothrin | 125:1 to 1:125 | 25:1 to 1:25 | 5:1 to 1:5 |
| 5. | cypermethrin | 125:1 to 1:125 | 25:1 to 1:25 | 5:1 to 1:5 |
| 6. | deltamethrin | 125:1 to 1:125 | 25:1 to 1:25 | 5:1 to 1:5 |
| 7. | esfenvalerate | 125:1 to 1:125 | 25:1 to 1:25 | 5:1 to 1:5 |
| 8. | etofenprox | 125:1 to 1:125 | 25:1 to 1:25 | 5:1 to 1:5 |
| 9. | fenpropathrin | 125:1 to 1:125 | 25:1 to 1:25 | 5:1 to 1:5 |
| 10. | fenvalerate | 125:1 to 1:125 | 25:1 to 1:25 | 5:1 to 1:5 |
| 11. | flucythrinate | 125:1 to 1:125 | 25:1 to 1:25 | 5:1 to 1:5 |
| 12.a | lambda-cyhalothrin | 125:1 to 1:125 | 25:1 to 1:25 | 5:1 to 1:5 |
| 12.b | gamma-cyhalothrin | 125:1 to 1:125 | 25:1 to 1:25 | 5:1 to 1:5 |
| 13. | permethrin | 125:1 to 1:125 | 25:1 to 1:25 | 5:1 to 1:5 |
| 14. | tau-fluvalinate | 125:1 to 1:125 | 25:1 to 1:25 | 5:1 to 1:5 |
| 15. | tralomethrin | 125:1 to 1:125 | 25:1 to 1:25 | 5:1 to 1:5 |
| 16. | zeta-cypermethrin | 125:1 to 1:125 | 25:1 to 1:25 | 5:1 to 1:5 |
| 17. | cyfluthrin | 125:1 to 1:125 | 25:1 to 1:25 | 5:1 to 1:5 |
| 18. | bifenthrin | 125:1 to 1:125 | 25:1 to 1:25 | 5:1 to 1:5 |
| 19. | cycloprothrin | 125:1 to 1:125 | 25:1 to 1:25 | 5:1 to 1:5 |
| 20. | eflusilanate | 125:1 to 1:125 | 25:1 to 1:25 | 5:1 to 1:5 |
| 21. | fubfenprox | 125:1 to 1:125 | 25:1 to 1:25 | 5:1 to 1:5 |
| 22. | pyrethrin | 125:1 to 1:125 | 25:1 to 1:25 | 5:1 to 1:5 |
| 23. | resmethrin | 125:1 to 1:125 | 25:1 to 1:25 | 5:1 to 1:5 |
| 24. | imidacloprid | 125:1 to 1:125 | 25:1 to 1:25 | 5:1 to 1:5 |
| 25. | acetamiprid | 125:1 to 1:125 | 25:1 to 1:25 | 5:1 to 1:5 |
| 26. | thiamethoxam | 125:1 to 1:125 | 25:1 to 1:25 | 5:1 to 1:5 |
| 27. | nitenpyram | 125:1 to 1:125 | 25:1 to 1:25 | 5:1 to 1:5 |
| 28. | thiacloprid | 125:1 to 1:125 | 25:1 to 1:25 | 5:1 to 1:5 |
| 29. | dinotefuran | 125:1 to 1:125 | 25:1 to 1:25 | 5:1 to 1:5 |
| 30. | clothianidin | 125:1 to 1:125 | 25:1 to 1:25 | 5:1 to 1:5 |
| 31. | imidaclothiz | 125:1 to 1:125 | 25:1 to 1:25 | 5:1 to 1:5 |
| 32. | chlorfluazuron | 125:1 to 1:125 | 25:1 to 1:25 | 5:1 to 1:5 |
| 33. | diflubenzuron | 125:1 to 1:125 | 25:1 to 1:25 | 5:1 to 1:5 |
| 34. | lufenuron | 125:1 to 1:125 | 25:1 to 1:25 | 5:1 to 1:5 |
| 35. | teflubenzuron | 125:1 to 1:125 | 25:1 to 1:25 | 5:1 to 1:5 |
| 36. | triflumuron | 125:1 to 1:125 | 25:1 to 1:25 | 5:1 to 1:5 |
| 37. | novaluron | 125:1 to 1:125 | 25:1 to 1:25 | 5:1 to 1:5 |
| 38. | flufenoxuron | 125:1 to 1:125 | 25:1 to 1:25 | 5:1 to 1:5 |
| 39. | hexaflumuron | 125:1 to 1:125 | 25:1 to 1:25 | 5:1 to 1:5 |
| 40. | bisfluoron | 125:1 to 1:125 | 25:1 to 1:25 | 5:1 to 1:5 |
| 41. | noviflumuron | 125:1 to 1:125 | 25:1 to 1:25 | 5:1 to 1:5 |
| 42. | buprofezin | 125:1 to 1:125 | 25:1 to 1:25 | 5:1 to 1:5 |
| 43. | cyromazine | 125:1 to 1:125 | 25:1 to 1:25 | 5:1 to 1:5 |
| 44. | methoxyfenozide | 125:1 to 1:125 | 25:1 to 1:25 | 5:1 to 1:5 |
| 45. | tebufenozide | 125:1 to 1:125 | 25:1 to 1:25 | 5:1 to 1:5 |
| 46. | halofenozide | 125:1 to 1:125 | 25:1 to 1:25 | 5:1 to 1:5 |
| 47. | fufenozide (JS-118) | 125:1 to 1:125 | 25:1 to 1:25 | 5:1 to 1:5 |
| 48. | chromafenozide | 125:1 to 1:125 | 25:1 to 1:25 | 5:1 to 1:5 |
| 49. | endosulfan | 125:1 to 1:125 | 25:1 to 1:25 | 5:1 to 1:5 |
| 50. | fipronil | 125:1 to 1:125 | 25:1 to 1:25 | 5:1 to 1:5 |
| 51. | ethiprole | 125:1 to 1:125 | 25:1 to 1:25 | 5:1 to 1:5 |
| 52. | pyrafluprole | 125:1 to 1:125 | 25:1 to 1:25 | 5:1 to 1:5 |
| 53. | pyriprole | 125:1 to 1:125 | 25:1 to 1:25 | 5:1 to 1:5 |
| 54. | flubendiamide | 125:1 to 1:125 | 25:1 to 1:25 | 5:1 to 1:5 |
| 55. | compound II-28-2 | 125:1 to 1:125 | 25:1 to 1:25 | 5:1 to 1:5 |
| 56. | Rynaxapyr | 125:1 to 1:125 | 25:1 to 1:25 | 5:1 to 1:5 |
| 57. | HGW 86 (Cyazypyr) | 125:1 to 1:125 | 25:1 to 1:25 | 5:1 to 1:5 |
| 58. | emamectin | 125:1 to 1:125 | 25:1 to 1:25 | 5:1 to 1:5 |
| 59. | emamectin benzoate | 125:1 to 1:125 | 25:1 to 1:25 | 5:1 to 1:5 |
| 60. | abamectin | 125:1 to 1:125 | 25:1 to 1:25 | 5:1 to 1:5 |
| 61. | ivermectin | 125:1 to 1:125 | 25:1 to 1:25 | 5:1 to 1:5 |
| 62. | milbemectin | 125:1 to 1:125 | 25:1 to 1:25 | 5:1 to 1:5 |
| 63. | lepimectin | 125:1 to 1:125 | 25:1 to 1:25 | 5:1 to 1:5 |
| 64. | tebufenpyrad | 125:1 to 1:125 | 25:1 to 1:25 | 5:1 to 1:5 |
| 65. | fenpyroximate | 125:1 to 1:125 | 25:1 to 1:25 | 5:1 to 1:5 |
| 66. | pyridaben | 125:1 to 1:125 | 25:1 to 1:25 | 5:1 to 1:5 |
| 67. | fenazaquin | 125:1 to 1:125 | 25:1 to 1:25 | 5:1 to 1:5 |
| 68. | pyrimidifen | 125:1 to 1:125 | 25:1 to 1:25 | 5:1 to 1:5 |
| 69. | tolfenpyrad | 125:1 to 1:125 | 25:1 to 1:25 | 5:1 to 1:5 |
| 70. | dicofol | 125:1 to 1:125 | 25:1 to 1:25 | 5:1 to 1:5 |
| 71. | cyenopyrafen | 125:1 to 1:125 | 25:1 to 1:25 | 5:1 to 1:5 |
| 72. | cyflumetofen | 125:1 to 1:125 | 25:1 to 1:25 | 5:1 to 1:5 |
| 73. | acequinocyl | 125:1 to 1:125 | 25:1 to 1:25 | 5:1 to 1:5 |
| 74. | fluacrypyrin | 125:1 to 1:125 | 25:1 to 1:25 | 5:1 to 1:5 |
| 75. | bifenazate | 125:1 to 1:125 | 25:1 to 1:25 | 5:1 to 1:5 |
| 76. | diafenthiuron | 125:1 to 1:125 | 25:1 to 1:25 | 5:1 to 1:5 |
| 77. | etoxazole | 125:1 to 1:125 | 25:1 to 1:25 | 5:1 to 1:5 |
| 78. | clofentezine | 125:1 to 1:125 | 25:1 to 1:25 | 5:1 to 1:5 |
| 79. | spinosad | 125:1 to 1:125 | 25:1 to 1:25 | 5:1 to 1:5 |
| 80. | triarathen | 125:1 to 1:125 | 25:1 to 1:25 | 5:1 to 1:5 |
| 81. | tetradifon | 125:1 to 1:125 | 25:1 to 1:25 | 5:1 to 1:5 |
| 82. | propargite | 125:1 to 1:125 | 25:1 to 1:25 | 5:1 to 1:5 |
| 83. | hexythiazox | 125:1 to 1:125 | 25:1 to 1:25 | 5:1 to 1:5 |
| 84. | bromopropylate | 125:1 to 1:125 | 25:1 to 1:25 | 5:1 to 1:5 |
| 85. | chinomethionat | 125:1 to 1:125 | 25:1 to 1:25 | 5:1 to 1:5 |
| 86. | amitraz | 125:1 to 1:125 | 25:1 to 1:25 | 5:1 to 1:5 |
| 87. | pyrifluquinazon NNI 0101 | 125:1 to 1:125 | 25:1 to 1:25 | 5:1 to 1:5 |
| 88. | pymetrozine | 125:1 to 1:125 | 25:1 to 1:25 | 5:1 to 1:5 |
| 89. | flonicamid | 125:1 to 1:125 | 25:1 to 1:25 | 5:1 to 1:5 |
| 90. | pyriproxyfen | 125:1 to 1:125 | 25:1 to 1:25 | 5:1 to 1:5 |
| 91. | diofenolan | 125:1 to 1:125 | 25:1 to 1:25 | 5:1 to 1:5 |
| 92. | chlorfenapyr | 125:1 to 1:125 | 25:1 to 1:25 | 5:1 to 1:5 |
| 93. | metaflumizone | 125:1 to 1:125 | 25:1 to 1:25 | 5:1 to 1:5 |
| 94. | indoxacarb | 125:1 to 1:125 | 25:1 to 1:25 | 5:1 to 1:5 |
| 95. | chlorpyrifos | 125:1 to 1:125 | 25:1 to 1:25 | 5:1 to 1:5 |
| 96. | spirodiclofen | 125:1 to 1:125 | 25:1 to 1:25 | 5:1 to 1:5 |
| 97. | spiromesifen | 125:1 to 1:125 | 25:1 to 1:25 | 5:1 to 1:5 |
| 98. | spirotetramat | 125:1 to 1:125 | 25:1 to 1:25 | 5:1 to 1:5 |
| 99. | pyridalyl | 125:1 to 1:125 | 25:1 to 1:25 | 5:1 to 1:5 |
| 100. | compound II-29-28 | 125:1 to 1:125 | 25:1 to 1:25 | 5:1 to 1:5 |
| 101. | compound II-29-29 | 125:1 to 1:125 | 25:1 to 1:25 | 5:1 to 1:5 |
| 102. | spinetoram | 125:1 to 1:125 | 25:1 to 1:25 | 5:1 to 1:5 |
| 103. | compound II-29-31 | 125:1 to 1:125 | 25:1 to 1:25 | 5:1 to 1:5 |

The active compound combinations according to the invention are suitable for controlling animal pests, preferably arthropods and nematodes, in particular insects and arachnids, encountered in viticulture, in the cultivation of fruit, in agriculture, in animal health, in forests, in the protection of stored products and in the protection of materials and also in the hygiene sector. They are effective against normally sensitive and resistant species and against all or individual stages of development. The abovementioned pests include:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella occidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

The active compound combinations can be converted into the customary formulations such as solutions, emulsions, wettable powders, suspensions, powders, dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants, and/or foam formers.

If the extender used is water, it is also possible, for example, to use organic solvents as cosolvents. The following are essentially suitable as liquid solvents: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Suitable solid carriers are:

for example ammonium salts and ground natural minerals such as kaolins, clays, talc, chalk, quartz, attapulgite, montmorillonite or diatomaceous earth, and ground synthetic materials such as highly disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignosulphite waste liquors and methylcellulose.

Tackifiers such as carboxymethylcellulose and natural and synthetic polymers in the form of powders, granules or latexes, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95% by weight of active compound, preferably between 0.5 and 90%.

The active compound combinations according to the invention can be present in commercially available formulations and in the use forms, prepared from these formulations, as a mixture with other active compounds, such as insecticides, attractants, sterilants, bactericides, acaricides, nematicides, fungicides, growth-regulating substances or herbicides. The insecticides include, for example, phosphates, carbamates, carboxylates, chlorinated hydrocarbons, phenylureas and substances produced by microorganisms, inter alia.

Mixtures with other known active compounds such as herbicides or with fertilizers and growth regulators are also possible.

When used as insecticides, the active compound combinations according to the invention can furthermore be present in their commercially available formulations and in the use forms, prepared from these formulations, as a mixture with synergists. Synergists are compounds which increase the action of the active compounds, without it being necessary for the synergist added to be active itself.

The active compound content of the use forms prepared from the commercially available formulations can vary within wide limits. The active compound concentration of the use forms can be from 0.0000001 to 95% by weight of active compound, preferably between 0.0001 and 1% by weight.

The compounds are employed in a customary manner appropriate for the use forms.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The treatment according to the invention of the plants and parts of plants with the active compound combinations is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts”, “parts of plants” and “plant parts” have been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferred and to be treated according to the invention include all plants which, in the genetic modification, received genetic material which imparts particularly advantageous useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are the increased defense of the plants against insects by toxins formed in the plants, in particular those formed by the genetic material from Bacillus Thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes in question which impart the desired traits can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these or still-to-be-developed genetic traits, which plants will be developed and/or marketed in the future.

The plants listed can be treated according to the invention in a particularly advantageous manner with the active compound mixture according to the invention. The preferred ranges stated above for the mixtures also apply to the treatment of these plants. Particular emphasis is given to the treatment of plants with the mixtures specifically mentioned in the present text.

The good insecticidal and acaricidal action of the active compound combinations according to the invention can be seen from the examples which follow. While the individual active compounds show weaknesses in their action, the combinations show an action which exceeds a simple sum of actions.

A synergistic effect in insecticides and acaricides is always present when the action of the active compound combinations exceeds the total of the actions of the active compounds when applied individually.

The expected activity of a given combination of two active compounds can be calculated according to S. R. Colby, Weeds 15 (1967), 20-22:

### Biological Examples

The expected activity of a given combination of two active compounds can be calculated as follows, according to S. R. Colby, Weeds 15 (1967), 20-22:

### If

X is the kill rate, expressed as a percentage of the untreated control, when employing active compound A at an application rate of m g/ha or in a concentration of m ppm,
Y is the kill rate, expressed as a percentage of the untreated control, when employing active compound B at an application rate of n g/ha or in a concentration of n ppm and
E is the kill rate, expressed as a percentage of the untreated control, when employing active compounds A and B at application rates of m and n g/ha or in a concentration of m and n ppm,
then

$$E = X + Y - \frac{X \cdot Y}{100}$$

If the actual kill rate exceeds the calculated value, the kill of the combination is superadditive, i.e. a synergistic effect is present. In this case, the actually observed kill rate must exceed the value calculated using the above formula for the expected kill rate (E).

### EXAMPLE A

### Myzus persicae Test

solvents: 78 parts by weight of acetone
1.5 parts by weight of dimethylformamide
   emulsifier: 0.5 part by weight of alkylaryl polyglycol ether

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) which are heavily infested by the green peach aphid (Myzus persicae) are treated by spraying with the active compound preparation of the desired concentration.

After the desired period of time, the kill in % is determined 100% means that all aphids have been killed; 0% means that none of the aphids have been killed. The kill rates determined are entered into Colby's formula.

In this test, for example, the following active compound combinations in accordance with the present application show a synergistically enhanced activity compared to the active compounds applied individually:

TABLE A - 1
Myzus persicae test

| | Concentration | Kill | |
|---|---|---|---|
| Active compound | in g/ha | in % after 1^{d} | |
| compound (I-5) | 0.8 | 0 | |
| | 0.16 | 0 | |
| compound (I-8) | 0.16 | 0 | |
| amitraz | 0.8 | 0 | |
| compound (I-8) + amitraz (1:5) | | found* | calc.** |
| according to the invention | 0.16 + 0.8 | 30 | 0 |
| buprofezin | 4 | 0 | |
| compound (I-5) + buprofezin (1:5) | | found* | calc.** |
| According to the invention | 0.8 + 4 | 30 | 0 |
| cyazypyr | 0.16 | 0 | |
| compound (I-8) + cyazypyr (1:1) | | found* | calc.** |
| according to the invention | 0.16 + 0.16 | 70 | 0 |
| deltamethrin | 0.032 | 0 | |
| compound (I-5) + deltamethrin (5:1) | | found* | calc.** |
| according to the invention | 0.16 + 0.032 | 30 | 0 |
| compound (I-8) + deltamethrin (5:1) | | found* | calc.** |
| according to the invention | 0.16 + 0.032 | 30 | 0 |
| dinotefuran | 0.8 | 0 | |
| compound (I-8) + dinotefuran (1:5) | | found* | calc.** |
| according to the invention | 0.16 + 0.8 | 80 | 0 |
| flonicamid | 4 | 20 | |
| | 0.8 | 0 | |
| compound (I-5) + flonicamid (1:5) | | found* | calc.** |
| According to the invention | 0.8 + 4 | 80 | 20 |
| compound (I-8) + flonicamid (1:5) | | found* | calc.** |
| according to the invention | 0.16 + 0.8 | 20 | 0 |
| flubendiamid | 4 | 0 | |
| | 0.8 | 0 | |
| compound (I-5) + | | | |
| flubendiamide (1:5) | | found* | calc.** |
| according to the invention | 0.8 + 4 | 50 | 0 |
| compound (I-8) + | | | |
| flubendiamide (1:5) | | found* | calc.** |
| according to the invention | 0.16 + 0.8 | 40 | 0 |
| imidacloprid | 0.16 | 50 | |
| compound (I-8) + imidacloprid (1:1) | | found* | calc.** |
| according to the invention | 0.16 + 0.16 | 70 | 50 |
| thiacloprid | 0.16 | 0 | |
| compound (I-5) + thiacloprid (1:1) | | found* | calc.** |
| according to the invention | 0.16 + 0.16 | 30 | 0 |
| compound (I-8) + thiacloprid (1:1) | | found* | calc.** |
| according to the invention | 0.16 + 0.16 | 60 | 0 |

TABLE A - 2
Myzus persicae test

| | Concentration | Kill | |
|---|---|---|---|
| Active compound | in g/ha | in % after 6^{d} | |
| compound (I-5) | 0.8 | 20 | |
| | 0.16 | 0 | |
| compound (I-8) | 0.16 | 60 | |
| amitraz | 4 | 0 | |
| compound (I-5) + amitraz (1:5) | | found* | calc.** |
| according to the invention | 0.8 + 4 | 90 | 20 |
| compound II-29-29 | 0.8 | 50 | |
| compound (I-8) + compound II-29-29 (1:5) | | found* | calc.** |
| according to the invention | 0.16 + 0.8 | 100 | 80 |
| chlorpyrifos | 0.8 | 0 | |
| | 0.16 | 0 | |
| compound (I-5) + chlorpyrifos (1:1) | | found* | calc.** |
| according to the invention | 0.8 + 0.8 | 80 | 20 |
| compound (I-8) + chlorpyrifos (1:1) | | found* | calc.** |
| according to the invention | 0.16 + 0.16 | 90 | 60 |
| cyromazine | 0.8 | 0 | |
| | 0.16 | 0 | |
| compound (I-5) + cyromazine (1:1) | | found* | calc.** |
| according to the invention | 0.8 + 0.8 | 90 | 20 |
| compound (I-8) + cyromazine (1:1) | | found* | calc.** |
| according to the invention | 0.16 + 0.16 | 90 | 60 |
| fenpyroximate | 0.8 | 0 | |
| compound (I-5) + fenpyroximate (1:1) | | found* | calc.** |
| according to the invention | 0.8 + 0.8 | 40 | 20 |
| methoxyfenozide | 0.8 | 0 | |
| | 0.16 | 0 | |
| compound (I-5) + methoxyfenozide (1:1) | | found* | calc.** |
| According to the invention | 0.8 + 0.8 | 50 | 20 |
| compound (I-8) + methoxyfenozide (1:1) | | found* | calc.** |
| according to the invention | 0.16 + 0.16 | 90 | 60 |
| novaluron | 4 | 0 | |
| compound (I-5) + novaluron (1:5) | | found* | calc.** |
| according to the invention | 0.8 + 4 | 70 | 20 |
| pyridaben | 0.8 | 0 | |
| compound (I-5) + pyridaben (1:1) | | found* | calc.** |
| according to the invention | 0.8 + 0.8 | 60 | 20 |
| pymetrozine | 0.8 | 60 | |
| | 0.16 | 0 | |
| compound (I-5) + pymetrozine (1:1) | | found* | calc.** |
| according to the invention | 0.8 + 0.8 | 100 | 68 |
| compound (I-8) + pymetrozine (1:1) | | found* | calc.** |
| according to the invention | 0.16 + 0.16 | 90 | 60 |
| spinetoram | 0.8 | 0 | |
| compound (I-5) + spinetoram (1:1) | | found* | calc.** |
| according to the invention | 0.8 + 0.8 | 60 | 20 |
| tebufenpyrad | 0.8 | 0 | |
| | 0.16 | 0 | |
| compound (I-5) + tebufenpyrad (1:1) | | found* | calc.** |
| according to the invention | 0.8 + 0.8 | 40 | 20 |
| compound (I-8) + tebufenpyrad (1:1) | | found* | calc.** |
| according to the invention | 0.16 + 0.16 | 80 | 60 |
| abamectin | 0.032 | 0 | |
| compound (I-5) + abamectin (25:1) | | found* | calc.** |
| according to the invention | 0.8 + 0.032 | 70 | 20 |
| compound II-28-2 | 0.032 | 0 | |
| compound (I-5) + compound II-28-2 (5:1) | | found* | calc.** |
| according to the invention | 0.16 + 0.032 | 70 | 0 |
| emamectin benzoate | 0.0064 | 0 | |
| compound (I-8) + emamectin benzoate (25:1) | | found* | calc.** |
| according to the invention | 0.16 + 0.0064 | 80 | 60 |
| ethiprole | 0.8 | 0 | |
| compound (I-5) + ethiprole (1:5) | | found* | calc.** |
| according to the invention | 0.16 + 0.8 | 60 | 0 |
| fipronil | 0.8 | 0 | |
| compound (I-5) + fipronil (1:5) | | found* | calc.** |
| according to the invention | 0.16 + 0.8 | 90 | 0 |
| flonicamid | 0.032 | 0 | |
| compound (I-5) + flonicamid (25:1) | | found* | calc.** |
| according to the invention | 0.8 + 0.032 | 70 | 20 |
| indoxacarb | 0.8 | 0 | |
| compound (I-5) + indoxacarb (1:5) | | found* | calc.** |
| according to the invention | 0.16 + 0.8 | 60 | 0 |
| Rynaxapyr | 0.032 | 0 | |
| compound (I-5) + Rynaxapyr (5:1) | | found* | calc.** |
| according to the invention | 0.16 + 0.032 | 99 | 0 |
| triazophos | 0.8 | 0 | |
| compound (I-5) + triazophos (1:1) | | found* | calc.** |
| According to the invention | 0.8 + 0.8 | 70 | 20 |
| compound II-29-28 | 0.16 | 0 | |
| compound (I-5) + compound II-29-28 (1:1) | | found* | calc.** |
| according to the invention | 0.16 + 0.16 | 90 | 0 |
| alpha-cypermethrin | 0.0064 | 0 | |
| compound (I-8) + alpha-cypermethrin (25:1) | | found* | calc.** |
| according to the invention | 0.16 + 0.0064 | 90 | 60 |
| bifenthrin | 0.032 | 0 | |
| compound (I-5) + bifenthrin (25:1) | | found* | calc.** |
| according to the invention | 0.8 + 0.032 | 40 | 20 |
| β-cyfluthrin | 0.032 | 0 | |
| | 0.0064 | 0 | |
| compound (I-5) + β-cyfluthrin (25:1) | | found* | calc.** |
| according to the invention | 0.8 + 0.032 | 60 | 20 |
| compound (I-8) + β-cyfluthrin (25:1) | | found* | calc.** |
| according to the invention | 0.16 + 0.0064 | 90 | 60 |
| cypermethrin | 0.16 | 0 | |
| | 0.032 | 0 | |
| compound (I-5) + cypermethrin (5:1) | | found* | calc.** |
| according to the invention | 0.8 + 0.16 | 50 | 20 |
| compound (I-8) + cypermethrin (5:1) | | found* | calc.** |
| according to the invention | 0.16 + 0.032 | 90 | 60 |
| gamma-cyhalothrin | 0.032 | 0 | |
| compound (I-5) + gamma-cyhalothrin (25:1) | | found* | calc.** |
| according to the invention | 0.8 + 0.032 | 70 | 20 |
| lambda-cyhalothrin | 0.032 | 0 | |
| | 0.0064 | 0 | |
| compound (I-5) + lambda-cyhalothrin (25:1) | | found* | calc.** |
| according to the invention | 0.8 + 0.032 | 40 | 20 |
| compound (I-8) + lambda-cyhalothrin (25:1) | | found* | calc.** |
| according to the invention | 0.16 + 0.0064 | 80 | 60 |
| acetamiprid | 0.032 | 0 | |
| compound (I-5) + acetamiprid (25:1) | | found* | calc.** |
| according to the invention | 0.8 + 0.032 | 40 | 20 |
| clothianidin | 0.16 | 40 | |
| compound (I-5) + clothianidin (1:1) | | found* | calc.** |
| according to the invention | 0.16 + 0.16 | 60 | 40 |
| thiamethoxam | 0.032 | 0 | |
| | 0.0064 | 0 | |
| compound (I-5) + thiamethoxam (25:1) | | found* | calc.** |
| according to the invention | 0.8 + 0.032 | 60 | 20 |
| compound (I-8) + thiamethoxam (25:1) | | found* | calc.** |
| according to the invention | 0.16 + 0.0064 | 90 | 60 |

*found = activity found
**calc. = activity calculated using Colby's formula

### EXAMPLE B

### Phaedon cochleariae Larvae Test

Solvents: 78 parts by weight of acetone
1.5 parts by weight of dimethylformamide
   Emulsifier: 0.5 part by weight of alkylaryl polyglycol ether

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) are treated by spraying with the active compound preparation of the desired concentration and are populated with larvae of the mustard beetle (Phaedon cochleariae) while the leaves are still moist.

After the desired period of time, the kill in % is determined 100% means that all beetle larvae have been killed; 0% means that none of the beetle larvae have been killed. The kill rates determined are entered into Colby's formula.

In this test, the following active compound combinations in accordance with the present application show a synergistically enhanced activity compared to the active compounds applied individually:

TABLE B - 1
Phaedon cochleariae larvae test

| | Concentration | Kill | |
|---|---|---|---|
| Active compound | in g/ha | in % after 2^{d} | |
| compound (I-5) | 20 | 0 | |
| | 4 | 0 | |
| compound (I-8) | 100 | 67 | |
| | 20 | 0 | |
| | 4 | 0 | |
| | 0.8 | 0 | |
| | 0.16 | 0 | |
| alpha-cypermethrin | 0.8 | 0 | |
| compound (I-8) + alpha-cypermethrin (25:1) | | found* | calc.** |
| according to the invention | 20 + 0.8 | 100 | 0 |
| cyazypyr | 0.16 | 17 | |
| compound (I-8) + cyazypyr (1:1) | | found* | calc.** |
| according to the invention | 0.16 + 0.16 | 50 | 17 |
| cypermethrin | 0.8 | 50 | |
| compound (I-8) + cypermethrin (5:1) | | found* | calc.** |
| according to the invention | 4 + 0.8 | 67 | 50 |
| deltamethrin | 0.8 | 67 | |
| compound (I-5) + deltamethrin (5:1) | | found* | calc.** |
| according to the invention | 4 + 0.8 | 100 | 67 |
| compound (I-8) + deltamethrin (5:1) | | found* | calc.** |
| according to the invention | 4 + 0.8 | 100 | 67 |
| fenpyroximate | 20 | 0 | |
| compound (I-5) + fenpyroximate (1:1) | | found* | calc.** |
| according to the invention | 20 + 20 | 33 | 0 |
| compound (I-8) + fenpyroximate (1:1) | | found* | calc.** |
| according to the invention | 20 + 20 | 33 | 0 |
| flonicamid | 20 | 0 | |
| compound (I-5) + flonicamid (1:5) | | found* | calc.** |
| According to the invention | 4 + 20 | 33 | 0 |
| imidacloprid | 4 | 0 | |
| compound (I-5) + imidacloprid (1:1) | | found* | calc.** |
| according to the invention | 4 + 4 | 33 | 0 |
| indoxacarb | 20 | 33 | |
| | 4 | 0 | |
| compound (I-5) + indoxacarb (1:5) | | found* | calc.** |
| According to the invention | 4 + 20 | 50 | 33 |
| compound (I-8) + indoxacarb (1:5) | | found* | calc.** |
| according to the invention | 0.8 + 4 | 67 | 0 |
| profenofos | 20 | 50 | |
| compound (I-5) + profenofos (1:1) | | found* | calc.** |
| According to the invention | 20 + 20 | 67 | 50 |
| compound (I-8) + profenofos (1:1) | | found* | calc.** |
| according to the invention | 20 + 20 | 83 | 50 |
| lufenuron | 100 | 0 | |
| compound (I-8) + lufenuron (1:1) | | found* | calc.** |
| according to the invention | 100 + 100 | 83 | 67 |

*found = activity found
**calc. = activity calculated using Colby's formula

TABLE B - 2
Phaedon cochleariae larvae test

| | Concentration | Kill | |
|---|---|---|---|
| Active compound | in g/ha | in % after 6^{d} | |
| compound (I-5) | 20 | 0 | |
| | 4 | 0 | |
| | 0.8 | 0 | |
| compound (I-8) | 100 | 67 | |
| | 20 | 17 | |
| | 4 | 0 | |
| | 0.8 | 0 | |
| | 0.16 | 0 | |
| acephate | 100 | 0 | |
| compound (I-8) + acephate (1:5) | | found* | calc.** |
| according to the invention | 20 + 100 | 33 | 17 |
| buprofezin | 100 | 0 | |
| compound (I-8) + buprofezin (1:5) | | found* | calc.** |
| According to the invention | 20 + 100 | 33 | 17 |
| BYI 2960 | 100 | 67 | |
| compound (I-8) + compound II-29-29 (1:5) | | found* | calc.** |
| according to the invention | 20 + 100 | 100 | 72.61 |
| chlorfenapyr | 0.8 | 0 | |
| compound (I-8) + chlorfenapyr (1:5) | | found* | calc.** |
| according to the invention | 0.16 + 0.8 | 33 | 0 |
| cyromazine | 20 | 0 | |
| compound (I-5) + cyromazine (1:1) | | found* | calc.** |
| according to the invention | 20 + 20 | 33 | 0 |
| diafenthiuron | 20 | 0 | |
| compound (I-8) + diafenthiuron (1:1) | | found* | calc.** |
| according to the invention | 20 + 20 | 50 | 17 |
| flonicamid | 100 | 0 | |
| compound (I-8) + flonicamid (1:5) | | found* | calc.** |
| According to the invention | 20 + 100 | 33 | 17 |
| flubendiamid | 20 | 50 | |
| compound (I-8) + flubendiamid (1:5) | | found* | calc.** |
| according to the invention | 4 + 20 | 83 | 50 |
| methoxyfenozide | 20 | 0 | |
| compound (I-5) + methoxyfenozide (1:1) | | found* | calc.** |
| according to the invention | 20 + 20 | 50 | 0 |
| pyridaben | 4 | 50 | |
| compound (I-5) + pyridaben (1:1) | | found* | calc.** |
| according to the invention | 4 + 4 | 83 | 50 |
| compound (I-8) + pyridaben (1:1) | | found* | calc.** |
| according to the invention | 4 + 4 | 83 | 50 |
| spinetoram | 0.8 | 50 | |
| compound (I-5) + spinetoram (1:1) | | found* | calc.** |
| according to the invention | 0.8 + 0.8 | 67 | 50 |
| compound (I-8) + spinetoram (1:1) | | found* | calc.** |
| according to the invention | 0.8 + 0.8 | 67 | 50 |
| tebufenpyrad | 20 | 0 | |
| compound (I-5) + tebufenpyrad (1:1) | | found* | calc.** |
| according to the invention | 20 + 20 | 33 | 0 |
| triazophos | 20 | 0 | |
| compound (I-8) + triazophos (1:1) | | found* | calc.** |
| According to the invention | 20 + 20 | 33 | 17 |
| abamectin | 0.16 | 0 | |
| compound (I-5) + abamectin (25:1) | | found* | calc.** |
| according to the invention | 4 + 0.16 | 33 | 0 |
| milbemectin | 0.8 | 0 | |
| compound (I-5) + milbemectin (25:1) | | found* | calc.** |
| according to the invention | 20 + 0.8 | 50 | 0 |
| compound II-28-2 | 0.8 | 0 | |
| compound (I-5) + compound II-28-2 (5:1) | | found* | calc.** |
| according to the invention | 4 + 0.8 | 83 | 0 |
| compound (I-8) + compound II-28-2 (5:1) | | found* | calc.** |
| according to the invention | 4 + 0.8 | 33 | 0 |
| chlorfenapyr | 4 | 83 | |
| compound (I-5) + chlorfenapyr (1:1) | | found* | calc.** |
| according to the invention | 4 + 4 | 100 | 83 |
| flonicamid | 0.8 | 0 | |
| compound (I-5) + flonicamid (25:1) | | found* | calc.** |
| according to the invention | 20 + 0.8 | 50 | 0 |
| compound (I-5) + compound II-28-2 (5:1) | | found* | calc.** |
| according to the invention | 4 + 0.8 | 83 | 0 |
| flufenoxuron | 100 | 0 | |
| compound (I-8) + flufenoxuron (1:1) | | found* | calc.** |
| according to the invention | 100 + 100 | 83 | 67 |
| IKA 2002 | 100 | 0 | |
| compound (I-8) + IKA 2002 (1:1) | | found* | calc.** |
| according to the invention | 100 + 100 | 83 | 67 |
| cyenopyrafen | 100 | 0 | |
| compound (I-8) + cyenopyrafen (1:1) | | found* | calc.** |
| according to the invention | 100 + 100 | 83 | 67 |
| cyflumetofen | 100 | 0 | |
| compound (I-8) + cyflumetofen (1:1) | | found* | calc.** |
| according to the invention | 100 + 100 | 100 | 67 |
| alpha-cypermethrin | 0.16 | 0 | |
| compound (I-5) + alpha-cypermethrin (25:1) | | found* | calc.** |
| according to the invention | 4 + 0.16 | 67 | 0 |
| bifenthrin | 0.8 | 50 | |
| compound (I-5) + bifenthrin (25:1) | | found* | calc.** |
| according to the invention | 20 + 0.8 | 67 | 50 |
| compound (I-8) + bifenthrin (25:1) | | found* | calc.** |
| according to the invention | 20 + 0.8 | 67 | 50 |
| β-cyfluthrin | 0.16 | 0 | |
| compound (I-8) + β-cyfluthrin (25:1) | | found* | calc.** |
| according to the invention | 4 + 0.16 | 33 | 0 |
| deltamethrin | 0.16 | 50 | |
| compound (I-5) + deltamethrin (25:1) | | found* | calc.** |
| according to the invention | 4 + 0.16 | 83 | 50 |
| gamma-cyhalothrin | 0.16 | 0 | |
| compound (I-5) + gamma-cyhalothrin (25:1) | | found* | calc.** |
| according to the invention | 4 + 0.16 | 50 | 0 |
| compound (I-8) + gamma-cyhalothrin (25:1) | | found* | calc.** |
| according to the invention | 4 + 0.16 | 33 | 0 |
| lambda-cyhalothrin | 0.16 | 17 | |
| compound (I-5) + lambda-cyhalothrin (25:1) | | found* | calc.** |
| according to the invention | 4 + 0.16 | 33 | 17 |
| AKD 1022 | 0.8 | 0 | |
| compound (I-8) + AKD 1022 (25:1) | | found* | calc.** |
| according to the invention | 20 + 0.8 | 50 | 17 |
| clothianidin | 4 | 50 | |
| compound (I-5) + clothianidin (1:1) | | found* | calc.** |
| according to the invention | 4 + 4 | 100 | 50 |
| dinotefuran | 0.8 | 0 | |
| compound (I-8) + dinotefuran (25:1) | | found* | calc.** |
| according to the invention | 20 + 0.8 | 67 | 17 |
| imidacloprid | 20 | 50 | |
| compound (I-8) + imidacloprid (1:1) | | found* | calc.** |
| according to the invention | 20 + 20 | 100 | 58.5 |
| imidacloprid | 4 | 0 | |
| compound (I-8) + imidacloprid (25:1) | | found* | calc.** |
| according to the invention | 100 + 4 | 83 | 67 |
| imidaclothiz | 4 | 0 | |
| compound (I-8) + imidaclothiz (25:1) | | found* | calc.** |
| according to the invention | 100 + 4 | 100 | 67 |
| thiacloprid | 20 | 50 | |
| compound (I-8) + thiacloprid (1:1) | | found* | calc.** |
| according to the invention | 20 + 20 | 100 | 58.5 |
| thiamethoxam | 0.8 | 0 | |
| compound (I-5) + thiamethoxam (25:1) | | found* | calc.** |
| according to the invention | 20 + 0.8 | 50 | 0 |

*found = activity found
**calc. = activity calculated using Colby's formula

### EXAMPLE C

### Spodoptera frugiperda Larvae Test

solvents: 78 parts by weight of acetone
1.5 parts by weight of dimethylformamide
   emulsifier: 0.5 part by weight of alkylaryl polyglycol ether

To produce a suitable preparation of active compound, 1 part by weight of active compound is mixed with the stated amounts of solvents and emulsifier, and the concentrate is diluted with emulsifier-containing water to the desired concentration.

Cabbage leaves (Brassica oleracea) are treated by spraying with the active compound preparation of the desired concentration and are populated with larvae of the army worm (Spodoptera frugiperda) while the leaves are still moist.

After the desired period of time, the kill in % is determined 100% means that all caterpillars have been killed; 0% means that none of the caterpillars have been killed. The kill rates determined are entered into Colby's formula.

In this test, the following active compound combinations in accordance with the present application show a synergistically enhanced activity compared to the active compounds applied individually:

TABLE C - 1
Spodoptera frugiperda larvae test

| | Concentration | Kill | |
|---|---|---|---|
| Active compound | in g/ha | in % after 2^{d} | |
| compound (I-5) | 100 | 0 | |
| | 20 | 0 | |
| | 0.8 | 0 | |
| | 0.16 | 0 | |
| compound (I-8) | 20 | 0 | |
| | 0.8 | 0 | |
| | 0.16 | 0 | |
| chlorfenapyr | 4 | 67 | |
| compound (I-8) + chlorfenapyr (1:5) | | found* | calc.** |
| according to the invention | 0.8 + 4 | 83 | 67 |
| novaluron | 0.8 | 33 | |
| compound (I-5) + novaluron (1:5) | | found* | calc.** |
| according to the invention | 0.16 + 0.8 | 50 | 33 |
| compound (I-8) + novaluron (1:5) | | found* | calc.** |
| according to the invention | 0.16 + 0.8 | 50 | 33 |
| spinetoram | 0.16 | 50 | |
| compound (I-5) + spinetoram (1:1) | | found* | calc.** |
| according to the invention | 0.16 + 0.16 | 67 | 50 |
| compound (I-8) + spinetoram (1:1) | | found* | calc.** |
| according to the invention | 0.16 + 0.16 | 67 | 50 |
| emamectin benzoate | 0.8 | 83 | |
| compound (I-5) + emamectin benzoate (25:1) | | found* | calc.** |
| according to the invention | 20 + 0.8 | 100 | 83 |
| compound (I-8) + emamectin benzoate (25:1) | | found* | calc.** |
| according to the invention | 20 + 0.8 | 100 | 83 |
| flufenoxuron | 100 | 17 | |
| compound (I-5) + flufenoxuron (1:1) | | found* | calc.** |
| according to the invention | 100 + 100 | 50 | 17 |
| lufenuron | 100 | 0 | |
| compound (I-5) + lufenuron (1:1) | | found* | calc.** |
| according to the invention | 100 + 100 | 33 | 0 |
| pyridalyl | 20 | 67 | |
| compound (I-5) + pyridalyl (1:1) | | found* | calc.** |
| according to the invention | 20 + 20 | 100 | 67 |
| compound (I-8) + pyridalyl (1:1) | | found* | calc.** |
| according to the invention | 20 + 20 | 83 | 67 |
| Rynaxapyr | 0.16 | 33 | |
| compound (I-5) + Rynaxapyr (5:1) | | found* | calc.** |
| according to the invention | 0.8 + 0.16 | 50 | 33 |
| compound (I-8) + Rynaxapyr (5:1) | | found* | calc.** |
| according to the invention | 0.8 + 0.16 | 50 | 33 |

*found = activity found
**calc. = activity calculated using Colby's formula

TABLE C - 2

| | Concentration | Kill | |
|---|---|---|---|
| Active compound | in g/ha | in % after 6^{d} | |
| compound (I-5) | 100 | 0 | |
| | 20 | 0 | |
| | 4 | 0 | |
| | 0.8 | 0 | |
| compound (I-8) | 20 | 0 | |
| | 4 | 0 | |
| | 0.8 | 0 | |
| | 0.16 | 0 | |
| compound II-28-2 | 0.16 | 50 | |
| compound (I-5) + compound II-28-2 (5:1) | | found* | calc.** |
| according to the invention | 0.8 + 0.16 | 67 | 50 |
| compound (I-8) + compound II-28-2 (5:1) | | found* | calc.** |
| according to the invention | 0.8 + 0.16 | 67 | 50 |
| chlorpyrifos | 4 | 33 | |
| compound (I-8) + chlorpyrifos (1:1) | | found* | calc.** |
| according to the invention | 4 + 4 | 50 | 33 |
| fenpyroximate | 100 | 50 | |
| compound (I-5) + fenpyroximate (1:1) | | found* | calc.** |
| according to the invention | 100 + 100 | 83 | 50 |
| flubendiamid | 0.8 | 67 | |
| compound (I-8) + flubendiamid (1:5) | | found* | calc.** |
| according to the invention | 0.16 + 0.8 | 83 | 67 |
| flufenoxuron | 0.8 | 67 | |
| compound (I-5) + flufenoxuron (1:1) | | found* | calc.** |
| according to the invention | 0.8 + 0.8 | 100 | 67 |
| compound (I-8 flufenoxuron (1:1) | | found* | calc.** |
| according to the invention | 0.8 + 0.8 | 100 | 67 |
| IKA 2002 | 100 | 0 | |
| compound (I-5) + IKA 2002 (1:1) | | found* | calc.** |
| according to the invention | 100 + 100 | 33 | 0 |
| metaflumizone | 4 | 0 | |
| compound (I-8) + metaflumizone (1:1) | | found* | calc.** |
| according to the invention | 4 + 4 | 33 | 0 |
| methoxyfenozide | 4 | 50 | |
| compound (I-5) + methoxyfenozide (1:1) | | found* | calc.** |
| according to the invention | 4 + 4 | 83 | 50 |
| milbemectin | 0.8 | 0 | |
| compound (I-8) + milbemectin (25:1) | | found* | calc.** |
| according to the invention | 20 + 0.8 | 33 | 0 |
| spinosad | 0.8 | 50 | |
| compound (I-8) + spinosad (5:1) | | found* | calc.** |
| according to the invention | 4 + 0.8 | 67 | 50 |
| triflumuron | 0.8 | 33 | |
| compound (I-5) + triflumuron (1:1) | | found* | calc.** |
| according to the invention | 0.8 + 0.8 | 83 | 33 |
| compound (I-8 triflumuron (1:1) | | found* | calc.** |
| according to the invention | 0.8 + 0.8 | 83 | 33 |
| bifenthrin | 0.8 | 0 | |
| compound (I-8) + bifenthrin (25:1) | | found* | calc.** |
| according to the invention | 20 + 0.8 | 33 | 0 |
| β-cyfluthrin | 0.16 | 0 | |
| compound (I-8) + β-cyfluthrin (25:1) | | found* | calc.** |
| according to the invention | 4 + 0.16 | 33 | 0 |
| cypermethrin | 0.8 | 50 | |
| compound (I-5) + cypermethrin (5:1) | | found* | calc.** |
| according to the invention | 4 + 0.8 | 67 | 50 |
| compound (I-8) + cypermethrin (5:1) | | found* | calc.** |
| according to the invention | 4 + 0.8 | 67 | 50 |
| deltamethrin | 0.16 | 17 | |
| compound (I-5) + deltamethrin (25:1) | | found* | calc.** |
| according to the invention | 4 + 0.16 | 50 | 17 |
| gamma-cyhalothrin | 0.16 | 17 | |
| compound (I-8) + gamma-cyhalothrin (25:1) | | found* | calc.** |
| according to the invention | 4 + 0.16 | 67 | 17 |
| lambda-cyhalothrin | 0.8 | 67 | |
| compound (I-5) + lambda-cyhalothrin (25:1) | | found* | calc.** |
| according to the invention | 20 + 0.8 | 83 | 67 |
| compound (I-8) + lambda-cyhalothrin (25:1) | | found* | calc.** |
| according to the invention | 20 + 0.8 | 83 | 67 |
| thiacloprid | 20 | 50 | |
| compound (I-8) + thiacloprid (1:1) | | found* | calc.** |
| according to the invention | 20 + 20 | 67 | 50 |

*found = activity found
**calc. = activity calculated using Colby's formula

### EXAMPLE D

### Tetranychus urticae Test (OP-Resistant/Spray Treatment)

solvents: 78 parts by weight of acetone
1.5 parts by weight of dimethylformamide
   emulsifier: 0.5 part by weight of alkylaryl polyglycol ether

To produce a suitable preparation of active compound, 1 part by weight of active compound is mixed with the stated amounts of solvents and emulsifier, and the concentrate is diluted with emulsifier-containing water to the desired concentration.

Discs of bean leaves (Phaseolus vulgaris) which are infested by all stages of the greenhouse red spider mite (Tetranychus urticae) are sprayed with an active compound preparation of the desired concentration.

After the desired period of time, the activity in % is determined 100% means that all spider mites have been killed; 0% means that none of the spider mites have been killed.

In this test, the following active compound combination in accordance with the present application showed a synergistically enhanced activity compared to the active compounds applied individually:

TABLE D - 1
Tetranychus urticae test

| | Concentration | Kill | |
|---|---|---|---|
| Active compound | in g/ha | in % after 2^{d} | |
| compound (I-5) | 4 | 0 | |
| | 0.8 | 0 | |
| compound (I-8) | 4 | 0 | |
| | 0.8 | 0 | |
| abamectin | 0.032 | 0 | |
| compound (I-5) + abamectin (25:1) | | found* | calc.** |
| according to the invention | 0.8 + 0.032 | 70 | 0 |
| compound (I-8) + abamectin (25:1) | | found* | calc.** |
| according to the invention | 0.8 + 0.032 | 90 | 0 |
| chlorfenapyr | 4 | 50 | |
| compound (I-8) + chlorfenapyr (1:1) | | found* | calc.** |
| according to the invention | 4 + 4 | 70 | 50 |
| cyenopyrafen | 0.8 | 70 | |
| compound (I-8) + cyenopyrafen (1:1) | | found* | calc.** |
| according to the invention | 0.8 + 0.8 | 100 | 70 |
| cyflumetofen | 0.8 | 50 | |
| compound (I-8) + cyflumetofen (1:1) | | found* | calc.** |
| according to the invention | 0.8 + 0.8 | 70 | 50 |
| diafenthiuron | 4 | 0 | |
| compound (I-5) + diafenthiuron (1:1) | | found* | calc.** |
| according to the invention | 4 + 4 | 50 | 0 |
| compound (I-8) + diafenthiuron (1:1) | | found* | calc.** |
| according to the invention | 4 + 4 | 20 | 0 |
| dinotefuran | 20 | 0 | |
| compound (I-8) + dinotefuran (1:5) | | found* | calc.** |
| according to the invention | 4 + 20 | 50 | 0 |
| novaluron | 20 | 0 | |
| compound (I-5) + novaluron (1:5) | | found* | calc.** |
| according to the invention | 4 + 20 | 20 | 0 |
| spinetoram | 4 | 20 | |
| compound (I-8) + spinetoram (1:1) | | found* | calc.** |
| according to the invention | 4 + 4 | 40 | 20 |

*found = activity found
**calc. = activity calculated using Colby's formula

TABLE D - 2

| | Concentration | Kill | |
|---|---|---|---|
| Active compound | in g/ha | in % after 6^{d} | |
| compound (I-5) | 100 | 0 | |
| | 20 | 0 | |
| | 4 | 0 | |
| compound (I-8) | 100 | 0 | |
| | 20 | 0 | |
| | 4 | 0 | |
| | 0.8 | 0 | |
| | 0.16 | 0 | |
| amitraz | 20 | 80 | |
| compound (I-5) + amitraz (1:5) | | found* | calc.** |
| according to the invention | 4 + 20 | 100 | 80 |
| compound II-29-31 | 0.8 | 60 | |
| compound (I-8) + compound II-29-31 (1:5) | | found* | calc.** |
| according to the invention | 0.16 + 0.8 | 80 | 60 |
| bifenthrin | 4 | 40 | |
| compound (I-8) + bifenthrin (25:1) | | found* | calc.** |
| according to the invention | 100 + 4 | 60 | 40 |
| deltamethrin | 4 | 0 | |
| compound (I-8) + deltamethrin (25:1) | | found* | calc.** |
| according to the invention | 100 + 4 | 20 | 0 |
| emamectin benzoate | 0.032 | 0 | |
| compound (I-8) + emamectin benzoate (25:1) | | found* | calc.** |
| according to the invention | 0.8 + 0.032 | 50 | 0 |
| fenpyroximate | 4 | 60 | |
| compound (I-5) + fenpyroximate (1:1) | | found* | calc.** |
| according to the invention | 4 + 4 | 90 | 60 |
| compound (I-8) + fenpyroximate (1:1) | | found* | calc.** |
| according to the invention | 4 + 4 | 90 | 60 |
| IKA 2002 | 4 | 70 | |
| compound (I-8) + IKA 2002 (1:1) | | found* | calc.** |
| according to the invention | 4 + 4 | 90 | 70 |
| Pymetrozine | 100 | 0 | |
| compound (I-5) + pymetrozine (1:1) | | found* | calc.** |
| according to the invention | 100 + 100 | 20 | 0 |
| spinosad | 4 | 20 | |
| compound (I-5) + spinosad (5:1) | | found* | calc.** |
| according to the invention | 20 + 4 | 40 | 20 |
| compound (I-8) + spinosad (5:1) | | found* | calc.** |
| according to the invention | 20 + 4 | 80 | 20 |
| tebufenpyrad | 4 | 40 | |
| compound (I-8) + tebufenpyrad (1:1) | | found* | calc.** |
| according to the invention | 4 + 4 | 80 | 40 |

*found = activity found
**calc. = activity calculated using Colby's formula

1. An active compound combination comprising (i) at least one compound of formula (I) 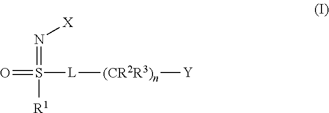
in which
X represents NO₂, CN or COOR⁴,
L represents a single bond,
R¹ represents C₁-C₄-alkyl, or
R¹, sulphur and L together represent a 4-, 5- or 6-membered ring,
R² and R³ independently of one another represent hydrogen, methyl, ethyl, fluorine, chlorine or bromine, or
R² and R³ together represent —(CH₂)₂—, —(CH₂)₃—, —(CH₂)₄— or —(CH₂)₅— and together with the carbon atom to which they are attached form a 3-, 4-, 5- or 6-membered ring,
n represents 0, 1, 2 or 3,
Y represents the radicals 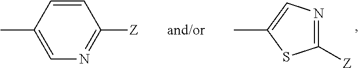
in which
Z represents halogen, C₁-C₄-alkyl, C₁-C₄-haloalkyl, C₁-C₄-alkoxy or C₁-C₄-haloalkoxy,
R⁴ represents C₁-C₃-alkyl,
and
(ii) at least one active compound selected from the group consisting of the acetylcholinesterase (AChE) inhibitors II-1:
alanycarb (II-1.A-1), aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35), acephate (II-1.B-1), azamethiphos (II-1.B-2), azinphos (-methyl, -ethyl) (II-1.B-3), bromophos-ethyl (II-1.B-4), bromfenvinfos (-methyl) (II-1.B-5), butathiofos (II-1.B-6), cadusafos (II-1.B-7), carbophenothion (II-1.B-8), chlorethoxyfos (II-1.B-9), chlorfenvinphos (II-1.B-10), chlormephos (II-1.B-11), chlorpyrifos (-methyl/-ethyl) (II-1.B-12), coumaphos (II-1.B-13), cyanofenphos (II-1.B-14), cyanophos (II-1.B-15), chlorfenvinphos (II-1.B-16), demeton-S-methyl (II-1.B-17), demeton-S-methylsulphone (II-1.B-18), dialifos (II-1.B-19), diazinon (II-1.B-20), dichlofenthion (II-1.B-21), dichlorvos/DDVP (II-1.B-22), dicrotophos (II-1.B-23), dimethoate (II-1.B-24), dimethylvinphos (II-1.B-25), dioxabenzofos (II-1.B-26), disulfoton (II-1.B-27), EPN (II-1.B-28), ethion (II-1.B-29), ethoprophos (II-1.B-30), etrimfos (II-1.B-31), famphur (II-1.B-32), fenamiphos (II-1.B-33), fenitrothion (II-1.B-34), fensulfothion (II-1.B-35), fenthion (II-1.B-36), flupyrazofos (II-1.B-37), fonofos (II-1.B-38), formothion (II-1.B-39), fosmethilan (II-1.B-40), fosthiazate (II-1.B-41), heptenophos (II-1.B-42), iodofenphos (II-1.B-43), iprobenfos (II-1.B-44), isazofos (II-1.B-45), isofenphos (II-1.B-46), isopropyl (II-1.B-47), O-salicylate (II-1.B-48), isoxathion (II-1.B-49), malathion (II-1.B-50), mecarbam (II-1.B-51), methacrifos (II-1.B-52), methamidophos (II-1.B-53), methidathion (II-1.B-54), mevinphos (II-1.B-55), monocrotophos (II-1.B-56), naled (II-1.B-57), omethoate (II-1.B-58), oxydemeton-methyl (II-1.B-59), parathion (-methyl/-ethyl) (II-1.B-60), phenthoate (II-1.B-61), phorate (II-1.B-62), phosalone (II-1.B-63), phosmet (II-1.B-64), phosphamidon (II-1.B-65), phosphocarb (II-1.B-66), phoxim (II-1.B-67), pirimiphos (-methyl/-ethyl) (II-1.B-68), profenofos (II-1.B-69), propaphos (II-1.B-70), propetamphos (II-1.B-71), prothiofos (II-1.B-72), prothoate (II-1.B-73), pyraclofos (II-1.B-74), pyridaphenthion (II-1.B-75), pyridathion (II-1.B-76), quinalphos (II-1.B-77), sebufos (II-1.B-78), sulfotep (II-1.B-79), sulprofos (II-1.B-80), tebupirimfos (II-1.B-81), temephos (II-1.B-82), terbufos (II-1.B-83), tetrachlorvinphos (II-1.B-84), thiometon (II-1.B-85), triazophos (II-1.B-86), triclorfon (II-1.B-87), vamidothion (II-1.B-88)
antagonists of GABA-gated chloride channels II-2:
camphechlor (II-2A-1), chlordane (II-2A-2), endosulfan (II-2A-3), gamma-HCH (II-2A-4), HCH (II-2A-5), heptachlor (II-2A-6), lindane (II-2A-7), methoxychlor (II-2A-8): acetoprole (II-2B-1), ethiprole (II-2B-2), fipronil (II-2B-3), pyrafluprole (II-2B-4), pyriprole (II-2B-5), vaniliprole (II-2B-6);
sodium channel modulators/blockers of voltage-gated sodium channels II-3:
acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-) (II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (-1R isomer) (II-3-51), tralomethrin (II-3-52), transfluthrin (II-3-53), ZXI 8901 (II-3-54), pyrethrin (pyrethrum) (II-3-55), eflusilanate (II-3-56), DDT (II-3-57), methoxychlor (II-3-58);
agonists/antagonists of the nicotinergic acetylcholine receptor II-4: acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9), nicotine (II-4B-1), bensultap (II-4B-2), cartap (II-4B-3), thiosulfap-sodium (II-4B-4), thiocylam (II-4C-4);
allosteric modulators of the acetylcholine receptor (agonists):
spinosad (II-5-1), spinetoram (II-5-2);
chloride channel activators: abamectin (II-6-1), emamectin (II-6-2), emamectin-benzoate (II-6-3), ivermectin (II-6-4), lepimectin (II-6-5), milbemectin (II-6-6);
juvenile hormone analogues: hydroprene (II-7A-1), kinoprene (II-7A-2), methoprene (II-7A-3), epofenonane (II-7A-4), triprene (II-7A-5), fenoxycarb (II-7B-1), pyriproxifen (II-7C-1), diofenolan (II-7C-2);
active compounds having unknown or non-specific mechanisms of action:
methylbromide (II-8A-1), chloropicrin (II-8B-1), sulphuryl fluoride (II-8C-1);
cryolite (II-9A-1), pymetrozine (II-9B-1), pyrifluquinazone NNI0101 (II-9B-2), flonicamid (II-9C-1),
clofentezine (II-10A-1), hexythiazox (II-10A-2), etoxazole (II-10B-1), diafenthiuron (II-12A-1),
azocyclotin (II-12B-1), cyhexatin (II-12B-2), fenbutatin oxide (II-12B-3)
II-12C propargite (II-12C-1), tetradifon (II-12C-2)
decouplers of oxidative phosphorylation by interruption of the H-proton gradient II-13 chlorfenapyr (II-13-1)
binapacyrl (II-13-2), dinobuton (II-13-3), dinocap (II-13-4), DNOC (II-13-5)
microbial disruptors of the insect gut membrane
Bacillus thuringiensis strains (II-13-6)
inhibitors of chitin biosynthesis
II-15 benzoylureas,
bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)
II-16 buprofezin (II-16-1)
moulting disruptors cyromazine (II-17-1)
ecdysone agonists/disruptors (II-18)
II-18A diacylhydrazines,
chromafenozide (II-18A-1), halofenozide (II-18A-2), methoxyfenozide (II-18A-3),
tebufenozide (II-18A-4), fufenozide (JS-118) (II-18A-5)
azadirachtin (II-18B-1)
octopaminergic agonists
amitraz (II-19-1)
II-20 site III electron transport inhibitors/site II electron transport inhibitors
hydramethylnon (II-20A-1)
acequinocyl (II-20B-1)
fluacrypyrim (II-20C-1)
cyflumetofen (II-20D-1), cyenopyrafen (II-20D-2)
electron transport inhibitors
II-21 site I electron transport inhibitors
from the group of the METI acaricides,
fenazaquin (II-21-1), fenpyroximate (II-21-2), pyrimidifen (II-21-3), pyridaben (II-21-4),
tebufenpyrad (II-21-5), tolfenpyrad (II-21-6), rotenone (II-21-7)
II-22 blockers of voltage-gated sodium channels
indoxacarb (II-22A-1)
metaflumizone (BAS 3201) (II-22B-1)
II-23 inhibitors of fatty acid biosynthesis
II-23A tetronic acid derivatives
spirodiclofen (II-23A-1), spiromesifen (II-23A-2)
II-23B tetramic acid derivatives,
spirotetramat (II-23B-1)
II-25 neuronal inhibitors having an unknown mechanism of action
bifenazate (II-25-1)
ryanodine receptor effectors
II-28 diamides,
flubendiamide (II-28-1),
Artraniliprole (II-28-3),
Cyaniliprole (II-28-4)
II-29 active compounds having an unknown mechanism of action
amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27), 4-{[(6-chloropyrid-3-yl)methyl](methyl)amino}furan-2(5H)-one (II-29-28), 4-{[(6-chloropyrid-3-yl)methyl](2,2-difluoroethyl)amino}furan-2(5H)-one (II-29-29), 4-{[(6-chloropyrid-3-yl)methyl](cyclopropyl)amino}furan-2(5H)-one (II-29-30) and 1-{2,4-dimethyl-5-[(2,2,2-trifluoroethyl)sulphinyl]phenyl}-3-(trifluoromethyl)-1H-1,2,4-triazole 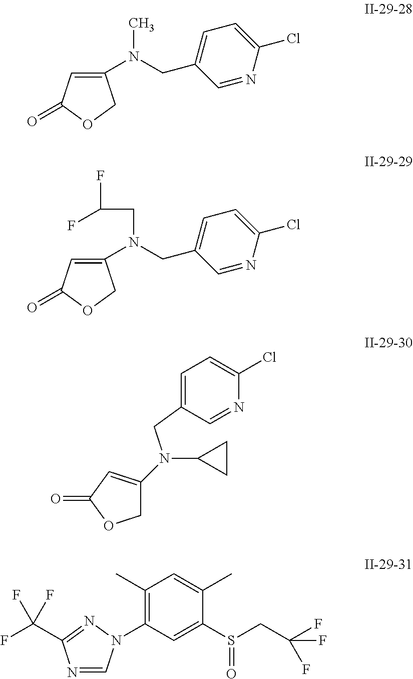
and II-30 microbial disruptors of the insect gut membrane: II-30-1 Bacillus thuringiensis strains

2. A composition comprising an active compound combination according to claim 1.

3. An active compound combination according to claim 1 suitable for controlling animal pests.

4. Method for controlling animal pests comprising allowing an active compound combination according to claim 1 to act on animal pests and/or a habitat thereof.

5. Process for preparing a composition according to claim 2 comprising mixing said, active compound combination with an extender and/or surfactant.
